(19) United States
(12) Patent Application Publication
(10) Pub. No.: US 2009/0152785 A1
(43) Pub. Date: Jun. 18, 2009

(54) ALIGNMENT APPARATUS AND ORIGINAL POINT RETURNING METHOD OF ALIGNMENT APPARATUS, TURNING TABLE, TRANSLATIONAL TABLE, MACHINE INCLUDING ALIGNMENT APPARATUS AND MACHINE CONTROL SYSTEM

(75) Inventors: Takehiko Komiya, Fukuoka (JP); Toshiyuki Osuga, Fukuoka (JP); Yasuhiko Kaku, Fukuoka (JP)

Correspondence Address: SUGHRUE-265550, 2100 PENNSYLVANIA AVE. NW, WASHINGTON, DC, 20037-3213, US

(73) Assignee: KABUSHIKI KAISHA YASKAWA DENKI, Kitakyushu-shi (JP)

(21) Appl. No.: 12/066,451

(22) PCT Filed: Aug. 25, 2006
(86) PCT No.: PCT/JP2006/316775

§ 371 Date: Mar. 11, 2008

(30) Foreign Application Priority Data
Sep. 12, 2005 (JP) 2005-263784

(51) Int. Cl. B23Q 1/26; B23Q 1/44; G12B 5/00

(52) U.S. Cl. 269/63; 269/55; 269/71; 700/114

(57) ABSTRACT

There is provided an alignment apparatus of rotating a table by translational driving to be able to operate the table in XYθ, Yθ, or θ accurately.

4 pieces of drive systems for driving a table (4) mounted with an object (5) includes a translational freedom degree portion (11), a translational drive portion (12), and a rotational freedom degree portion (13), further, an alignment apparatus is made to be able to return to an original point by providing a motor (1) and a detecting apparatus (2) at a machine fixing apparatus (41), accurately fixing the table (4) by the machine fixing apparatus (41) by using a first positioning apparatus and a second positioning apparatus, and a first position fixing apparatus and a second position fixing apparatus, and storing a detecting apparatus reference position at a detecting apparatus reference position storing apparatus (44).

### TECHNICAL FIELD

The present invention relates to an alignment apparatus for positioning an object on a table to a predetermined position by moving the table in XYθ, Yθ or θ in an inspection apparatus, an exposure apparatus or the like of a semiconductor device or a printed board, a liquid crystal display element or the like and an original point returning method of an alignment apparatus.

### RELATED ART

A stage apparatus including a linear motor constituting a first example of a conventional art enables to carry out positioning by a small angle by using a linear motor and is made to be small-sized and thin-sized (refer to, for example, Patent Reference 1).

Further, there are also a 2 axes parallel/1 axis turning movement guide mechanism and a 2 axes parallel/1 axis turning table apparatus using the same constituting a second example of a conventional art is made to constitute a table apparatus using the 2 axes parallel/1 axis turning movement guide mechanism simply integrated to a table and capable of guiding and supporting the table highly accurately (refer to, for example, Patent Reference 2).

A stage apparatus constituting a third example of a conventional art includes a movable support apparatus for axially supporting movably one end portion and other end portion of a stage having a movable table and a position control apparatus for controlling the movable table and the movable support apparatus, made to be able to precisely position the stage in a movement not only in a direct advancing direction but in a rotating direction and is made to be able to move the stage at high speed by promoting a response (refer to, for example, Patent Reference 3).

Patent Reference 1: JP-A-2002-328191 (FIG. 1, FIG. 2)

Patent Reference 2: JP-A-11-245128 (FIG. 2, FIG. 4, FIG. 5)

Patent Reference 3: JP-A-2003-316440 (FIG. 1, FIG. 3, FIG. 4, FIG. 5, FIG. 7)

An explanation will be given of a stage apparatus including a linear motor of Patent Reference 1 constituting a first example of the conventional art.

FIG. 77 is a front view showing an embodiment of the stage apparatus including the linear motor of Patent Reference 1 viewed from X direction constituting one direction, and FIG. 78 is a plane view showing the stage apparatus shown in FIG. 77.

In the two drawings, the stage apparatus including the linear motor is integrated with a rotating linear motor 1013 as a drive apparatus for moving in a rotating direction by a small amount between a rotating stage 1103 and a second stage 1102, particularly, in consideration of angular positioning of a small amount of the rotating stage 1103, as the rotating linear motor 1013, a movable magnet type linear motor is applied, constituting a rotating stage apparatus for angularly positioning a part of a work or the like by moving the rotating linear motor 1013 and the rotating stage 1103 constituting a portion in a rotating direction in a rotating direction (that is, θ direction) by a small amount.

The rotating stage 1103 (that is, θ stage apparatus) is integrated to an XY stage apparatus constituted by a first stage reciprocally moved in X direction constituting a linear direction in one direction and the second stage 1102 reciprocally moved in Y direction orthogonal to X direction, constituting a compound stage apparatus of an XY-θ stage apparatus and constituting a structure for positioning a part of a work or the like on a plane in X direction, Y direction and a rotating direction (θ direction).

In this way, the stage apparatus including the linear motor of the conventional art is small-sized and thin-sized to position in XYθ directions.

Next, an explanation will be given of a 2 axes parallel/1 axis turning movement guide mechanism and a 2 axes parallel/1 axis turning table apparatus using the same of Patent Reference 2. FIG. 79 is a partially broken disassembled perspective view of the 2 axes parallel/1 axis turning movement guide mechanism of Patent Reference 2, FIG. 80 shows the 2 axes parallel/1 axis turning table apparatus using the 2 axes parallel/1 axis turning movement guide mechanism shown in FIG. 79, (a) of the drawing is a plane view omitting a table and showing the table by a two-dotted chain line, (b) of the drawing is a front view, and FIG. 81 is a plane view of the table shown in FIG. 80.

In FIG. 79 through FIG. 81, a 2 axes parallel/1 axis turning movement guide mechanism 2201 (FIG. 79) is constituted by a 2 axes parallel movement guide portion 2270 and a turning movement guide portion 2280 integrated to the 2 axes parallel movement guide portion 2270.

Further, as shown by FIG. 80 and FIG. 81, a 2 axes parallel/1 axis turning table apparatus using the 2 axes parallel/1 axis turning movement guide mechanism 2201 supports a table 2233 in parallel with a base 2234 and in 2 axes directions orthogonal to each other movably by way of 4 of 2 axes parallel/1 axis turning movement guide mechanisms 2201A, 2201B, 2201C, 2201D and is made to be able to be turned centering on a turning axis C0 disposed at a center portion of the table 2233.

3 of 4 of the 2 axes parallel/1 axis turning movement guide mechanisms 2201A, 2201B, 2201D are operably connected with linear drive mechanisms 2237A, 2237B, 2237D constituted by rotating motors 2238 and feed screw mechanisms 2239 for converting a rotational movement of the rotating motors 2238 into a linear movement which are respectively driven to be elongated and contracted in linear directions. The 2 axes parallel/1 axis turning movement guide mechanism 2201C can freely be moved.

When the table 2233 is moved in parallel, the two linear drive mechanisms 2237A and 2237B or the linear drive mechanism 2237C is driven.

When the table 2233 is turned relative to the turning axis C0, the linear drive mechanisms 2237A and 2237B are driven by the same amount +ΔX and −ΔX in directions reverse to each other, on the other hand, the linear drive mechanism 2237D is driven by a predetermined amount ΔY in Y axis direction.

In this way, the 2 axes parallel/1 axis turning movement guide mechanism and the 2 axes parallel/1 axis turning table apparatus using the same move in parallel or turn the table to position.

A stage apparatus of Patent Reference 1 constituting a third example of the conventional art will be explained.

FIG. 82 is an outlook view of the stage apparatus of Patent Reference 1. In FIG. 82, numerals 3100, 3200, 3300 designate direct advancing stages, numerals 3110, 3210, 3310 designate movable tables, numerals 3112 and 3114, 3212 and 3214, 3312 and designate leg portions, numerals 3120, 3220, 3320 designate base portions, numerals 3222 and 3224, 3222 and 3324, and 3324 designate guide rails, numerals 3130, 3230 3330 designate linear motor stators, numerals 3120, 3220, 3320 designate base portions, numeral 3350 designates a first end portion, and numeral 3360 designates a second end portion. The three direct advancing stages 3100, 3200 and 3300 are provided with the same structure, and the movable tables 3110, 3210 and which are movable by being driven separately by linear motors are moved on the stages 3100, 3200 and 3300. The first end portion 3350 of the base portion of the base portion 3320 of the direct advancing stage 3300 is pivotably supported on the movable table 3110 of the direct advancing stage 3100, and the second end portion 3360 of the base portion 3320 of the direct advancing stage 3300 is pivotably supported on the movable table of the direct advancing stage 3200.

FIG. 83 is a perspective view showing a mode of an axially supporting portion of the direct advancing stage 3300 of the stage apparatus of Patent Reference 3. In FIG. 83, numerals 3400, 3500 designate axially supporting members, numerals 3410, 3510 designate outer side cylinder portions, numerals 3420, 3520 designate axially supporting members, and numeral 3530 designates a leaf spring portion.

The leaf spring portion 3530 is provided at the inner side cylinder portion 3520 and is fixed to a lower face of the base portion 3320 by way of a support member.

FIG. 84 illustrates views showing details of the axially supporting member 3400 and the axially supporting member 3500. FIG. 84(a) shows a section when the axially supporting member 3400 is viewed from a side of the first end portion 3350 of the base member 3320, and FIG. 84(b) shows a section when the axially supporting member 3500 is viewed from a side of the second end portion 3360 of the base portion 3320.

The inner side cylinder portion 3420 shown in FIG. 84(a) is smoothly pivoted relative to the outer side cylinder portion 3410. The inner side cylinder portion 3520 shown in FIG. 84(b) is provided with the leaf spring 3530 along a radius direction of the inner side cylinder portion 3520.

FIG. 85 is a view viewing the inner side cylinder portion 3520 of the stage apparatus of Patent Reference 3. In FIG. 85, numeral 3522 designates a small inner diameter portion, numeral 3524 designates a large inner diameter portion, numeral 3526 designates a boundary side face, and numeral 3560 designates a screw. The leaf spring 3530 is constituted by an elongated shape, both end portions of the leaf spring 3530 are provided with through holes in an elliptical shape, and a direction of a long diameter of the through hole in the elliptical shape is a direction substantially the same as a longitudinal direction of the leaf spring 3530. The both end portions of the leaf spring 3530 are provided at the boundary side face 3526 of the inner side cylinder portion 3520 by way of the through holes by the screws 3560. The leaf spring 3530 is constituted such that the longitudinal direction of the leaf spring 3530 is substantially the same as a direction of a diameter of the inner side cylinder portion 3520. When the leaf spring 3530 is bent in a direction of a white arrow mark as shown in the drawing, the both end portions of the leaf spring 3530 can slightly be moved along the through holes in the elliptical shape. A center portion of the leaf spring 3530 is fixed with a support member by a screw 3580. The support member 3570 is constituted by a T-like shape, and an upper portion of the support member is fixed to a lower face of the base portion 3320 of the direct advancing stage 3300 by a screw 3590. By providing a rotating bearing 3540 and a roller 3550, the inner side cylinder portion 3520 can smoothly be pivoted relative to the outer side cylinder portion 3510. Further, the direct advancing stage can be moved relative to the inner side cylinder portion by bending the leaf spring 3530. “Stage” is constituted from the direct advancing stage 3300, and “movable table” is constituted from the movable table 3310. Further, “first movable support apparatus” is constituted from the axially supporting member 3400, and “second movable support apparatus” is constituted from the axially supporting member 3500. Further, “one end portion” is constituted from the first end portion 3350, and “other end portion” is constituted from the second end portion 3360. Furthermore, “elastic member” is constituted from the leaf spring portion 3530.

FIG. 86 shows a specific mode of positioning the table of the stage apparatus of Patent Reference 3.

An example shown in FIGS. 86(a) through (c) are shown by plane views showing an outline of the three direct advancing stages 3100, 3200 and 3300, and the movable tables 3110, 3210 and 3310. FIG. 86(a) shows the stage apparatus when the movable table 3110 is disposed at a center in X direction of the direct advancing stage 3100, the movable table 3210 is disposed at a center in X direction of the direct advancing stage 3200, and the movable table 3310 is disposed at a center in Y direction of the direct advancing stage 3300, and reference positions are constituted when the movable tables 3110, 3210 and 3310 are disposed at the positions.

FIG. 86(b) shows a stage when both of the movable table 3110 of the direct advancing stage 3100 and the movable table 3210 of the direct advancing stage 3200 are moved from the reference positions in a positive direction by a distance Y1, and the movable table 3310 of the direct advancing stage 3300 is moved from the reference position in a positive direction by a distance X1. By moving the movable table 3110 and the movable table 3210 in the same direction by the same distance in this way, a total of the direct advancing stage 3300 can be moved in Y direction. By moving in this way, the movable table 3310 can be disposed at a desired position in X-Y directions.

In FIG. 86(c), the movable table 3110 of the direct advancing stage 3100 is moved from the reference position in a negative direction by a distance Y2, and the movable table 3210 of the direct advancing stage 3200 is moved in the positive direction by a distance Y2. By moving in this way, a direction of a total of the direct advancing stage 3300 can be disposed at a position rotated by θ. By making the movable table 3110 and the movable table 3210 disposed at positions relatively different from each other in this way, a total of the direct advancing stage 3300 can be disposed by a desired angle, and the movable table 3310 can be disposed at a position rotated by a desired angle.

When the direct advancing stage 3300 is rotated as shown by FIG. 86(c), the support member 3570 supporting the base portion 3320 of the direct advancing stage 3300 mentioned above is moved. When the support member 3570 is moved, the leaf spring portion 3530 fixed to the support member 3570 is bent.

FIG. 87 is a view showing a behavior when the leaf spring portion 3530 of the stage apparatus of Patent Reference 3 is bent. There is shown the support member 3570 moved in a left direction of the drawing. By moving the support member 3570, the leaf spring portion 3530 is bent at a portion designated by notation M.

In this way, at the first end portion 3350 of the base portion 3320 of the direct advancing stage 3300, by constructing a constitution of only axially supporting the direct advancing stage 3300, a position of the movable table 3310 along the longitudinal direction of the direct advancing stage 3300 can be calculated by constituting a reference by a pivoting center of the first end portion 3350. Further, at the second end portion 3360 of the base portion 3320 of the direct advancing stage 3300, by constructing a constitution of axially supporting the direct advancing stage 3300 and making the direct advancing stage 3300 movable in a longitudinal direction, a pivoting operation of the direct advancing stage 3300 can be made to be smooth.

### DISCLOSURE OF THE INVENTION

### Problems to be Solved by the Invention

However, the stage apparatus including the linear motor of Patent Reference 1 is constructed by an apparatus constitution in which respective axes in three directions of XYθ overlap each other to pose a problem that the stage apparatus become high physically when an object to be positioned is large-sized. In recent years, a liquid crystal material has been large-sized year by year and there is a drawback that in order to reciprocally move or rotationally move the table, that is, the stage, the linear motor or the stage apparatus is obliged to be enlarged as it is.

Further, owing to the apparatus constitution of overlapping the respective axes of three directions of XYθ each other, in a case of enlarging the stage, when moved in XY, a gravitational center position is shifted, and therefore, depending on the position of moving the stage by a drive apparatus, a load is concentrated on a connecting portion of the respective axes, a large moment load is generated at the stage, and therefore, there poses a problem of reducing a positioning accuracy by hampering a smooth movement of the stage, or bringing about an unintentional rotational movement.

Further, the 2 axes parallel/1 axis turning movement guide mechanism and the 2 axes parallel/1 axis turning table apparatus of Patent Reference 2 are constructed by a 3 axes constitution using 3 of the 2 axes parallel/1 axis turning movement guide mechanisms, when driven only by 1 axis, a capacity of a motor becomes deficient, and operation the same as that in directions in being driven by 2 axes cannot be carried out, and therefore, time is taken for moving/positioning, as a result, a problem of deteriorating efficiency/productivity is posed.

Further, the apparatus of rotating/turning to move the table or the like by utilizing a translational movement as in Patent Reference 2 poses a problem of nonlinearity in a translational moving amount and a rotational moving amount. There poses a problem that the translational movement amount is constituted by values respectively different from each other in operations of a regular rotation and a reverse rotation of the table, an angular movement at an equal interval of the table. In other words, depending on an attitude or a position of the table, an operating instruction of the translational movement differs.

When attitudes of the table in an assumed attitude and the actual table differ from each other, the table is not rotated/turned as in the operational instruction of the translational moving amount.

That is, there poses a very big problem that the table cannot accurately be operated unless the attitude/position of the table can accurately be grasped.

In a mechanism such as a ball screw including a mechanical loss, the above-described accuracy is about an accuracy thereof, which does not pose a big problem, however, when an operational accuracy is increased by utilizing the linear motor, an error in an instruction poses a problem.

Although the stage apparatus of Patent Reference 3 is provided with a freedom degree by utilizing the elastic member and bending the elastic member, positioning needs to be carried out in consideration of a bending displacement of the elastic member. That is, there pose a problem that positioning cannot finely be carried out by a hysteresis of an elastic property of the leaf spring, or a nonlinearity of a recovery force and a displacement of a coil spring or a pneumatic spring or the like used in the elastic member. Further, when the elastic member is arranged as in the leaf spring of a drive system, there also poses a problem that a resonance caused by the leaf spring element effects an influence on a positioning accuracy.

The invention has been carried out in view of the problem and it is an object thereof to provide an alignment apparatus capable of moving a table highly accurately by strictly determining a machine original point constituting an initial position of the table and calculating an operational instruction constituting a reference by the machine original point in order to support a load by the table or an object by dispersing the load with excellent balance by a drive mechanism unit and accurately operate the table even when the table is large-sized.

### Means for Solving the Problems

In order to resolve the above-described problem, the invention is constituted as follows.

According to Claim 1, there is provided with an alignment apparatus for operating a table mounted with an object in XYθ, Yθ, or θ by way of a drive mechanism arranged at a machine base portion to be positioned to a predetermined position, the alignment apparatus including:

the drive mechanism including a plurality of drive mechanism units each constituted by;
a mechanism portion including two translational freedom degree portions each having a translational freedom degree and one rotational freedom degree portion having a rotational freedom degree; and
a motor control apparatus including motors for driving the freedom degree portions of the two translational freedom degree portions and the one rotational freedom degree portion, a detecting apparatus for detecting an amount of operating the mechanism portion constituting a member to be detected, and a controller for controlling the motors by receiving an operation instruction to constitute the motors of a number at least the same as a number of freedom degrees of XYθ, Yθ or θ operation of the table;

the drive mechanism units including an instructing apparatus for providing the operation instruction to the controller;

the table being operated to translationally move and rotationally move in two directions of the XYθ operation, to translationally move and rotationally move in one direction of the Yθ operation, or rotationally move of the θ operation by operating the motors respectively in a translational direction or a rotational direction;

a machine original point storing apparatus for previously storing or inputting difference between a machine original point position and a fixing reference position;

a machine fixing apparatus for mechanically fixing the table or the drive mechanism at the fixing reference position of the alignment apparatus;

a machine fixing reference position storing apparatus for detecting and storing the machine fixing reference positions of a number at least the same as a number of freedom degrees provided to the table by the detecting apparatus;

a detecting apparatus reference position storing apparatus for disengaging the machine fixing apparatus, detecting apparatus reference position references of a number at least the same as the number of the freedom degrees provided to the table by the detecting apparatus by driving the motors of a number at least the same as the number of the freedom degrees provided to the table, and storing differences between the detecting apparatus reference positions and the machine original point positions or the fixing reference position of the number at least the same as the number of the freedom degrees provided to the table; and

a machine original point returning amount calculating apparatus for detecting the detecting apparatus reference position references of the number at least the same as the number of the freedom degrees provided to the table by driving the motors of the number at least the same as the number of the freedom degrees provided to the table, and calculating moving amounts of the motors of the number at least the same as the number of the freedom degrees provided to the table for making the table and the drive mechanism unit disposed at the machine original point or the fixing reference position from a current position in a state in which the machine fixing apparatus is not present routinely after the above-described processing has been finished and a power source is introduced again, wherein

the table and the drive mechanism unit are moved to the machine original point position by operating the motors of the number at least the same as the number of the freedom degrees provided to the table.

Further, according to Claim 2, there is provided with an alignment apparatus for operating a table mounted with an object in XYθ, Yθ, or θ by way of a drive mechanism arranged at a machine base portion to be positioned to a predetermined position,

the alignment apparatus including:

the drive mechanism including a plurality of drive mechanism units each constituted by;
a mechanism portion including two translational freedom degree portions each having a translational freedom degree and one rotational freedom degree portion having a rotational freedom degree; and
a motor control apparatus including motors for driving the freedom degree portions of the two translational freedom degree portions and the one rotational freedom degree portion, a detecting apparatus for detecting an amount of operating the mechanism portion constituting a member to be detected, and a controller for controlling the motors by receiving an operation instruction to constitute the motors of a number at least the same as a number of freedom degrees of XYθ, Yθ or θ operation of the table;

the drive mechanism units including an instructing apparatus for providing the operation instruction to the controller;

the table being operated to translationally move and rotationally move in two directions of the XYθ operation, to translationally move and rotationally move in one direction of the Yθ operation, or rotationally move in the θ operation by operating the motors respectively in a translational direction or a rotational direction;

a machine fixing apparatus for mechanically fixing the table or the drive mechanism at a fixing reference position of the alignment apparatus;

a machine original point storing apparatus for previously storing or inputting difference between a machine original point and the fixing reference position;

a two-dimensional position detecting apparatus for detecting a mark previously provided to the table or the object;

a two-dimensional image processing apparatus for calculating a moving amount of the table necessary for moving to an arbitrary position based on the image of the two-dimensional position detecting apparatus;

a reference image position storing apparatus for storing a reference image position by constituting an absolute position by a position of a mark of an image by using outputs of the two-dimensional position detecting apparatus and the two-dimensional image processing apparatus; and

a machine original point returning amount calculating apparatus for calculating moving amounts of the motors of a number at least the same as a number of freedom degrees provided to the table for making the table and the drive mechanism unit disposed at the machine original point position or the fixing reference position from a current position by comparing a new output image provided by newly detecting a mark in a current state by the two-dimensional position detecting apparatus and the two-dimensional processing apparatus, and the reference image position stored in the reference image position storing apparatus, wherein

the table and the drive mechanism unit are moved to the machine original point position by operating the motors of the number at least the same as the number of the freedom degrees provided to the table.

Further, according to Claim 3, there is provided with an alignment apparatus for operating a table mounted with an object in XYθ, Yθ, or θ by way of a drive mechanism arranged at a machine base portion to be positioned to a predetermined position,

the alignment apparatus including:

the drive mechanism including a plurality of drive mechanism units each constituted by;
a mechanism portion including two translational freedom degree portions each having a translational freedom degree and one rotational freedom degree portion having a rotational freedom degree; and
a motor control apparatus including motors for driving the freedom degree portions of the two translational freedom degree portions and the one rotational freedom degree portion, a detecting apparatus for detecting an amount of operating the mechanism portion constituting a member to be detected, and a controller for controlling the motors by receiving an operation instruction to constitute the motors of a number at least the same as a number of freedom degrees of XYθ, Yθ or θ operation of the table;

the drive mechanism units including an instructing apparatus for providing the operation instruction to the controller;

the table being operated to translationally move and rotationally move in two directions of the XYθ operation, to translationally move and rotationally move in one direction of the Yθ operation, or rotationally move of the θ operation by operating the motors respectively in a translational direction or a rotational direction;

a machine original point storing apparatus for previously storing or inputting difference between a machine original point position and a fixing reference position;

a machine fixing apparatus for mechanically fixing the table or the drive mechanism at the fixing reference position of the alignment apparatus;

a machine fixing reference position storing apparatus for detecting and storing the fixing reference positions of a number at least the same as a number of freedom degrees provided to the table by the detecting apparatus; and

an absolute position storing apparatus provided to the detecting apparatus for storing values of the machine original point positions of the number at least the same as the number of the freedom degrees provided to the table as an absolute value in consideration of difference between the fixing reference position and the machine original point position, wherein

the table and the drive mechanism unit are moved to the machine original point position by reading the absolute values of the machine original point positions of the number at least the same as the number of the freedom degrees provided to the table from the absolute position storing apparatus and operating the motors of the number at least the same as the number of the freedom degrees provided to the table in a state in which the machine fixing apparatus is not present routinely after the above-described processing has been finished and a power source is introduced again.

Further, according to Claim 4, there is provided with an original point returning method of an alignment apparatus for operating a table mounted with an object in XYθ, Yθ, or θ by way of a drive mechanism arranged at a machine base portion to be positioned to a predetermined position, wherein

the drive mechanism includes a plurality of drive mechanism units each constituted by;
a mechanism portion including two translational freedom degree portions each having a translational freedom degree and one rotational freedom degree portion having a rotational freedom degree; and
a motor control apparatus including motors for driving the freedom degree portions of the two translational freedom degree portions and the one rotational freedom degree portion, a detecting apparatus for detecting an amount of operating the mechanism portion constituting a member to be detected, and a controller for controlling the motors by receiving an operation instruction to constitute the motors of a number at least the same as a number of freedom degrees of XYθ, Yθ or θ operation of the table;

the drive mechanism units includes an instructing apparatus for providing the operation instruction to the controller;

the table is operated to translationally move and rotationally move in two directions of the XYθ operation, to translationally move and rotationally move in one direction of the Yθ operation, or rotationally move of the θ operation by operating the motors respectively in a translational direction or a rotational direction;

the original point returning method including the steps of:

previously storing or inputting a machine original point position as a difference from a fixing reference position by a machine original point storing apparatus;

mechanically fixing the table or the drive mechanism to the fixing reference position of the alignment apparatus by a machine fixing apparatus;

detecting the machine fixing reference positions of the number at least the same as the number of freedom degrees provided to the table by the detecting apparatus to store in a machine fixing reference position storing apparatus;

disengaging the machine fixing apparatus;

detecting detecting apparatus reference position references of the number at least the same as the number of the freedom degrees provided to the table by driving the motors of the number at least the same as the number of the freedom degrees provided to the table;

storing differences between the detecting apparatus reference positions and the machine original point positions or the fixing reference positions of the number at least the same as the number of the freedom degrees provided to the table in the detecting apparatus reference position storing apparatus;

detecting the detecting apparatus reference position references of the number at least the same as the number of the freedom degrees provided to the table by driving the motors of the number at least the same as the number of the freedom degrees provided to the table in a state in which the machine fixing apparatus is not present routinely after the above-described processing has been finished and a power source is introduced again; and

calculating process moving amounts of the motors from the detecting apparatus reference position references to the machine original point positions or the fixing reference positions of the number at least the same as the number of the freedom degrees provided to the table by a machine original point returning amount calculating apparatus.

Further, according to Claim 5, there is provided with an original point returning method of an alignment apparatus for operating a table mounted with an object in XYθ, Yθ, or θ by way of a drive mechanism arranged at a machine base portion to be positioned to a predetermined position, wherein

the drive mechanism includes a plurality of drive mechanism units each constituted by;
a mechanism portion including two translational freedom degree portions each having a translational freedom degree and one rotational freedom degree portion having a rotational freedom degree; and
a motor control apparatus including motors for driving the freedom degree portions of the two translational freedom degree portions and the one rotational freedom degree portion, a detecting apparatus for detecting an amount of operating the mechanism portion constituting a member to be detected, and a controller for controlling the motors by receiving an operation instruction to constitute the motors of a number at least the same as a number of freedom degrees of XYθ, Yθ or θ operation of the table;

the drive mechanism unit includes an instructing apparatus for providing the operation instruction to the controller;

the table is operated to translationally move and rotationally move in two directions of the XYθ operation, to translationally move and rotationally move in one direction of the Yθ operation, or rotationally move of the θ operation by operating the motors respectively in a translational direction or a rotational direction;

the original point returning method including the steps of:

previously storing or inputting a machine original point position as difference from a fixing reference position by a machine original point storing apparatus;

mechanically fixing the table or the drive mechanism to the fixing reference position of the alignment apparatus by a machine fixing apparatus;

detecting a mark on the table by a two-dimensional position detecting apparatus;

receiving an image of the two-dimensional position detecting apparatus by a two-dimensional image processing apparatus and storing a reference image position in a reference image position storing apparatus by constituting an absolute position by a position of a mark of the image;

newly detecting the position of the mark of a current state by the two-dimensional position detecting apparatus and the two-dimensional image processing apparatus in a state in which the machine fixing apparatus is not present routinely after the above-described processing has been finished and a power source is introduced again;

calculating moving amounts of the motors of the number at least the same as the number of the freedom degrees provided to the table for making the table and the drive mechanism unit disposed at the machine original point position or the fixing reference position from a current position by comparing positions of the new image and the reference image position stored to the reference image position storing apparatus by a machine original point returning amount calculating apparatus; and

moving the table and the drive mechanism unit to the machine original point position by operating the motors of the number at least the same as the number of the freedom degrees provided to the table.

Further, according to Claim 6, there is provided with the original point returning method of an alignment apparatus according to Claim 5, repeating the steps of:

moving the table and the drive mechanism unit to the machine original point position by operating the motors of the number at least the same as the number of the freedom degrees provided to the table;

thereafter, detecting newly the position of a mark in the current state by the two-dimensional position detecting apparatus and the two-dimensional image processing apparatus; and

comparing with the position of the reference image stored in the reference image position storing apparatus;

when the positions do not coincide with each other,

calculating moving amounts of the motors of the number at least the same as the number of the freedom degrees provided to the table for making the table and the drive mechanism unit disposed at the machine original point position or the fixing reference position from a current position; and

moving the table and the drive mechanism unit to the machine original point position by operating the motors of the number at least the same as the number of the freedom degrees provided to the table.

Further, according to Claim 7, there is provided with an original point returning method of an alignment apparatus for operating a table mounted with an object in XYθ, Yθ, or θ by way of a drive mechanism arranged at a machine base portion to be positioned to a predetermined position, wherein

the drive mechanism includes a plurality of drive mechanism units each constituted by;
a mechanism portion including two translational freedom degree portions each having a translational freedom degree and one rotational freedom degree portion having a rotational freedom degree; and
a motor control apparatus including motors for driving the freedom degree portions of the two translational freedom degree portions and the one rotational freedom degree portion, a detecting apparatus for detecting an amount of operating the mechanism portion constituting a member to be detected, and a controller for controlling the motors by receiving an operation instruction to constitute the motors of a number at least the same as a number of freedom degrees of XYθ, Yθ or θ operation of the table;

the drive mechanism unit includes an instructing apparatus for providing the operation instruction to the controller;

the table is operated to translationally move and rotationally move in two directions of the XYθ operation, to translationally move and rotationally move in one direction of the Yθ operation, or rotationally move of the θ operation by operating the motors respectively in a translational direction or a rotational direction;

the original point returning method including the steps of:

previously storing or inputting a machine original point position as difference from a fixing reference position by a machine original point storing apparatus;

mechanically fixing the table or the drive mechanism to the fixing reference position of the alignment apparatus by a machine fixing apparatus;

detecting the fixing reference positions of the number at least the same as the number of freedom degrees provided to the table by the detecting apparatus;

storing values of the machine original point positions of the number at least the same as the number of the freedom degrees provided to the table as absolute values in an absolute position storing apparatus provided to the detecting apparatus in consideration of difference between the fixing reference position and the machine original point position;

reading the machine original point positions of the number at least the same as the number of the freedom degrees provided to the table from the absolute position storing apparatus in a state in which the machine fixing apparatus is not present routinely after the above-described processing has been finished and a power source is introduced again; and

moving the table and the drive mechanism unit to the machine original point position by operating the motors of the number at least the same as the number of the freedom degrees provided to the table.

Further, according to Claim 8, there is provided with the alignment apparatus according to any one of Claims 1 to 3, wherein

the drive mechanism further includes:

a 3 freedom degree mechanism including the translational freedom degree portion having two translational freedom degrees and the rotational freedom degree portion having one rotational freedom degree without including the motors.

Further, according to Claim 9, there is provided with the alignment apparatus according to any one of Claims 1 to 3, wherein

in the table having at least the two freedom degrees operated in Yθ, a 2 freedom degree mechanism including the translational freedom degree portion having one translational freedom degree and the rotational freedom degree portion having one rotational freedom degree without including the motors is provided.

Further, according to Claim 10, there is provided with the alignment apparatus according to Claim 9, wherein

in the table having at least the two freedom degrees operated in Yθ, the 2 freedom degree mechanism including a 2 freedom degree drive mechanism having the motors is provided.

Further, according to Claim 11, there is provided with the alignment apparatus according to any one of Claims 1 to 3, wherein

in the table having at least the rotational one freedom degree operated in θ, a rotational one freedom degree mechanism including one rotational freedom degree for supporting the table is provided.

Further, according to Claim 12, there is provided with the alignment apparatus according to any one of Claims 1 to 3, further including:

a first positioning apparatus for positioning the machine fixing apparatus to the machine base portion.

Further, according to Claim 13, there is provided with the alignment apparatus according to any one of Claims 1 to 3, further including:

a second positioning apparatus for positioning the machine fixing apparatus to the drive mechanism.

Further, according to Claim 14, there is provided with the alignment apparatus according to any one of Claims 1 to 3, further including:

a third positioning apparatus for positioning the machine fixing apparatus to the table.

Further, according to Claim 15, there is provided with the original point returning method of an alignment apparatus according to any one of Claims 1 to 5 and 7, including a step of:

positioning an installed position by a first positioning apparatus provided at the machine base portion.

Further, according to Claim 16, there is provided with the original point returning method of an alignment apparatus according to any one of Claims 1 to 5 and 7, including a step of:

positioning an installed position by a second positioning apparatus provided at the drive mechanism.

Further, according to Claim 17, there is provided with the original point returning method of an alignment apparatus according to any one of Claims 1 to 5 and 7, including a step of:

positioning an installed position by a third positioning apparatus provided at the table.

Further, according to Claim 18, there is provided with the alignment apparatus according to any one of Claims 1 to 3, further including:

a first position fixing apparatus for fixing the machine base portion and the machine fixing apparatus.

Further, according to Claim 19, there is provided with the alignment apparatus according to any one of Claims 1 to 3, further including:

a second position fixing apparatus for fixing the drive mechanism and the machine fixing apparatus.

Further, according to Claim 20, there is provided with the alignment apparatus according to any one of Claims 1 to 3, further including:

a third position fixing apparatus for fixing the table and the machine fixing apparatus.

Further, according to Claim 21, there is provided with the original point returning method of an alignment apparatus according to any one of Claims 1 to 5 and 7, wherein

the machine fixing apparatus and the machine base portion are fixed by using a first position fixing apparatus provided at the machine base portion.

Further, according to Claim 22, there is provided with the original point returning method of an alignment apparatus according to any one of Claims 1 to 5 and 7, wherein

the machine fixing apparatus and the drive mechanism are fixed by using a second position fixing apparatus provided at the drive mechanism.

Further, according to Claim 23, there is provided with the original point returning method of an alignment apparatus according to any one of Claims 1 to 5 and 7, wherein

the machine fixing apparatus and the table are fixed by using a third position fixing apparatus provided at the table.

Further, according to Claim 24, there is provided with the original point returning method of an alignment apparatus according to any one of Claims 1 to 5 and 7, wherein

the controller cuts a control of the motors, moves the table or the drive mechanism, and fixes the machine base portion and the table or the drive mechanism at the fixing reference position.

Further, according to Claim 25, there is provided with the alignment apparatus according to any one of Claims 1 to 3, wherein

the drive mechanism includes the rotational freedom portion above the translational freedom portion, and further includes the translational freedom degree portion above the rotational freedom degree portion.

Further, according to Claim 26, there is provided with the alignment apparatus according to any one of Claims 1 to 3, wherein

the drive mechanism further includes the translational freedom degree portion above the translational freedom degree portion, and includes the rotational freedom degree portion above the translational freedom degree portion.

Further, according to Claim 27, there is provided with the alignment apparatus according to any one of Claims 1 to 3, wherein

the drive mechanism includes the translational freedom degree portion above the rotational freedom degree portion, and further includes the translational freedom degree portion above the translational freedom degree portion.

Further, according to Claim 28, there is provided with the alignment apparatus according to Claim 1 or 3, further including:

a two-dimensional position detecting apparatus for grasping a position of a mark on the object or the table, and

a two-dimensional image processing apparatus for subjecting an image of the object caught by the two-dimensional position detecting apparatus to an image processing and calculating a correcting amount for correcting the position of the object, wherein

the position of the table or the object is corrected by operating the motors based on the correcting amount provided by the two-dimensional image processing apparatus.

Further, according to Claim 29, there is provided with the alignment apparatus according to Claim 2 or 28, including:

a plurality of the two-dimensional position detecting apparatus.

Further, according to Claim 30, there is provided with the alignment apparatus according to any one of Claims 1 to 3, wherein

the drive mechanism unit is arranged such that the motors of at least the number of the freedom degrees provided to the table are separated from a gravitational center of the table and move the table with being shifted from the gravitational center of the table.

Further, according to Claim 31, there is provided with the original point returning method of an alignment apparatus according to any one of Claims 4, 5 and 7, wherein

the drive mechanism units are arranged such that the motors of at least the number of the freedom degrees provided to the table are separated from a gravitational center of the table, and move the table with being shifted from the gravitational center of the table.

Further, according to Claim 32, there is provided with the alignment apparatus according to any one of Claims 1 to 3, wherein

the motors for driving the translational freedom degree portion of the drive mechanism is a linear motor.

Further, according to Claim 33, there is provided with the original point returning method of an alignment apparatus according to any one of Claims 4, 5 and 7, wherein

a linear motor as the motor drives the translational freedom degree portion of the drive mechanism unit.

Further, according to Claim 34, there is provided with the alignment apparatus according to any one of Claims 1 to 3, wherein

the fixing reference position is the machine original point position.

Further, according to Claim 35, there is provided with the original point returning method of an alignment apparatus according to any one of Claims 4, 5 and 7, wherein

the machine original point position is used as the fixing reference position.

Further, according to Claim 36, there is provided with a turning table including the alignment apparatus according to any one of Claims 1 to 3.

Further, according to Claim 37, there is provided with a translational table including the alignment apparatus according to any one of Claims 1 to 3.

Further, according to Claim 38, there is provided with a machine including the alignment apparatus according to any one of Claims 1 to 3.

Further, according to Claim 39, there is provided with a machine control system including at least one drive mechanism portion and the machine according to Claim 38 as the drive mechanism portion.

### EFFECTS OF THE INVENTION

According to the invention according to Claims 1 through 7, the table operated in XYθ, Yθ, θ can accurately be fixed, and therefore, the machine original point can be grasped and the table can be operated accurately. Further, when setting thereof is finished once, the alignment apparatus can simply be returned to the machine original point routinely.

According to the invention according to Claims 1 and 4, the original point returning can be carried out by using the detecting apparatus of an increment value type.

According to the invention according to Claims 2, 5 and 6, the original point returning can be carried out by using the two-dimensional image taking apparatus.

According to the invention according to Claim 3 and Claim 7, the original point returning can be carried out by using the detecting apparatus of the absolute value type.

Further, according to the invention according to Claim 8, the table can be supported by the mechanism having 3 freedom degrees, and therefore, the table can be supported by a plurality of portions thereof without hampering the operation of the table, and bending of the table can be restrained.

Further, according to the invention according to Claims 9 and 10, in the table operated in Yθ, the table can be supported by the mechanism having the 2 freedom degrees, and therefore, the table can be supported by the center of rotation without hampering the operation of the table operated in Yθ, and bending of the table can be restrained. Further, the table can accurately be operated in Yθ by restraining the shift of the table operated in Yθ in X direction. In addition thereto, according to the invention according to Claim 10, the function of the motor can dispersingly constituted, and therefore, a capacity of the motor can dispersingly be selected.

Further, according to the invention according to Claim 11, in the table operated in θ, the table can be supported by the rotational 1 freedom degree mechanism having the rotational 1 freedom degree, and therefore, the table can be supported without hampering the operation of the table operated in θ, and bending of the table can be restrained. Further, the table can accurately be operated in θ by restraining a shift of the table operated in θ in XY directions.

Further, according to the invention according to Claims 12 through 17, the machine fixing portion can accurately be positioned to the machine base portion, the drive mechanism, the table by the first positioning apparatus, the second positioning apparatus, the third positioning apparatus, and the table or the drive mechanism unit can accurately be positioned to the position at which the machine original point can be grasped.

Further, according to the invention according to Claims 18 through 23, the machine fixing apparatus, the machine base portion, the table or the drive mechanism can firmly be fixed to the position at which the machine original point can accurately be grasped by the first position fixing apparatus, the second position fixing apparatus, the third position fixing apparatus.

Further, according to the invention according to Claim 24, the control is cut, and therefore, the table or the drive mechanism unit can simply be moved even manually, and the table or the drive mechanism can simply be fixed by the machine fixing apparatus.

Further, according to the invention according to Claims 25 through 27, the drive mechanism or the drive mechanism unit can be utilized by various constitutions.

Particularly according to the invention according to Claim 25, the rotational drive portion can be placed by being interposed by the direct advancing guides of the two translational drive portions, the table through the machine base can continuously be supported, and therefore, the table through the machine base can be supported by restraining a deformation of the drive mechanism against the table or other load. According to the invention according to Claim 26 and Claim 27, angles of attaching the two translational drive portions are fixed, and therefore, an operation amount necessary in moving the table can comparatively simply be calculated.

Further, according to the invention according to Claim 28, the position of the table or the object can be grasped by the two-dimensional position detecting apparatus and the two-dimensional image processing apparatus, and therefore, the position of the table or the object can be corrected by driving the motor.

Further, according to the invention according to Claim 29, a plurality of two-dimensional position detecting apparatus can be used, and therefore, even when the table is large-sized, alignment marks can be detected at a plurality of points, and the machine original point or the fixing reference position can be grasped by promoting an accuracy of detecting a positional shift.

Further, according to the invention according to Claims 30 and 31, in either thereof, the table can firmly be operated in accordance with specifications of XYθ operation, Yθ operation or θ operation of the table and the drive mechanism unit can be arranged to constitute a minimum number of the motors.

Further, according to the invention according to Claims 32 and 33, in either thereof, the linear motor can be utilized, and therefore, a mechanism having a small mechanical loss is constituted, and the translational movement can be carried out highly accurately by utilizing a mechanism with a small burden of maintenance and control.

Further, according to the invention according to Claims 34 and 35, in either thereof, the fixing reference position can be dealt with as the machine original point position, and therefore, a processing procedure can be simplified.

Further, according to the invention according to Claim 36, the turning table is attached, and therefore, the table is operated in XYθ, Yθ or θ and the alignment apparatus which cannot provide a large rotating amount can be rotated by the large amount.

Further, according to the invention according to Claim 37, the translational table is attached, and therefore, the table is operated in XYθ, Yθ or θ and the alignment apparatus which cannot carry out a large translational movement can be translationally moved by the large amount.

Further, according to the invention according to Claims 38 and 39, the table constitutes the machine including the arrangement apparatus operated in XYθ, Yθ or θ, and therefore, the operation by the various operation can be carried out by operating other drive mechanism.

### BRIEF DESCRIPTION OF THE DRAWINGS

FIG. 1 is a schematic diagram and a control block diagram of an alignment apparatus showing a first embodiment of the invention.

FIG. 2 is a top view and a view of arranging a drive mechanism unit of the alignment apparatus showing the first embodiment of the invention.

FIG. 3 is an outline view of the drive mechanism unit of the alignment apparatus showing the first embodiment of the invention.

FIG. 4 is a view showing a translational movement of a table of the alignment apparatus showing the first embodiment of the invention.

FIG. 5 is a view showing a rotational movement of the table of the alignment apparatus showing the first embodiment of the invention.

FIG. 6 is a view showing the rotational movement of the table constituting a problem of the alignment apparatus showing the first embodiment of the invention.

FIG. 7 is a diagram showing a relationship of the rotational movement of the table constituting the problem of the alignment apparatus showing the first embodiment of the invention and a translational movement of a motor.

FIG. 8 is a flowchart showing an original point returning method of the alignment apparatus showing the first embodiment of the invention.

FIG. 9 is a flowchart showing a method of fixing the table or the drive mechanism unit of the alignment apparatus showing the first embodiment of the invention.

FIG. 10 is an outline view showing a machine fixing apparatus of the alignment apparatus showing the first embodiment of the invention.

FIG. 11 is a top view showing a situation of fixing a machine of the alignment showing the first embodiment of the invention and a diagram of arranging the drive mechanism unit.

FIG. 12 is an outline view for explaining the original point returning method of the alignment apparatus showing the first embodiment of the invention.

FIG. 13 is a schematic diagram and a control block diagram of an alignment apparatus showing a second embodiment of the invention.

FIG. 14 is an outline view of a drive mechanism unit of the alignment apparatus showing the second embodiment of the invention.

FIG. 15 is a view showing a rotational movement of a table of the alignment apparatus showing the second embodiment of the invention.

FIG. 16 is a flowchart showing an original point returning method of the alignment apparatus showing the second embodiment of the invention.

FIG. 17 is a flowchart showing a method of fixing a table of the alignment apparatus showing the second embodiment of the invention.

FIG. 18 is a top view showing a situation of fixing a machine of the alignment apparatus showing the second embodiment of the invention.

FIG. 19 is an outline view showing a machine fixing apparatus of the alignment apparatus showing the second embodiment of the invention.

FIG. 20 is a view showing a position correcting method of an object by a two-dimensional position detecting apparatus and a two-dimensional image processing apparatus of the alignment apparatus showing the second embodiment of the invention.

FIG. 21 is a view showing an original point position calculating method by the two-dimensional position detecting apparatus and the two-dimensional image processing apparatus of the alignment apparatus showing the second embodiment of the invention.

FIG. 22 is a schematic diagram and a control block diagram of an alignment apparatus showing a third embodiment of the invention.

FIG. 23 is a top view and a view of arranging a drive mechanism unit of the alignment apparatus showing the third embodiment of the invention.

FIG. 24 is an outline view of the drive mechanism unit (6a) of the alignment apparatus showing the third embodiment of the invention.

FIG. 25 is an outline view of the drive mechanism unit (6b) of the alignment apparatus showing the third embodiment of the invention.

FIG. 26 is an outline view of the drive mechanism unit (6c) of the alignment apparatus showing the third embodiment of the invention.

FIG. 27 is an outline view of a 3 freedom degree mechanism of the alignment apparatus showing the third embodiment of the invention.

FIG. 28 is a view showing an arrangement of a drive mechanism and a rotational movement of a table of the alignment apparatus showing the third embodiment of the invention.

FIG. 29 is an outline view of Example 1 of other drive mechanism unit of the alignment apparatus showing the third embodiment of the invention.

FIG. 30 is an outline view of Example 2 of other drive mechanism unit of the alignment apparatus showing the third embodiment of the invention.

FIG. 31 is an outline view of Example 3 of other drive mechanism unit of the alignment apparatus showing the third embodiment of the invention.

FIG. 32 is an outline view of Example 4 of other drive mechanism unit of the alignment apparatus showing the third embodiment of the invention.

FIG. 33 is an outline view of Example 5 of other drive mechanism unit of the alignment apparatus showing the third embodiment of the invention.

FIG. 34 is an outline view of Example 6 of other drive mechanism unit of the alignment apparatus showing the third embodiment of the invention.

FIG. 35 is an outline view of Example 7 of other drive mechanism unit of the alignment apparatus showing the third embodiment of the invention.

FIG. 36 is an outline view of Example 8 of other drive mechanism unit of the alignment apparatus showing the third embodiment of the invention.

FIG. 37 is an outline view of Example 9 of other drive mechanism unit of the alignment apparatus showing the third embodiment of the invention.

FIG. 38 is an outline view of Example 10 of other drive mechanism unit of the alignment apparatus showing the third embodiment of the invention.

FIG. 39 is an outline view of Example 11 of other drive mechanism unit of the alignment apparatus showing the third embodiment of the invention.

FIG. 40 is an outline view of Example 12 of other drive mechanism unit of the alignment apparatus showing the third embodiment of the invention.

FIG. 41 is an outline view of Example 13 of other drive mechanism unit of the alignment apparatus showing the third embodiment of the invention.

FIG. 42 is an outline view of Example 14 of other drive mechanism unit of the alignment apparatus showing the third embodiment of the invention.

FIG. 43 is an outline view of Example 15 of other drive mechanism unit of the alignment apparatus showing the third embodiment of the invention.

FIG. 44 is an outline view of Example 16 of other drive mechanism unit of the alignment apparatus showing the third embodiment of the invention.

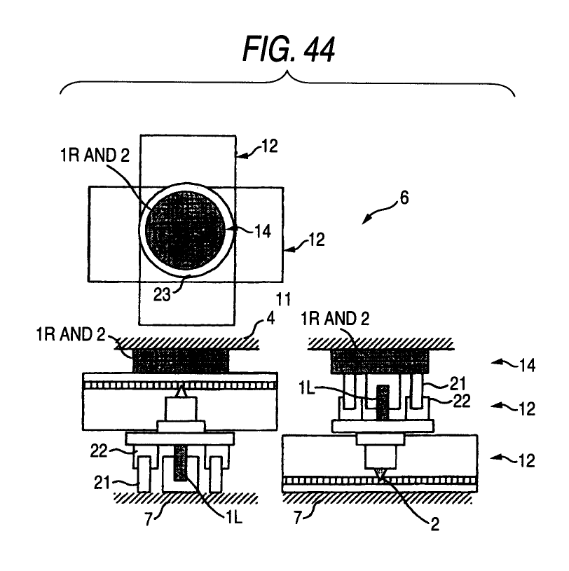

FIG. 45 is an outline view of Example 1 of other 3 freedom degree mechanism of the alignment apparatus showing the third embodiment of the invention.

FIG. 46 is an outline view of Example 2 of other 3 freedom degree mechanism of the alignment apparatus showing the third embodiment of the invention.

FIG. 47 is a top view and a view of arranging the drive mechanism unit or the 3 freedom degree mechanism of the alignment apparatus showing the third embodiment of the invention.

FIG. 48 is a top view and a view showing arrangement example of other drive mechanism unit or a 3 freedom degree mechanism.

FIG. 49 is a top view and a view showing arrangement example 2 of other drive mechanism unit or a 3 freedom degree mechanism of the alignment apparatus showing the third embodiment of the invention.

FIG. 50 is a top view and a view showing arrangement example 3 of other drive mechanism or a 3 freedom degree mechanism of the alignment apparatus showing the third embodiment of the invention.

FIG. 51 is a schematic diagram and a control block diagram of an alignment apparatus showing a fourth embodiment of the invention.

FIG. 52 is a top view and a view of arranging a drive mechanism unit of the alignment apparatus showing the fourth embodiment of the invention.

FIG. 53 is an outline view of a 2 freedom degree mechanism of the alignment apparatus showing the fourth embodiment of the invention.

FIG. 54 is a view showing a translational movement of a table of the alignment apparatus showing the fourth embodiment of the invention.

FIG. 55 is a view showing a rotational movement of the table of the alignment apparatus showing the fourth embodiment of the invention.

FIG. 56 is a flowchart showing an original point returning method of the alignment apparatus showing the fourth embodiment of the invention.

FIG. 57 shows Example 1 of other schematic diagram and a control block diagram of the alignment apparatus showing the fourth embodiment of the invention.

FIG. 58 is a top view and a view of arranging a drive mechanism unit of other Example 1 of the alignment apparatus showing the fourth embodiment of the invention.

FIG. 59 shows Example 2 of other schematic diagram and a control block diagram of the alignment apparatus showing the fourth embodiment of the invention.

FIG. 60 is a top view and a view of arranging the drive mechanism unit of other Example 2 of the alignment apparatus showing the fourth embodiment of the invention.

FIG. 61 is an outline view of a 2 freedom degree drive mechanism of other Example 2 of the alignment apparatus showing the fourth embodiment of the invention.

FIG. 62 shows Example 1 of an outline view of other 2 freedom degree mechanism of the alignment apparatus showing the fourth embodiment of the invention.

FIG. 63 shows Example 2 of an outline view of other 2 freedom degree drive mechanism of the alignment apparatus showing the fourth embodiment of the invention.

FIG. 64 is a schematic diagram and a control block diagram of an alignment apparatus showing a fifth embodiment of the invention.

FIG. 65 is a top view and a view of arranging a drive mechanism unit of the alignment apparatus showing the fifth embodiment of the invention.

FIG. 66 is a view showing a rotational movement of a table of the alignment apparatus showing the fifth embodiment of the invention.

FIG. 67 shows Example 1 of other schematic diagram and a control block diagram of the alignment apparatus showing the fifth embodiment of the invention.

FIG. 68 is a top view and a view of arranging the drive mechanism of other Example 1 of the alignment apparatus showing the fifth embodiment of the invention.

FIG. 69 illustrates a top view and an arranging view and a side view of a turning table including an alignment apparatus showing a sixth embodiment of the invention.

FIG. 70 illustrates views showing a table of a translational table including the alignment apparatus showing the sixth embodiment of the invention and a rotational movement of the translational table.

FIG. 71 illustrates a top view and a side view of a translational table including an alignment apparatus showing a seventh embodiment of the invention and a view of arranging a drive mechanism unit and a drive mechanism portion.

FIG. 72 is a top view of a machine control system of a gantry mechanism constituting a machine including an alignment apparatus showing an eighth embodiment of the invention.

FIG. 73 is a view showing an operation of the gantry mechanism constituting the machine including the alignment apparatus showing the eighth embodiment of the invention.

FIG. 74 is a view showing the alignment apparatus of the gantry mechanism constituting the machine including the alignment apparatus showing the eighth embodiment of the invention and an operation of the gantry mechanism.

FIG. 75 illustrates a top view and a side view of a gantry mechanism constituting a machine including an alignment apparatus showing a ninth embodiment of the invention and a machine control system of a gate type fixing mechanism.

FIG. 76 is a front view showing an embodiment of a stage apparatus including a linear motor of Patent Reference 1 according a first example of a conventional art viewed from X direction constituting one direction.

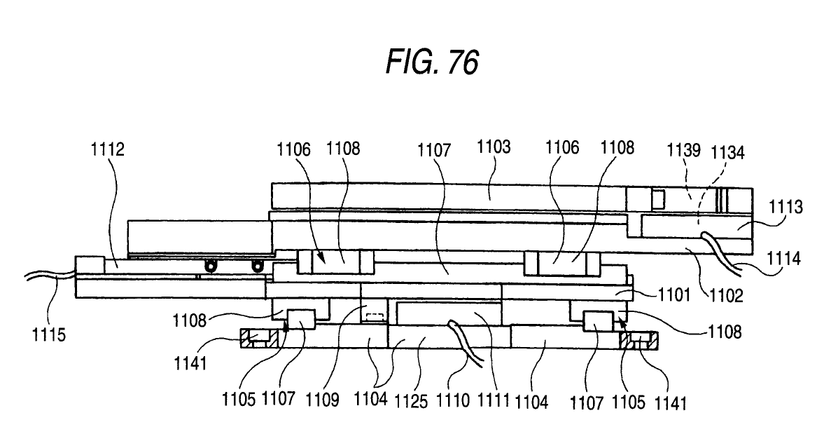

FIG. 77 is a plane view showing the stage apparatus of FIG. 34 of Patent Reference 1 according the first example of the conventional art.

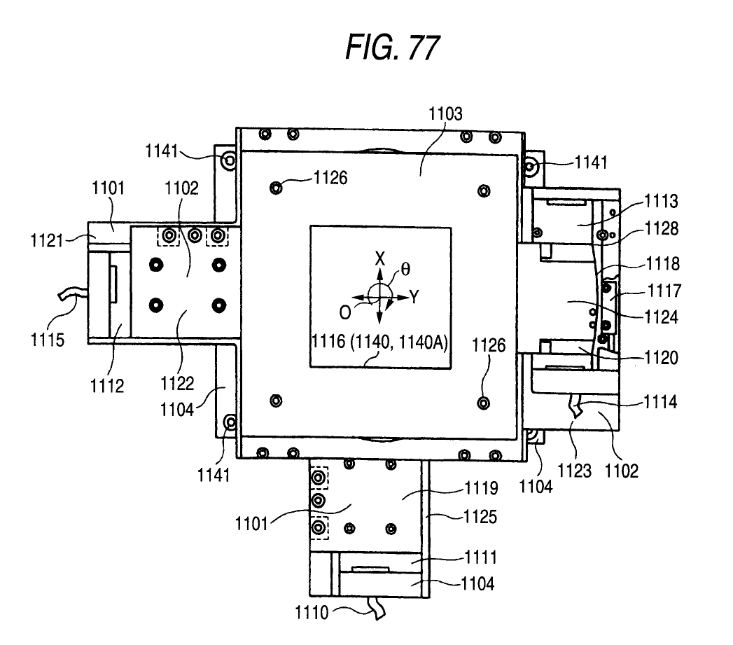

FIG. 78 is a partially broken disassembled perspective view of a 2 axes parallel/1 axis turning movement guide mechanism of Patent Reference 2 according to a second example of the conventional art.

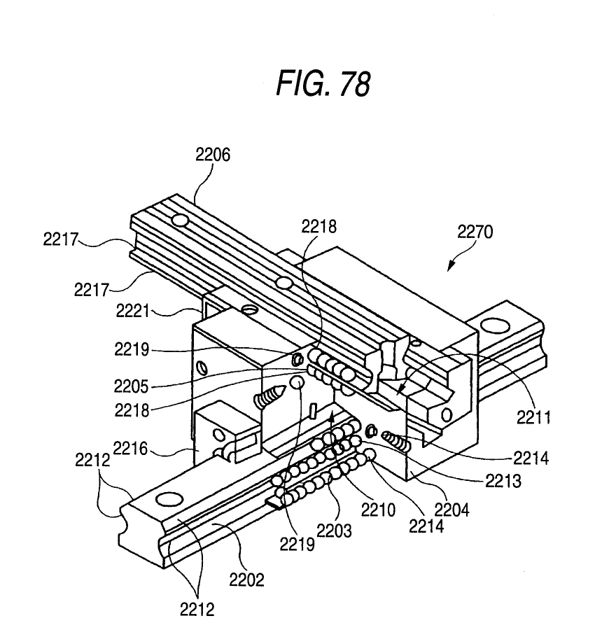

FIG. 79 shows a 2 axes parallel/1 axis turning table apparatus using the 2 axes parallel/1 axis turning movement guide mechanism of Patent Reference 2 according to the second example of the conventional art. (a) of the drawing is a plane view omitting a table to show by a two-dotted chain line, and (b) of the drawing is a front view.

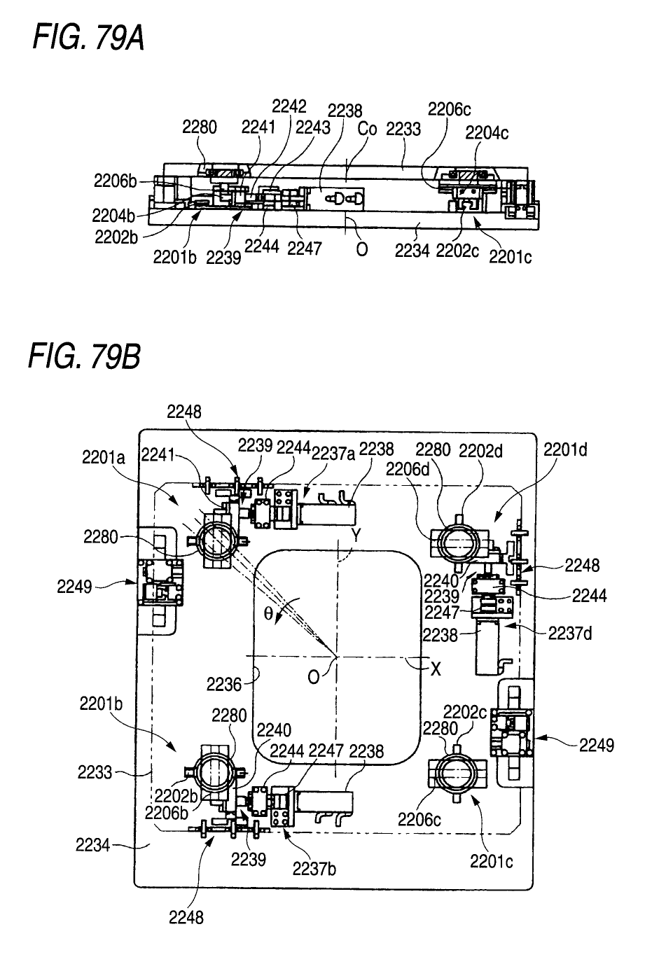

FIG. 80 is a plane view of the table of Patent Reference 2 according to the second example of the conventional art.

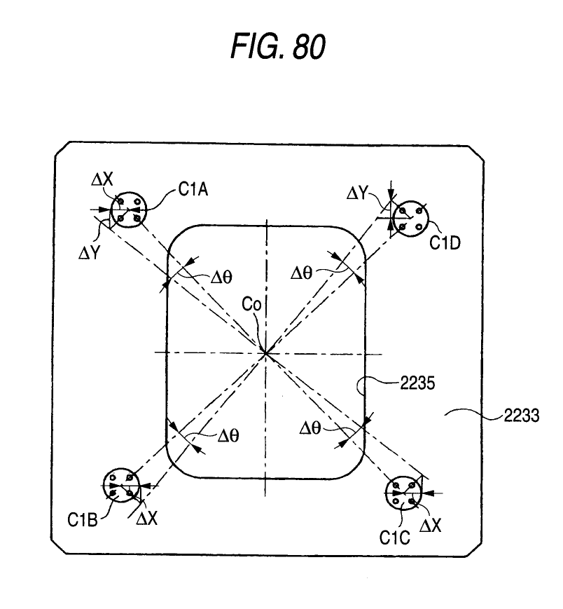

FIG. 81 is an outline view of a stage apparatus of Patent Reference 3 according to a third embodiment of a conventional art.

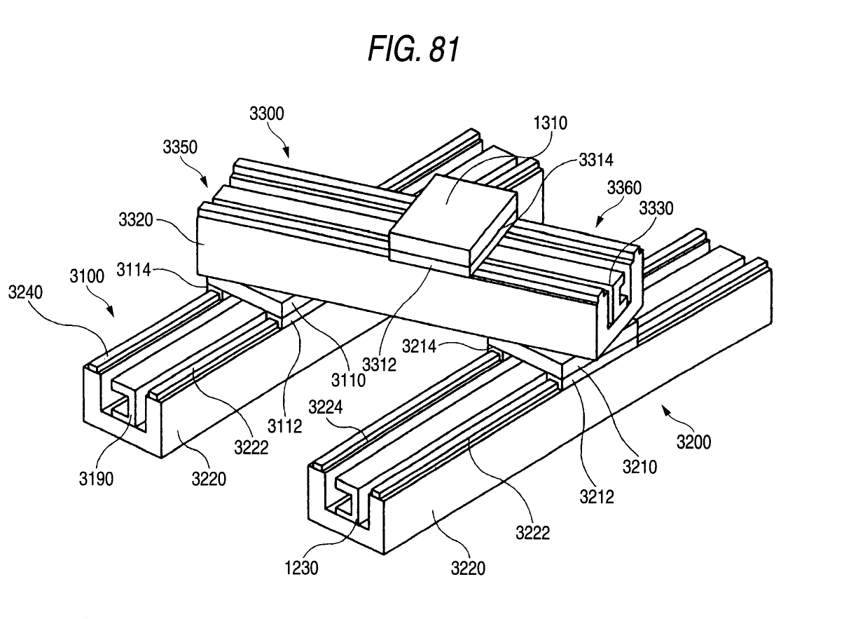

FIG. 82 is a perspective view showing a mode of an axially supporting portion of a direct advancing stage 3300 of the stage apparatus of Patent Reference 3 according to the third embodiment of the conventional art.

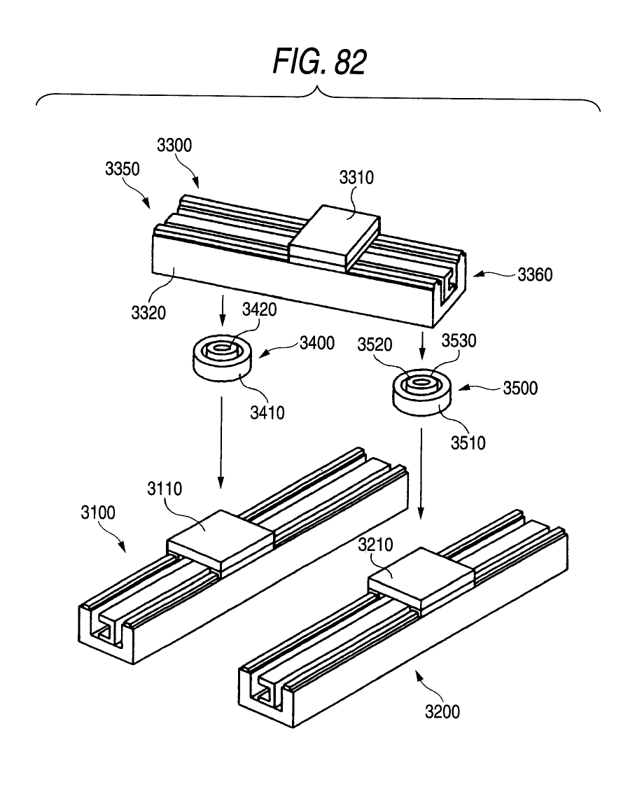

FIG. 83 illustrates views showing details of an axially supporting member 3400 and an axially supporting member 3500 of the stage apparatus of Patent Reference 3 according to the third example of the conventional art.

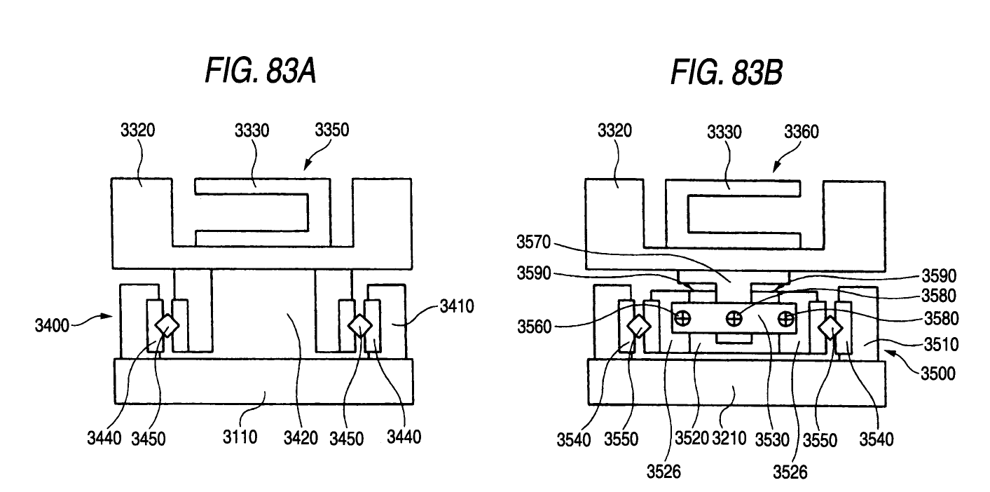

FIG. 84 is a view viewing an inner side cylinder portion 3520 of the stage apparatus of Patent Reference 3 according to the third example of the conventional art from above.

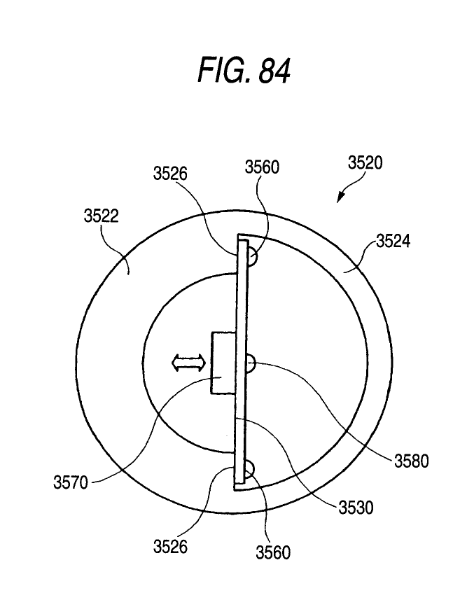

FIG. 85 illustrates views showing a specific mode of positioning a table of the stage apparatus of Patent Reference 3 according to the third example of the conventional art.

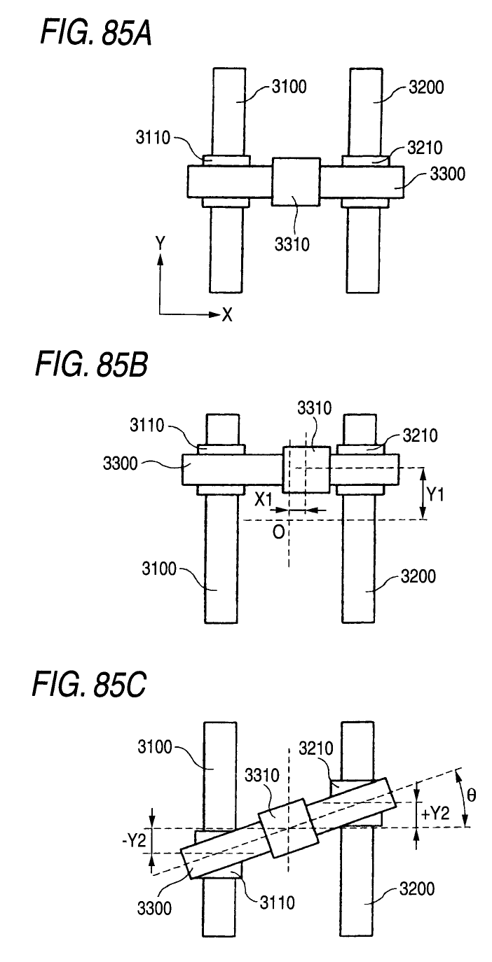

FIG. 86 is a view showing a behavior when a leaf spring portion 3530 of the stage apparatus of Patent Reference 3 according to the third example of the conventional art is bent.

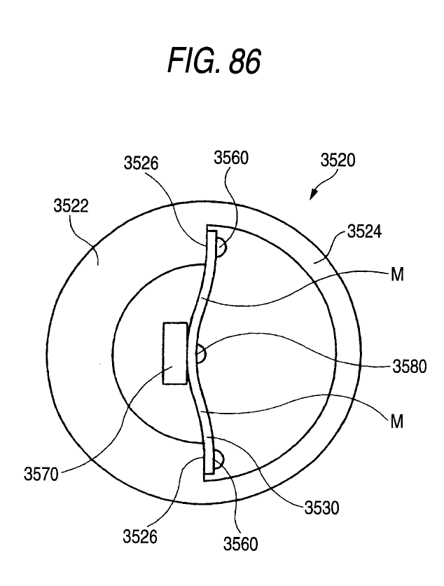

### DESCRIPTION OF REFERENCE NUMERALS AND SIGNS

1 motor
1L linear motor
1R rotating type motor
2 detecting apparatus
3 controller
4 table
5 object
6 drive mechanism unit
7 machine base portion
8 instructing apparatus
9 two-dimensional position detecting apparatus
10 two-dimensional image processing apparatus
11 translational freedom degree portion
12 translational drive portion
13 rotational freedom degree portion
14 rotating drive portion
16 3 freedom degree mechanism
17 2 freedom degree mechanism
18 2 freedom degree drive mechanism
19 rotational 1 freedom degree mechanism
21 direct advancing guide
22 direct advancing guide block
23 rotating bearing
24 curve guide
25 curve guide block
30 machine original point position
31 fixing reference position
32 detecting apparatus reference position
41 machine fixing apparatus
42 machine fixing reference position storing apparatus
43 machine original point storing apparatus
44 detecting apparatus reference position storing apparatus
45 machine original point returning amount calculating apparatus
46 drive mechanism
47 absolute position storing apparatus
48 reference image position storing apparatus
51 first positioning apparatus
52 second positioning apparatus
53 third positioning apparatus
54 first position fixing apparatus
55 second position fixing apparatus
56 third position fixing apparatus
59 drive mechanism portion
60 alignment apparatus
61 turning table
62 translational table
63 gantry movable portion

### BEST MODE FOR CARRYING OUT THE INVENTION

Embodiments of the invention will be explained in reference to the drawings as follows.

### Example 1

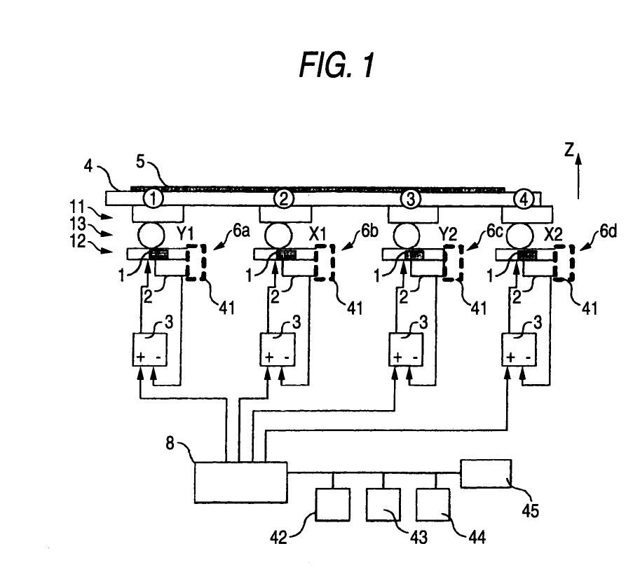

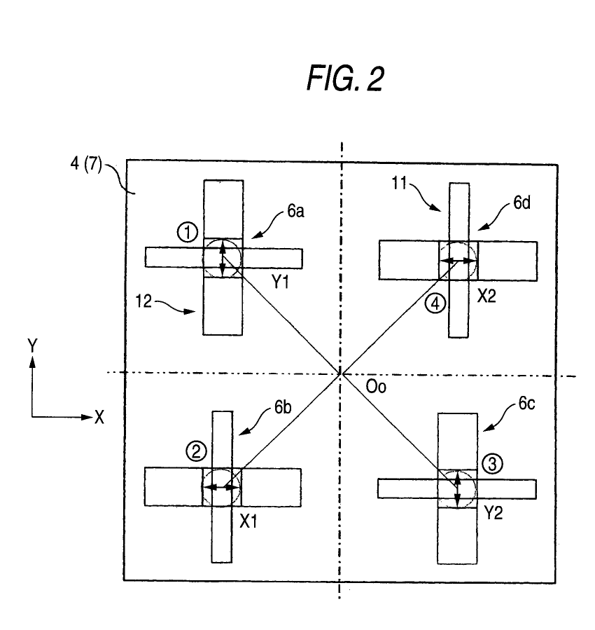

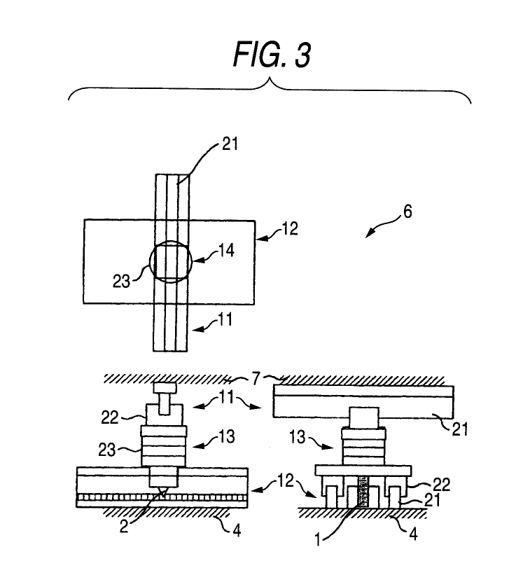

FIG. 1 is a schematic diagram and a control block diagram of an alignment apparatus showing a first embodiment of the invention, FIG. 2 is a top view of the alignment apparatus showing the first embodiment of the invention and a view of arranging a drive mechanism unit, and FIG. 3 is an outline view of a drive mechanism unit of the alignment apparatus showing the first embodiment of the invention. In the drawings, numeral 1 designates a motor (linear motor 1L), numeral 2 designates a detecting apparatus, numeral 3 designates a controller, numeral 4 designates a table, numeral 5 designates an object, numeral 6 designates a drive mechanism unit, numeral 7 designates a machine base portion, numeral 8 designates an instructing apparatus, numeral 11 designates a translational freedom degree portion, numeral 12 designates a translational drive portion, numeral 13 designates a rotational freedom degree portion, numeral 21 designates a direct advancing guide, numeral 22 designates a direct advancing guide block, numeral 23 designates a rotating bearing, numeral 41 designates a machine fixing apparatus, numeral 42 designates a machine fixing reference position storing apparatus, numeral 43 designates a machine original point storing apparatus, numeral 44 designates a detecting apparatus reference position storing apparatus, numeral 45 designates a machine original point returning amount calculating apparatus. Further, the detecting apparatus 2 is of an increment value type.

As shown by FIG. 1 and FIG. 2, the alignment apparatus is fixed with 4 of the drive mechanism units 6 between the machine base portion 7 and the table 4.

As shown by FIG. 3, the drive mechanism unit 6 is a mechanism having 2 translational freedom degrees and 1 rotational freedom degree including the translational drive portion 12 having a linear motor 1L for 1 translational freedom degree.

The translational freedom degree portion 11 having a translational freedom degree without a linear motor constitutes the drive mechanism unit 6 by being mounted above the translational drive portion 12 by interposing the rotational freedom degree portion 13 having a rotational freedom degree therebetween. That is, the drive mechanism unit 6 is constructed by a constitution of successively arranging mechanisms of the translational freedom degree, a rotational freedom degree, and a translational freedom degree.

Further, the translational freedom degree portion 11 and the translational drive portion 12 are provided with a direct advancing bearing comprising the direct advancing guide 21 and the direct advancing guide block 22, and the rotational freedom degree portion 14 is provided with the rotating bearing 23 for realizing a rotational freedom degree between the translational freedom degree portion 11 and the translational freedom degree portion 12.

2 of the drive mechanism units 6 are arranged at the machine base portion 7 to be able to be operated in X direction, and remaining 2 of the drive mechanism units 6 are arranged at corners of the machine base portion 7, the table 4 such that the translational drive portion 12 can be operated in Y direction.

Further, the linear motors 1L constituting the translational drive portions 11 are respectively connected with the controllers 3. The respective controllers 3 are provided with the instructing apparatus 8 for transmitting an operation instructing signal for operating the linear motors 1L to constitute a motor control apparatus. The instructing apparatus 8 forms an operation instruction, and the controller 3 operates the motor 1 in accordance with the operation instruction. The detecting apparatus 2 reads a position of a movable portion of the translational drive portion 12 and the controller 3 controls the motor 1 to nullify an error from the operation instruction.

A portion of the invention which differs from Patent Reference 1 resides in that a movement of the table in XYθ directions is realized by including 4 of the drive mechanism units 6 on a plane of the machine base portion 7.

A portion of the invention which differs from Patent Reference 2 resides in that the machine fixing apparatus 41, the machine fixing reference position storing apparatus 42, the machine original point storing apparatus 43, and the machine original point return amount calculating apparatus 45 are provided, further, the motor 1 is constituted by the linear motor 1L without a mechanical loss and a backlash.

A portion of the invention which differs from Patent Reference 3 resides in a portion of realizing rotation (turning) of the table 4 by the drive mechanism units 6 including 4 of the drive mechanism units 6 each successively arranged with mechanisms of the translational freedom degree, the rotational freedom degree, and the translational freedom degree. Further, the invention can operate the table in XYθ and a number of freedom degrees of the table differ.

Next, an operation of the alignment apparatus will be explained.

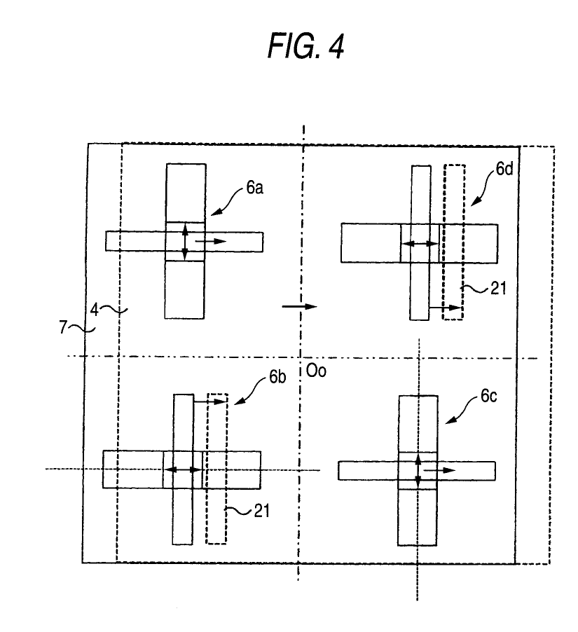

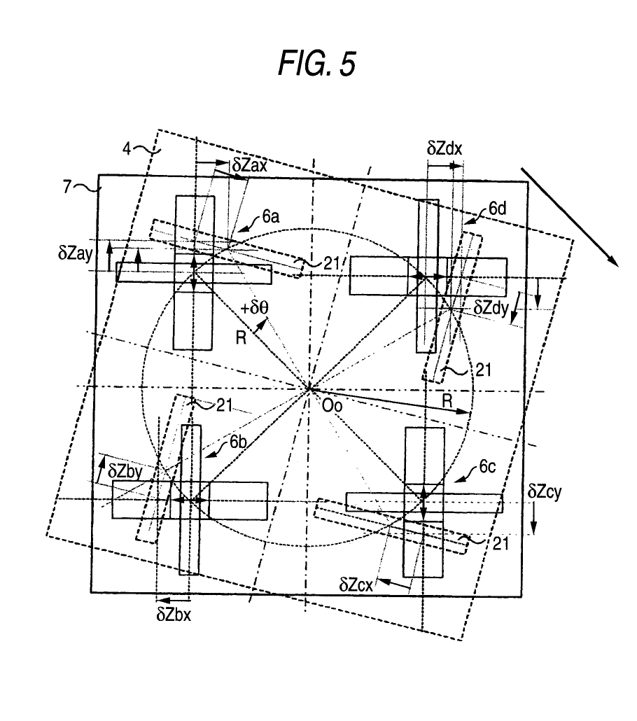

FIG. 4 is a view showing a translational movement of the table of the alignment apparatus showing the first embodiment of the invention, and FIG. 5 is a view showing a rotational movement of the table of the alignment apparatus showing the first embodiment of the invention. As shown by FIG. 4 and FIG. 5, the alignment apparatus can be moved in XYθ directions.

In order to move the table in a translational direction, the movement is realized by moving 2 of the linear motors 1L in the same direction by using the drive mechanism units 6 arranged with the linear motors 1 in XY directions. In moving the table 4 in X direction, as shown by FIG. 4, the drive mechanism units 6b and 6d arranged with the linear motors 1 in a direction of X direction are operated in the same direction. In case of Y direction, the drive mechanism units 6a and 6c arranged with the linear motors 1L in a direction of Y direction are operated in the same direction. When the linear motors 1L are moved simultaneously in X and Y directions, the table 4 is skewedly moved. When XY moving amounts are adjusted, an angle of translationally moving skewedly can be determined.

Thereby, the table 5 can be moved in the translational direction.

Further, in order to move the table 4 rotationally, the linear motors 1L of the drive mechanism units 6 arranged in twos in XY directions are operated in directions respectively reverse to each other and the table 4 can be rotated as shown in FIG. 5.

In FIG. 5, rotation Oo designates a center and a center of rotation of the table, notation R designates a radius of rotation, notation δθ designates an angle of rotation of the table, and notation δZi designates an amount of operating the linear motor 1 of the drive mechanism unit 6.

In order to rotate the table 4 indicated by a bold line centering on Oo, the linear motor 1 of the drive mechanism unit 6a may be operated by δZay, the linear motor 1 of the drive mechanism unit 6b may be operated by δZbx, the linear motor 1 of the drive mechanism unit 6c may be operated by δZcy, and the linear motor 1 of the drive mechanism unit 6d may be operated by δZdx. When the linear motor 1 is operated as shown by FIG. 5, the translational freedom degree portion 11 and the rotational freedom degree portion 13 without the linear motor 1 of the drive mechanism unit 6 are operated, and therefore, the table 4 is rotated by δθ.

The δθ rotation and amounts of moving the respective linear motors 1 can geometrically be determined.

The table 4 can be moved in the rotational direction as described above.

The movement can be realized by forming an operation instruction necessary for moving the table 4 shown in FIG. 4 and FIG. 5 of the embodiment accurately by the instructing apparatus 8 to be provided to 4 of the controllers 3 and accurately controlling 4 of the motors 1 (linear motors 1L).

However, according to the alignment apparatus of the embodiment of the invention, although the amount of moving the linear motor 1 necessary for rotating the table 4 needs to be calculated geometrically, there is a nonlinear relationship between rotation of the table 4 and the translational movement of the linear motor 1, and therefore, there poses a problem in controlling to operate the table 4 to which attention is to be paid.

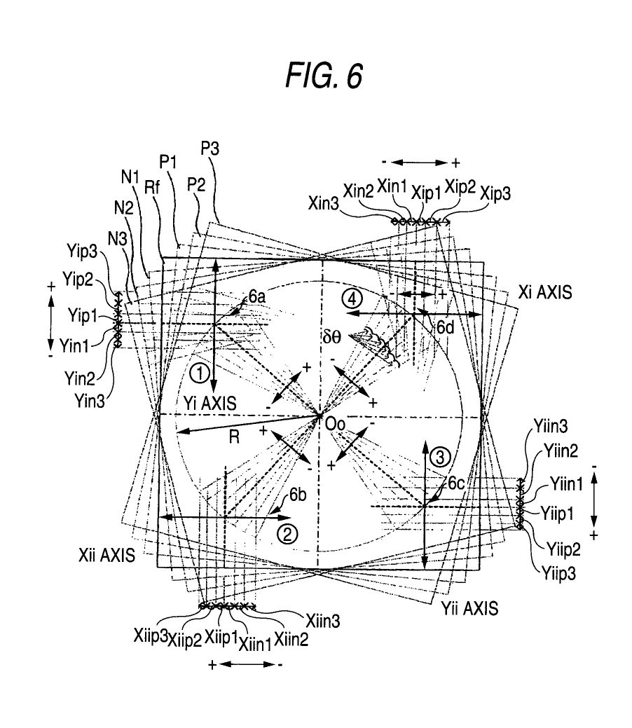

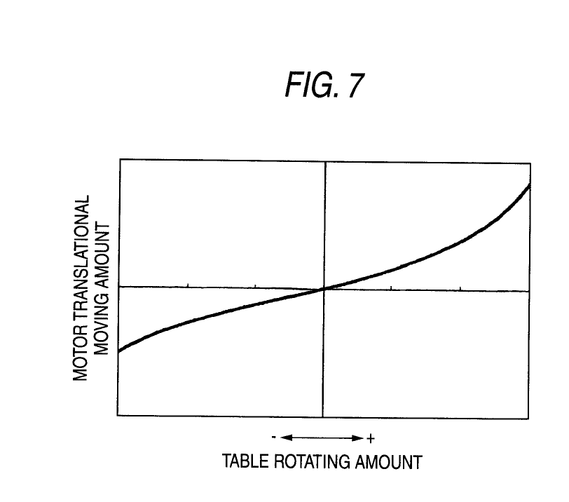

FIG. 6 is a view showing a rotational movement of a table constituting the problem of the alignment apparatus showing the first embodiment of the invention, and FIG. 7 is a view showing a relationship between a rotational movement of a table and a translational movement of a motor constituting the problem of the alignment apparatus showing the first embodiment of the invention.

FIG. 6 shows a result of regularly and reversely rotating the table 4 in 3 stages at equal intervals by δθ centering on Oo.

At this occasion, amounts of changes of moving amounts of the linear motors 1L necessary in regular rotation, that is, amounts of changes of moving amounts of the linear motors 1L when the table 4 is rotated from Rf (initial state) to P1, P2, P3, becomes Yip1, Yip2, Yip3 at the drive mechanism unit 6a, Xiip1, Xiip2, Xiip3 at the drive mechanism unit 6b, Yiip1, Yiip2, Yiip3 at the drive mechanism unit 6c and Xip1, Xip2, Xip3 at the drive mechanism unit 6d.

In reverse rotation, when the table 4 is rotated from Rf (initial state) to N1, N2, N3, similarly, the amounts become Yin1, Yin2, Yin3, Xiin1, Xiin2, Xiin3, Yiin1, Yiin2, Yiin3, Xin1, Xin2, Xin3.

Although in any of the cases, the amounts of changing the rotational angle of the table 4 is the equal interval of δθ, the translational movement amounts of the linear motors 1L are not constituted by equal intervals. Further, also moving amounts of the linear motors 1L in positive and negative directions necessary for regularly and reversely rotating the table 4 differ from each other.

Specifically, the moving amounts of the respective linear motors 1 are brought into following relationships.

Yip1≠Yip2, Yip2≠Yip3, Yin1≠Yin2, Yin2≠Yin3,

Xiip1≠Xiip2, Xiip2≠Xiip3, Xiin1≠Xiin2, Xiin2≠Xiin3

Yiip1≠Yiip2, Yiip2≠Yiip3, Yiin1≠Yiin2, Yiin2≠Yiin3,

Xip1≠Xip2, Xip2≠Xip3, Xin1≠Xin2, Xin2≠Xin3

Further,

Yip1≠Yin1, Yip2≠Yin2, Yip3≠Yin3

(Yip1+Yip2)≠(Yin1+Yin2),

(Yip1+Yip2+Yip3)≠(Yin1+Yin2+Yin3)

Xiip1≠Xiin1, Xiip2≠Xiin2, Xiip3≠Xiin3

(Xiip1+Xiip2)≠(Xiin1+Xiin2),

(Xiip1+Xiip2+Xiip3)≠(Xiin1+Xiin2+Xiin3),

The same goes with the drive mechanism unit 6c and the drive mechanism unit 6d.

Therefore, the relationships are made to constitute a graph as shown by FIG. 7.

There is a nonlinear relationship as shown by FIG. 7 between rotation of the table 4 and translational movements of the linear motors 1L, and therefore, when an actual mode of the table 4 differs from an assumption, accurate rotation of the table 4 cannot be carried out.

For example, even when the moving amount of the linear motor 1L is calculated by assuming the initial state Rf although the table 4 is in the mode of N1, the accurate rotation of the table 4 cannot be carried out.

Further, even when the table 4 is translationally moved, distances between the respective linear motors 1 and the center of rotation are changed, and therefore, the radius of rotation differs, and when operated by an operation instruction assuming the initial state, the accurate rotation of the table 4 cannot be carried out.

In order to resolve the above-descried problem, original point returning is carried out to be able to accurately rotate the table 4 by carrying out the following processings.

Further, the problem shown in FIG. 6 and FIG. 7 is a problem common to other embodiments.

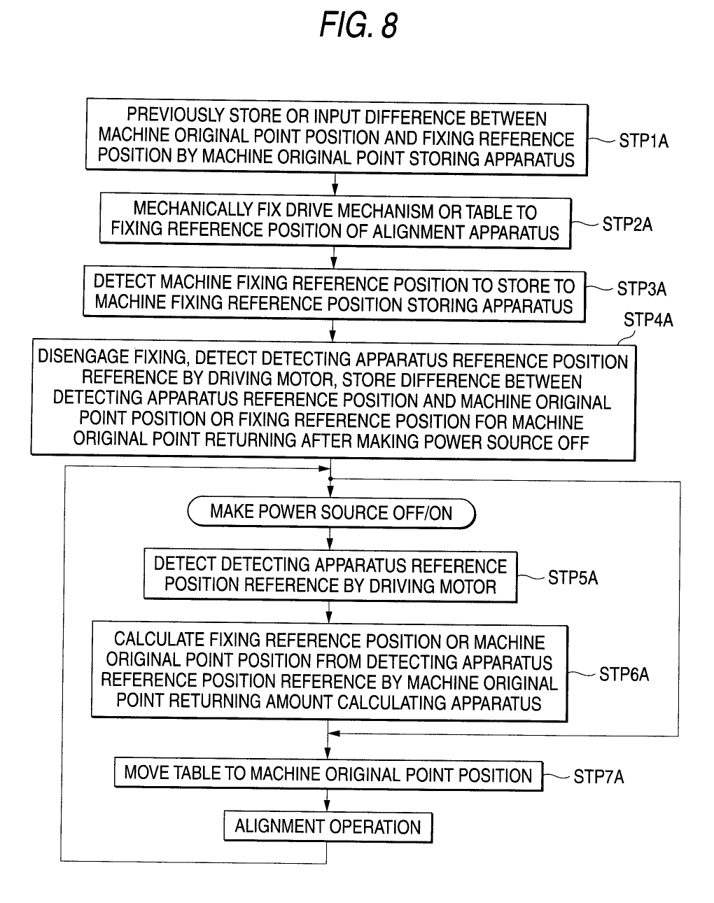

FIG. 8 is a flowchart showing a original point returning method of the alignment apparatus showing the first embodiment of the invention.

A method of the invention will successively be explained in reference to the drawing.

An outline of the flowchart of FIG. 8 is as follows.

First, at step STP1A, a difference between a machine original position and a fixing reference position is stored or inputted previously by the machine original point storing apparatus.

Next, at step STP2A, the drive mechanism or the table is mechanically fixed to the fixing reference position of the alignment apparatus.

At step STP3A, the machine fixing reference position is detected and is stored to the machine fixing reference position storing apparatus.

At step STP4A, in order to return to the original point after making a power source OFF, fixing is disengaged, a detecting apparatus reference position reference is detected by driving the motor, and a difference between the detecting apparatus reference position and the machine original point or the fixing reference position is stored.

Thereafter, a routine processing is constituted after temporarily cutting the power source and inputting the power source again.

At step STP5A, the detecting apparatus reference position reference is detected by driving the motor.

Next, at step STP6A, the fixing reference position or the machine original point position is calculated from the detecting apparatus reference position reference by the machine original point returning amount calculating apparatus.

At step STP7A, the table is moved to the machine original point position.

The original point returning is finished by the above-described and the operation of the alignment apparatus is made to be able to be carried out.

The above-described processing will be explained in details.

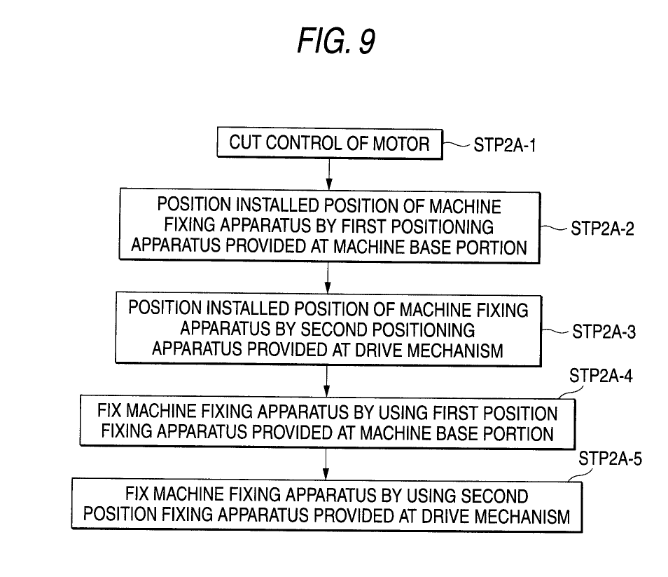

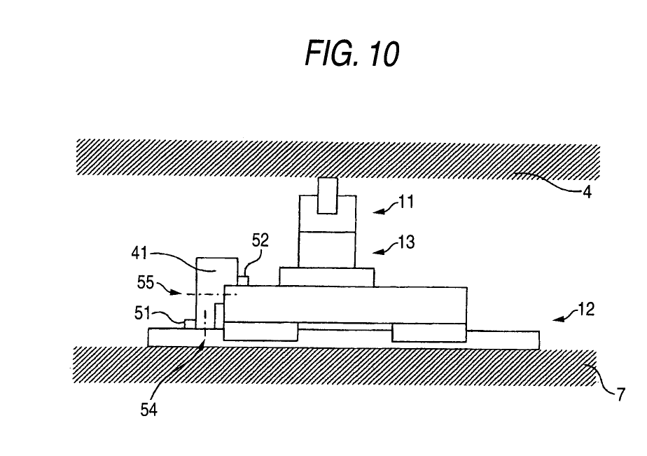

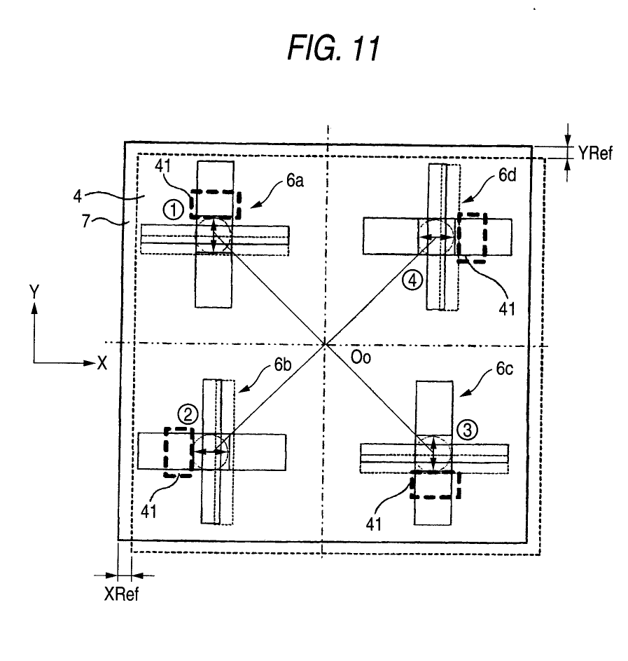

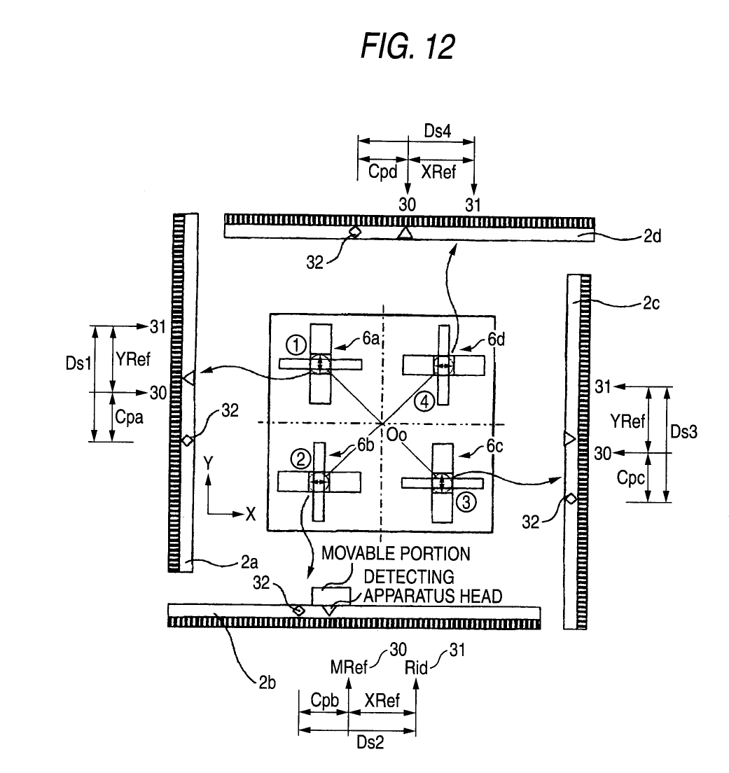

FIG. 9 is a flowchart showing a method of fixing the drive mechanism unit of the alignment apparatus showing the first embodiment of the invention, FIG. 10 is an outline view of the machine fixing apparatus of the alignment apparatus according to the first embodiment of the invention, FIG. 11 is a top view showing a situation of fixing the machine of the alignment apparatus showing the first embodiment of the invention and a view of arranging the drive mechanism unit, and FIG. 12 is an outline view for explaining an original point returning method of the alignment apparatus showing the first embodiment of the invention.

The machine fixing apparatus 41 and a constitution of a periphery thereof will be explained in reference to FIG. 9.

Numeral 41 designates the machine fixing apparatus, numeral 51 designates a first positioning apparatus, numeral 52 designates a second positioning apparatus, numeral 54 designates a first position fixing apparatus, and numeral 55 designates a second position fixing apparatus.

FIG. 12 enlarges to show the detecting apparatus 2 attached to the linear motor 1 mounted to the drive mechanism unit 6 for explaining respective steps.

At step STP1A, the difference (Xref, Yref) between the machine original point position and the fixing reference position which is already known in designing the machine of the alignment apparatus. That is, step STP1A is a step of inputting the difference between the machine original point position and the fixing reference position.

At step STP2A, the table or the drive mechanism unit is mechanically fixed to the fixing reference position of the alignment apparatus.

As shown by FIG. 10, the drive unit 6 is stopped and the table 4 is mechanically fixed to a certain attitude.

The step of fixing the drive mechanism unit 6 is as follows as shown by FIG. 9.

At step STP2A-1, a control of the motor is cut. Thereby, the table 4 and the drive mechanism unit 6 (drive mechanism 46) can be moved simply even manually.

At step STP2A-2, a position of installing the machine fixing apparatus is positioned by the first positioning apparatus provided at the machine base portion. The machine fixing apparatus 41 is positioned to the first positioning apparatus 51 on a side of the machine base portion 7.

At step STP2A-3, the position of installing the machine fixing apparatus is positioned by the second positioning apparatus provided at the drive mechanism. The machine fixing apparatus 41 is positioned to the second positioning apparatus 51 on a side of the drive mechanism unit 6 (drive mechanism 46).

At step STP2A-2 and STP2A-3, positioning is adjusted by moving the table 4 or the drive mechanism unit 6. The machine base portion 7 is provided with the first positioning apparatus 51, and therefore, when the machine fixing apparatus 41 is positioned thereto, the machine fixing apparatus 41 can accurately be positioned to the machine base portion 7. Further, the second positioning apparatus 52 is provided also on a side of the drive mechanism unit 6, and therefore, when the machine fixing apparatus 41 is positioned to the second positioning apparatus 52 by moving the table 4 or the drive mechanism unit 6, the machine fixing apparatus 41 can accurately be positioned to the drive mechanism unit 6. The positioning apparatus 51 or the second positioning apparatus 52 can be realized by using a positioning pin or the like.

At STP2A-4, the machine fixing apparatus is fixed by using the first position fixing apparatus provided at the machine base portion. The machine fixing apparatus is fixed by using the first positioning apparatus 54 provided at the machine base portion 7.

At STP2A-5, the machine fixing apparatus is fixed by using the second position fixing apparatus provided the drive mechanism. The machine fixing apparatus is fixed by using the second position fixing apparatus 55 provided at the drive mechanism unit 6 (drive mechanism 46).

The machine base portion 7 and the machine fixing apparatus 41 can be fixed by using the first position fixing apparatus 54 by STP2A-4 and STP2A-5. Tap holes are provided at the machine base portion 7 and the machine fixing apparatus 41, and the machine base portion 7 and the machine fixing apparatus 41 can be fixed by screwing. Further, the drive mechanism unit 6 and the machine fixing apparatus 41 can be fixed by using the second position fixing apparatus 55. The drive mechanism unit 6 and the machine fixing apparatus 41 are provided with tap holes, and the drive mechanism unit (drive mechanism 46) and the machine fixing apparatus 41 can be fixed by screwing. The alignment apparatus can be fixed to the fixing reference position constituting a reference as described above.

The alignment apparatus is fixed by using the machine fixing apparatus 41 as shown in FIG. 11. The alignment apparatus is fixed at a position remote from the machine original point (initial position) by XRef and YRef.

Here, as shown by FIG. 11, the machine fixing apparatus 41 fix 4 of the drive mechanism units 6 and the machine base portion 7.

4 of the drive mechanism units 6 are fixed, and therefore, the table 4 is fixed to the fixing reference position constituting the reference.

At STP3A, the machine fixing reference position is detected to be stored to the machine fixing reference position storing apparatus. As shown by FIG. 11, the drive units are fixed by being remote from the machine original point by Xref and Yref. The detecting apparatus 2 as shown by FIG. 12 constituted by a scale and a head, there is brought about a state in which the head is disposed at the fixing reference position 31. At this occasion, by reading a graduation of the scale, the fixing reference position 31 is detected by the detecting apparatus 2. A value of the fixing reference position 31 is stored to the machine fixing reference position storing apparatus. Further, according to the embodiment, 4 of the motor control apparatus are constituted, 4 of the machine fixing apparatus 41 are used, and therefore, 4 of the machine fixing reference positions are detected and stored to the machine fixing reference position storing apparatus.

At this stage, Xref and Yref are already known at step STP1A, and therefore, the machine original point position 30 is known, however, when the power source is cut and the machine is restarted, since the detecting apparatus 2 is of the increment value type, and therefore, so far as the drive unit 6 is not fixed by the machine fixing apparatus 41, the fixing reference position 31 cannot be recognized. Hence, the following step is carried out.

At step STP4A, in order to return to the original point after making the power source OFF, the fixing is disengaged, the detecting apparatus reference position reference is detected by driving the motor, and the difference between the detecting apparatus reference position and the machine original point position or the fixing reference position is stored.

The detecting apparatus reference position reference is detected by disengaging the machine fixing apparatus 41 and driving the linear motor 1L. Further, also at the step, 4 of the linear motors 1L are driven, 4 of the detecting apparatus reference position references are detected and the differences between 4 of the detecting apparatus reference positions and the machine original point position or the fixing reference position is stored. That is, Cpa, Cpb, Cpc, Cpd or Ds1, Ds2, Ds3, Ds4 of FIG. 12 are stored.

An operation of detecting the detecting apparatus reference position reference is original point returning which is generally carried out when the detecting apparatus 2 of the increment value type is used. Generally, the detecting apparatus reference position reference is not set to the detecting apparatus 2 by strict accuracy, also in the alignment apparatus of the embodiment, the detecting apparatus reference position reference is not attached by controlling the position, and therefore, the detecting apparatus reference position reference cannot be made to constitute an original point position. Therefore, there poses a problem that even when general original point returning is carried out, the machine original point position indispensable for the embodiment is not constituted.

However, the alignment apparatus is fixed, the machine fixing reference position is detected, the machine original point position is grasped and stored, and therefore, although distances between the machine original point position 32 and the detecting apparatus reference position references or the fixing reference positions (Cpa, Cpb, Cpc, Cpd or Ds1, Ds2, Ds3, Ds4) are respectively dispersed, the distances are grasped and stored, and therefore, when the step is carried out, the original point returning can simply be carried out routinely.

At and after step STP5A, the original point returning carried out routinely is constituted.

At step STP5A, the detecting apparatus reference position reference is detected by driving the motor. The detecting apparatus reference position reference which is carried out at step STP4A is detected. As described above already, this is the original point returning which is carried out generally when the detecting apparatus 2 of the increment value type is used. 4 of the linear motors 1L are driven and 4 of the detecting apparatus reference position references are detected.

At step STP6A, the fixing reference position or the machine original point position is calculated from the detecting apparatus reference position reference by the machine original point returning amount calculating apparatus. That is, at step STP4A, the distances between the machine original point position 32 and the detecting apparatus reference position references or the fixing reference positions (Cpa, Cpb, Cpc, Cpd or Ds1, Ds2, Ds3, Ds4) are stored, and therefore, when the newly detected detecting apparatus reference position references and, for example, Ds1, Ds2, Ds3, Ds4 of FIG. 12 are used, the fixing reference positions can be calculated. The distances XRef and Yref between the fixing reference position and the machine original point are already known, and therefore, the machine original point position can further be calculated. That is, the distances Cpa, Cpb, Cpc and Cpd of the machine original point positions are known from the detecting apparatus reference position references newly detected at STP5A.

At step STP7A, the table is moved to the machine original point position. The distances Cpa, Cpb, Cpc, Cpd of the machine original point positions are known by step STP6A from the detecting apparatus reference position references newly detected at step STP5A, and therefore, when the table is moved by the distances, the table can be disposed at the machine original point.

When the detecting apparatus reference position references are newly detected at step STP5A, the table can be disposed at the machine original point. Thereby, even when the power source is cut again, when started from STP5A, the original point returning can simply be carried out. The original point returning can very simply be carried out routinely.

By fixing the table or the drive mechanism mechanically accurately and storing the distances between the fixing references by which the machine original point is known and the detecting apparatus reference position references as described above, the original point returning can simply be carried out routinely.

Therefore, instruction of XYθ operation starting from θ operation can accurately be carried out by constituting the reference by the machine original point, and XYθ operation of the table can accurately be realized by driving the motor.

### Embodiment 2

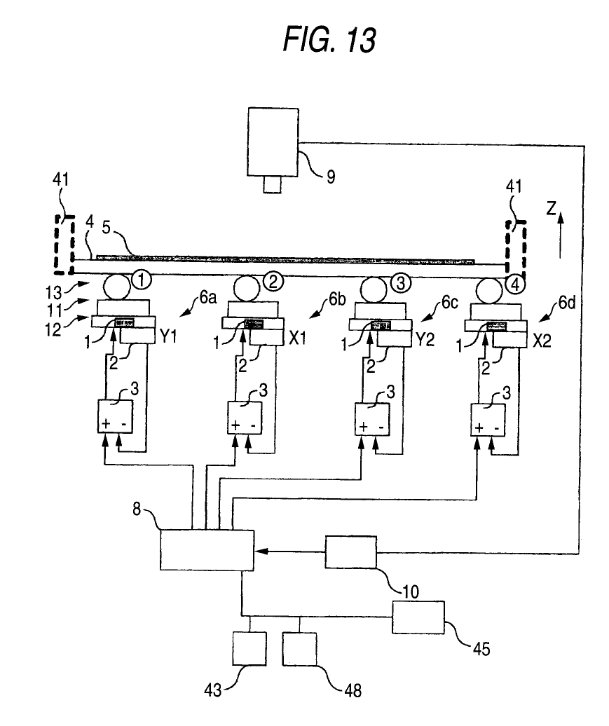

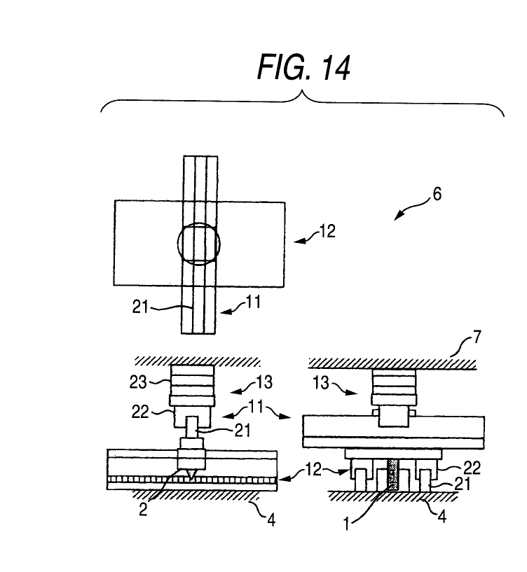

FIG. 13 is a schematic diagram and a control block diagram of an alignment apparatus showing a second embodiment of the invention, FIG. 14 is an outline view of a drive mechanism unit of the alignment apparatus showing the second embodiment of the invention.

A difference of the embodiment from the first embodiment resides in that the two-dimensional position detecting apparatus 9 and the two-dimensional image processing apparatus 10 are provided to be able to detect a mark of the table 4 or the object 5.

Further, the difference resides in that the machine fixing apparatus 41 is utilized to fix the machine base portion 7 and the table 4.

Further, the machine fixing reference position storing apparatus 42 and the detecting apparatus reference position storing apparatus 44 are not utilized but the reference image position storing apparatus 48 is provided instead thereof. Further, the drive mechanism unit 6 is constructed by a constitution including the translational freedom degree 11 above the translational drive portion 12 and the rotational freedom degree 13 is provided above the translational freedom degree 11 as shown by FIG. 13.

As shown by FIG. 13, the translational drive portion 12 and the translational freedom degree 11 are constructed by a constitution of being always orthogonal to each other. The constitution of the drive mechanism unit 6 differs from that of the first embodiment (FIG. 3) as shown by FIG. 13, and therefore, a relationship between rotation of the table 4 and the linear motor 1 is changed.

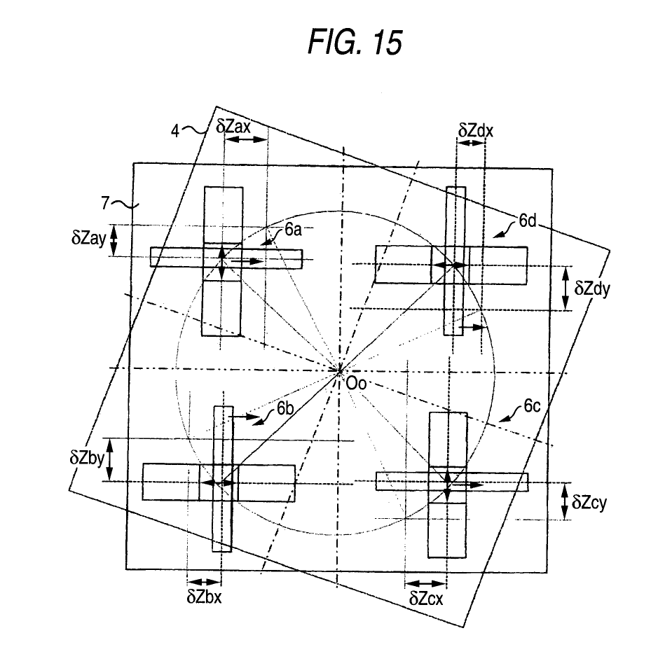

FIG. 15 is a view showing a rotational movement of the table of the alignment apparatus showing the second embodiment of the invention. Although the translational movement of the table 4 is the same as that of the first embodiment, the rotational movement differs from that of the first embodiment (FIG. 5) as shown by FIG. 15. However, it is not changed that the rotational movement of the table and the movement of the linear motor 1 can geometrically be determined. Further, there poses the problem shown in FIG. 6 and FIG. 7 of the first embodiment invariably also in the embodiment.

Further, although a function of the alignment apparatus remains unchanged, constituent elements are changed from those of the first embodiment, and therefore, a procedure of constituting the machine original point by the table 4 by utilizing the two-dimensional position detecting apparatus 9 and the two-dimensional image processing apparatus 10 differs.

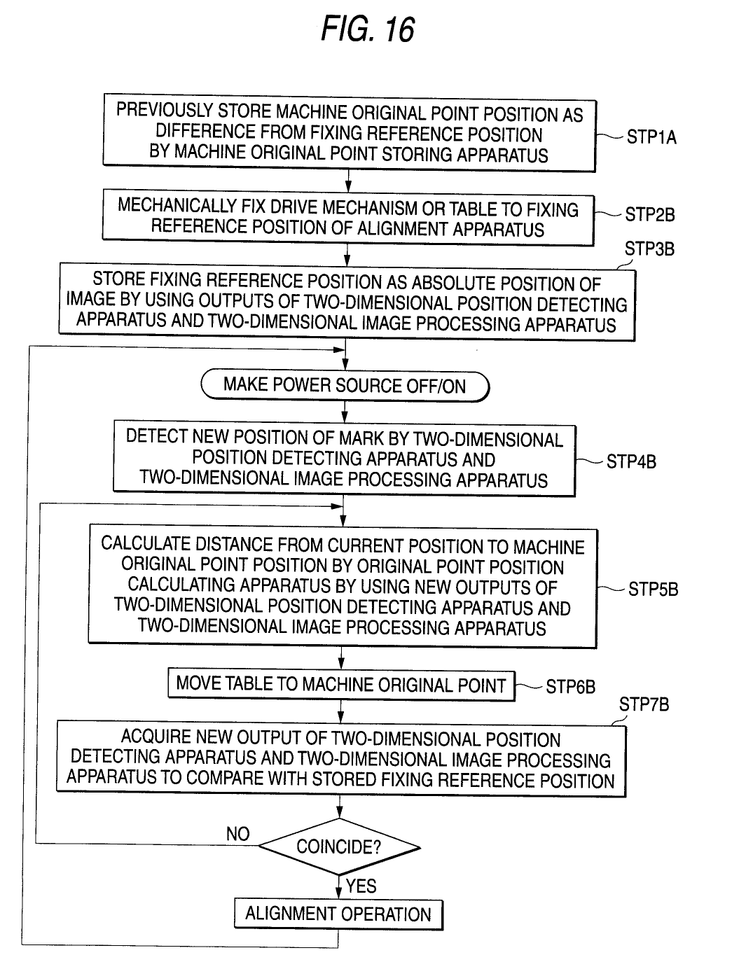

FIG. 16 is a flowchart showing an original point returning method of the alignment apparatus showing the second embodiment of the invention. There is a provided a procedure from step STP1A to step STP7B.

At step STP1A, similar to the first embodiment, the difference between the machine original point position and the fixing reference position is stored or inputted previously by the machine original point storing apparatus.

At step STP2B, similar to the first embodiment, the drive mechanism or the table is mechanically fixed to the fixing reference position of the alignment apparatus.

At step STP3B, a position of the mark is detected by the two-dimensional position detecting apparatus and the two-dimensional image processing apparatus and the fixing reference position is stored as an absolute position of the image by using an output thereof.

Thereafter, there is carried out the routine processing after the power source is temporarily cut and the power source is inputted again.

At step STP4B, the position of the mark is detected newly by the two-dimensional position detecting apparatus and the two-dimensional image processing apparatus.

At step STP5B, a distance from a current position to the machine original point position is calculated by the original point position calculating apparatus by using an output of the image.

At step STP6B, the table is moved to the machine original point.

At step STP7B, the position of the mark is newly detected by the two-dimensional position detecting apparatus and the two-dimensional image processing apparatus. When a result thereof coincides with a stored fixing reference position, the original point returning is finished. When the result does not reach the fixing reference position, the operation returns to step STP5B and the processing is repeated.

The original point returning is finished as described above and the operation of the alignment apparatus is made to be able to be carried out.

The above-described processing will be explained further in details.

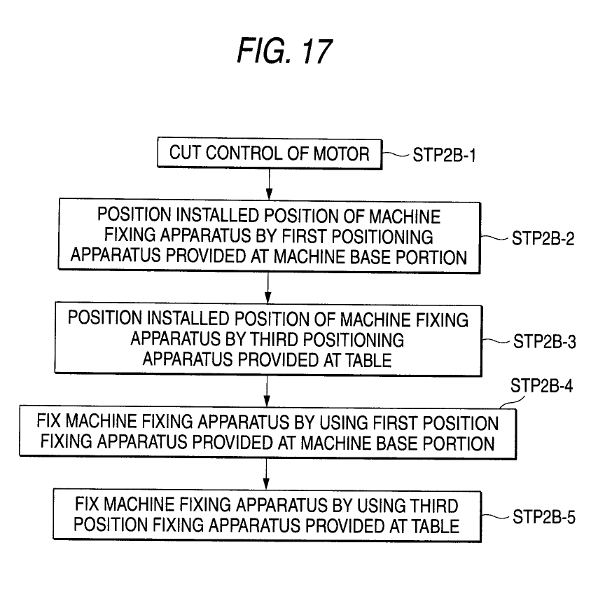

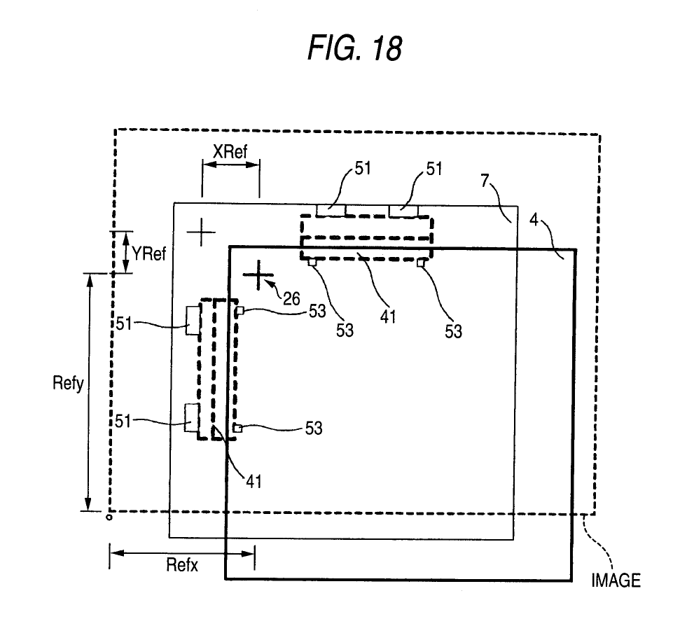

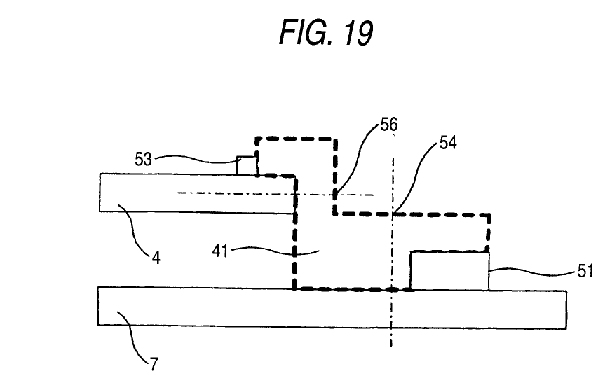

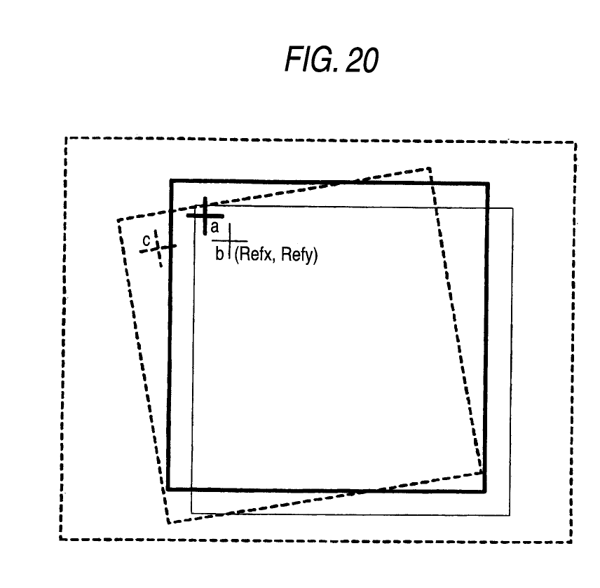

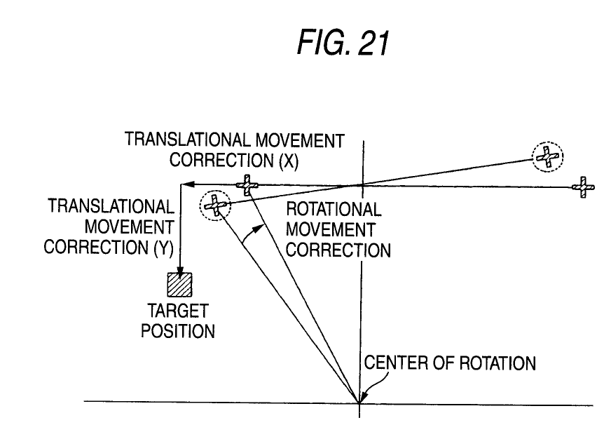

FIG. 17 is a flowchart showing a method of fixing the table of the alignment apparatus showing the second embodiment of the invention, FIG. 18 is a top view showing a situation of fixing the machine of the alignment apparatus showing the second embodiment of the invention, FIG. 19 is an outline view showing the machine fixing apparatus of the alignment apparatus showing the second embodiment of the invention, FIG. 20 is a view showing an original point position calculating method by the two-dimensional position detecting apparatus and the two-dimensional image processing apparatus of the alignment apparatus showing the second embodiment of the invention, and FIG. 21 is a view showing a position correcting method of the object by the two-dimensional position detecting apparatus and the two-dimensional image processing apparatus of the alignment apparatus showing the second embodiment of the invention.

At step STP2B, similar to the first embodiment, the table or the drive mechanism unit is mechanically fixed at the fixing reference position of the alignment apparatus. The step of fixing the table 4 is as follows as shown by FIG. 17. As shown by FIG. 18 and FIG. 19, a fixing situation differs from that of the first embodiment and the table 4 is directly fixed.

A flowchart showing a method of fixing the table of the alignment apparatus is as follows.

At STP2B-1, a control of the motor is cut. Similar to the first embodiment, thereby, the table 4 or the drive mechanism unit 6 (drive mechanism 46) can simply be moved even manually.

At STP2B-2, a position of installing the machine fixing apparatus is positioned by the first positioning apparatus provided at the machine base portion. The machine fixing apparatus 41 is positioned to the first positioning apparatus 51 on the side of the machine base portion 7.

At STP2B-3, the position of installing the machine fixing apparatus is positioned by the second positioning apparatus provided to the table. The machine fixing apparatus is positioned to the second positioning apparatus 51 on the side of the table.

At STP2B-2 and STP2B-3, the positioning is adjusted by moving the table 4 or the drive mechanism unit 6. The machine base portion 7 is provided with the first positioning apparatus 51, and therefore, when the machine fixing apparatus 41 is positioned thereto, the machine fixing apparatus 41 can accurately be positioned to the machine base portion 7. Further, also a side of the table 4 is provided with the second positioning apparatus 52, and therefore, when the machine fixing apparatus 41 is positioned to the second positioning apparatus 52 by moving the table 4 or the drive mechanism unit 6, the machine fixing apparatus 41 can accurately be positioned to the table 4. The positioning apparatus 51 or the second positioning apparatus 52 can be realized by using a positioning pin or the like.

At STP2B-4, the machine fixing apparatus is fixed by using the first position fixing apparatus provided at the machine base portion. The machine fixing apparatus is fixed by using the first position fixing apparatus 54 provided at the machine base portion 7.

At STP2B-5, the machine fixing apparatus is fixed by using the second position fixing apparatus provided at the table. The machine fixing apparatus is fixed by using the second position fixing apparatus 55 provided at the table.

By STP2B-4 and STP2B-5, the machine base portion 7 and the machine fixing apparatus 41 can be fixed by using the first position fixing apparatus 54. The machine base portion 7 and the machine fixing apparatus 41 can be fixed by providing tap holes at the machine base portion 7 and the machine fixing apparatus 41 and screwing. Further, the table and the machine fixing apparatus 41 can be fixed by using the second position fixing apparatus 55. The table and the machine fixing apparatus 41 can be fixed by providing tap holes at the drive table and the machine fixing apparatus 41 and screwing. The alignment apparatus can be fixed to the fixing reference position constituting the reference as described above.

The alignment apparatus is fixed by using the machine fixing apparatus as shown by FIG. 18. The alignment apparatus is fixed at a position remote from the machine original point (initial position) by XRef and YRef. Here, the machine fixing apparatus 41 fixes the table 4 and the machine base portion 7 at two positions. In this way, the table 4 is fixed to the fixing reference position constituting the reference.

At step STP3B, the fixing reference position is stored as the absolute position of the image by using outputs of the two-dimensional position detecting apparatus and the two-dimensional image processing apparatus. As shown by FIG. 18, the table is fixed to be remote from the machine original position by Xref and Yref.

When a frame surrounded by a dotted line of FIG. 18 is made to constitute an image of the two-dimensional processing apparatus, the absolute position (Refx, Refy) on the image on the table is known. The absolute position is stored to the fixing reference position storing apparatus as the fixing reference position by the absolute value.

At and after step STP4B, the routine original point returning is carried out. There is carried out a processing when the power source is temporarily cut and the power source is inputted again. Also the machine fixing apparatus 41 is disengaged.

At step STP4B, the two-dimensional position detecting apparatus detects the mark on the table again. Since also the machine fixing apparatus 41 is disengaged, the two-dimensional position detecting apparatus detects the mark on the table again to find at which position the table 4 is disposed. As shown by FIG. 20, when a mode of inclining the table is constituted as shown by a broken line, it is known at which position a newly detected mark c is disposed relative to the fixing reference position b (Refx, Refy) stored at step STP3B, or the machine original point position a (Refx+Xref, Refy+Yref).

At step STP5B, the detected image is processed. As shown by FIG. 21, the two-dimensional image processing apparatus 10 is for calculating translational movement correcting amounts X, Y and a rotational movement correcting amount θ relative to a target position, and therefore, moving amounts of XYθ for constituting the fixing reference position or the machine original point position can be calculated.

Further, the instructing apparatus can calculate moving amounts at the respective motors 1 (linear motors 1L) necessary for the moving amounts of XYθ of the table 4 in order to realize the alignment operation. That is, this is an operation carried out by the alignment apparatus ordinarily, the fixing reference position or the machine original point position constituting the target position is a correct value, and therefore, the accurate moving amounts of the linear motors 1L can be calculated.

At step STP6B, the table 4 is moved by being actually operated by the moving amount to the fixing reference position or the machine original point position from the current value.

At step STP7B, the new outputs of the two-dimensional position detecting apparatus and the two-dimensional image processing apparatus are auired to be compared with the stored fixing reference position. When the both do not coincide with each other, the operation returns to step STP5B to calculate the moving amount again and the processing is carried out repeatedly until the mark on the table newly coincides with the stored fixing reference position.

When the table or the drive mechanism is fixed mechanically accurately and the mark provided by the two-dimensional position detecting apparatus and the two-dimensional image processing apparatus is stored as the fixing reference position as described above, the original point returning can simply be carried out routinely. The two-dimensional position detecting apparatus can confirm the result even after the original point returning and the operation of the original point returning can repeatedly be carried out.

Therefore, the instruction of the XYθ operation starting from θ operation can accurately be carried out by constituting the reference by the machine original point, and the XYθ operation of the table can accurately be realized by driving the motor.

The processing is a general way per se of using the alignment apparatus of aligning the mark of the table 4 at the stored fixing reference position. Since the above-described processing is carried out, the processing can be utilized for the original point returning. After the original point returning, the table is subjected to the XYθ operation to coincide with a certain position stored with the mark of the object 5 placed above the table 4.

### Embodiment 3

According to the embodiment, a constitution example or an arrangement example of the drive mechanism unit will be described.

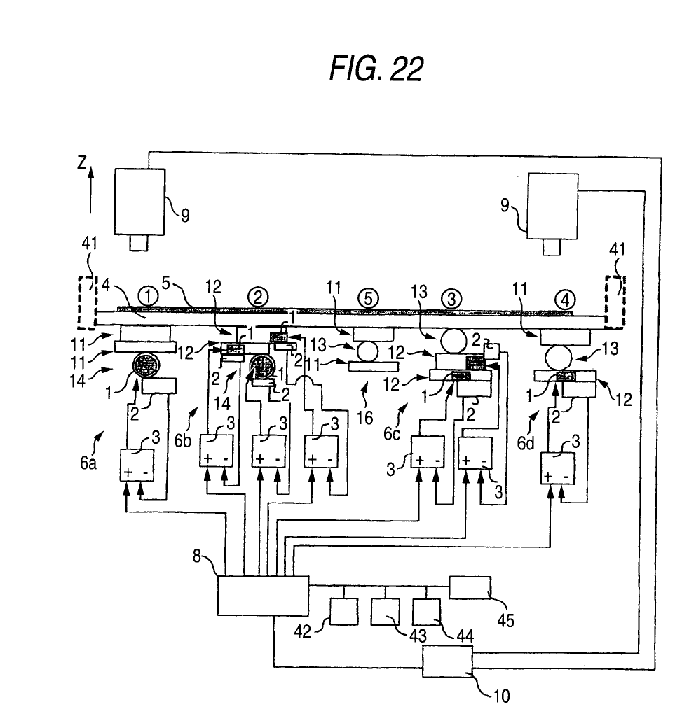

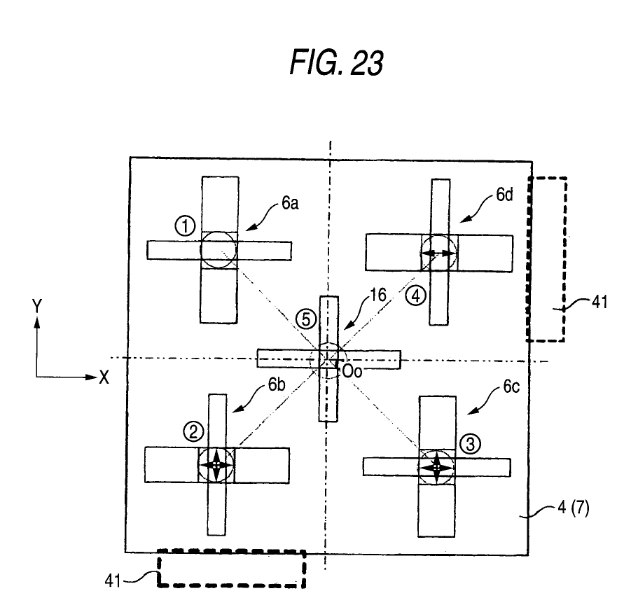

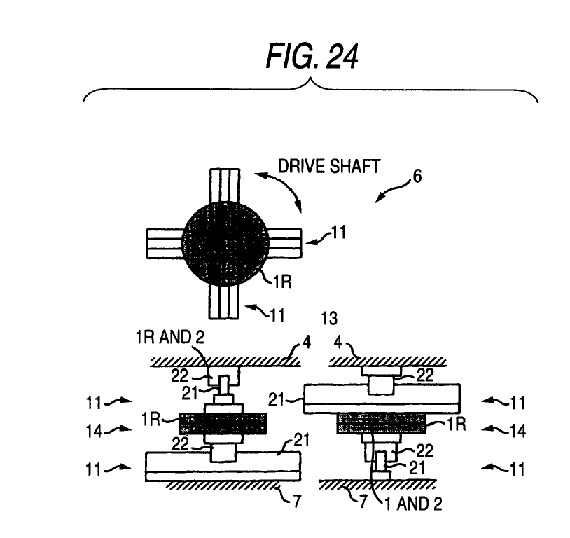

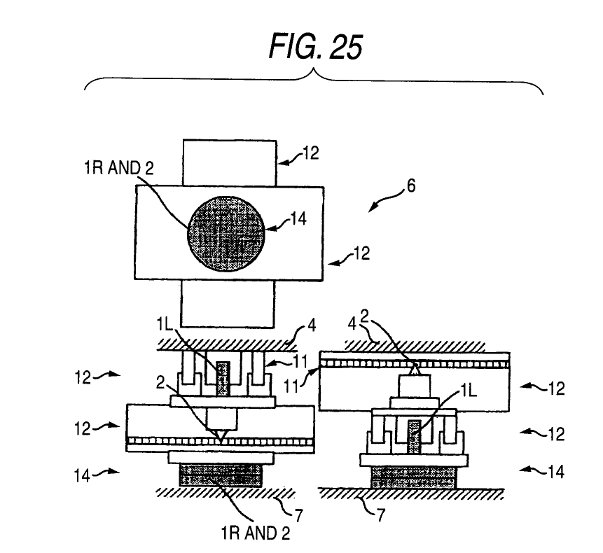

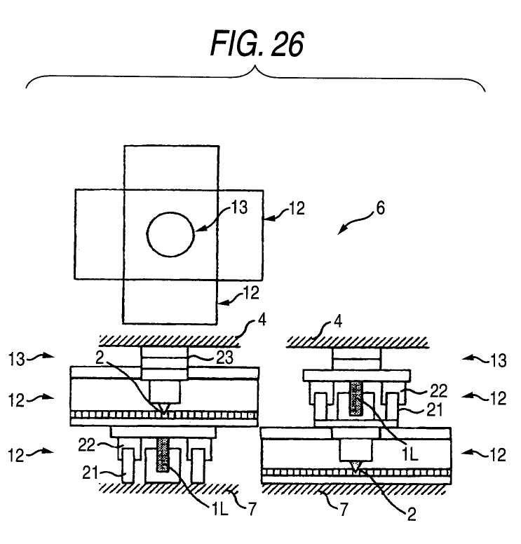

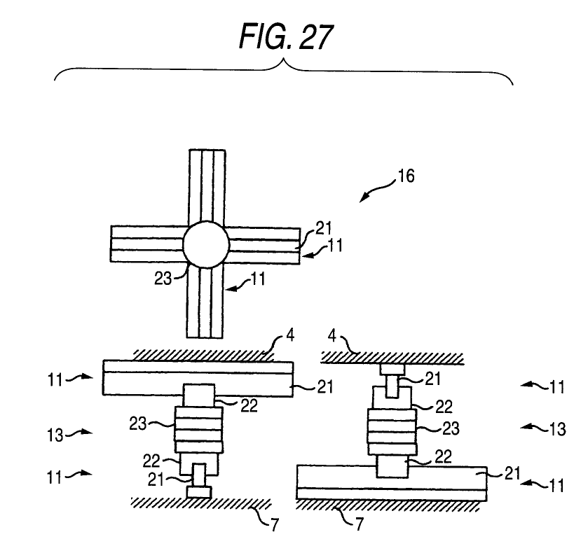

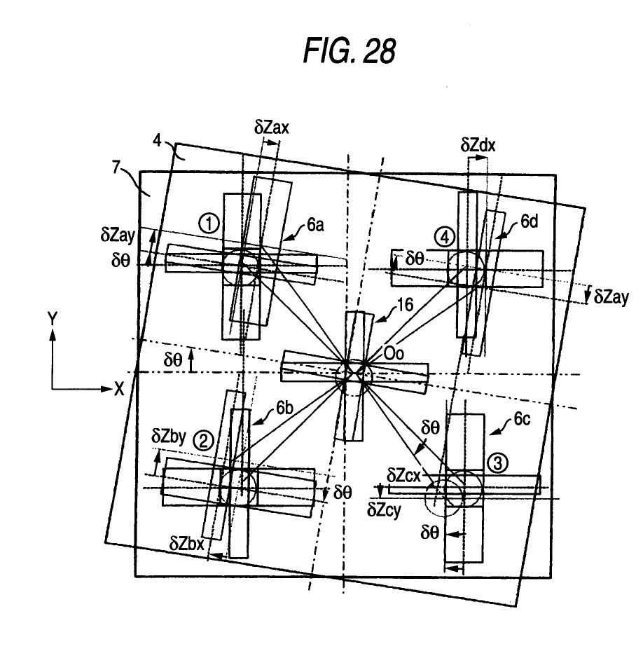

FIG. 22 is a schematic diagram and a control block diagram of an alignment apparatus showing a third embodiment of the invention, FIG. 23 is a top view of the alignment apparatus showing the third embodiment of the invention and an arrangement view of the drive mechanism unit, FIG. 24 is an outline view of the drive mechanism unit (6a) of the alignment apparatus showing the third embodiment of the invention, FIG. 25 is an outline view of the drive mechanism unit (6b) of the alignment apparatus showing the third embodiment, FIG. 26 is an outline view of the drive mechanism unit (6c) of the alignment apparatus showing the third embodiment of the invention, FIG. 27 is an outline view of a 3 freedom degree mechanism of the alignment apparatus showing the third embodiment of the invention, and FIG. 28 is a view showing a rotational movement of the table of the alignment apparatus showing the third embodiment of the invention.

The embodiment differs from the first embodiment in that the drive mechanism unit 6 and a 3 freedom degree mechanism 16 having different constitutions are mixed. Further, twos of the two-dimensional position detecting apparatus 9 and the two-dimensional image processing apparatus 10 are provided. Further, the embodiment differs from the second embodiment in that a plurality of the two-dimensional position detecting apparatus 9 are provided and in that the drive mechanism unit 6 and the 3 freedom degree mechanism 6 having different constitutions are mixed.

The alignment apparatus of the embodiment is constituted from the drive mechanism unit 6 and the 3 freedom degree mechanism 16 shown in FIG. 24, FIG. 25, FIG. 26, FIG. 27, and the drive mechanism unit 6 shown in FIG. 3 of the embodiment to be arranged therewith.

As shown by FIG. 24, the drive mechanism unit 6a includes a rotating type motor 1R and is constituted in an order of the translational freedom degree portion 11, a rotational drive portion 14, and the translational freedom degree 11 from the machine base portion 7.

As shown by FIG. 25, the drive mechanism unit 6b includes 2 of the linear motors 1L and the rotating type motor 1R and constituted in an order of the rotational drive portion 14, the translational drive portions 12, the translational drive portion 12 from the machine base portion 7, and the two-translational drive portions 12 are orthogonal to each other.

As shown by FIG. 26, the drive mechanism unit 6c includes 2 of the linear motors 1L, and constituted in an order of the translational drive portion 12, the translational drive portion 12, the rotational drive portion 14 from the machine base portion 7 and the two-translational drive portions 12 are orthogonal to each other.

The drive mechanism unit 6d is constructed by the constitution shown in FIG. 3 of the first embodiment.

Further, as shown by FIG. 27, the 3 freedom degree mechanism 18 is constituted in an order of the translational freedom degree portion 11, the rotational freedom degree portion 13, the translational freedom degree portion 11 from the machine base portion 7.

There are respective threes of the linear motors 1L driven in X direction and Y direction, there are two rotational type motors 1L, and therefore, the table 4 can be operated in XYθ.

Further, the operation in XY directions can be carried out similar to the first embodiment.

When the table is rotated, the constitutions of the drive mechanism units 6 differ, and therefore, the amount of operating the motor 1 differs from those of the first embodiment and the second embodiment.

In order to rotate the table 4 by δθ, as shown by FIG. 28, the drive mechanism unit 6a operates the rotational type motor 1L by δθ. The drive mechanism unit 6b operates the two linear motors 1L by δZbx and δZby, and operates the rotating type motor 1L by δθ. The drive mechanism unit 6c operates the two linear motors 1L by δZcx and δZcy. The drive mechanism unit 6d operates the one linear motor 1L by δZdx. By operation of these, also the freedom degree without the motor 1 is moved, also the 3 freedom degree mechanism is moved by δθ, and therefore, the table can be rotated by δθ.

Amounts of moving the motor 1 (linear motor 1L, rotational type motor 1R) of the respective drive units 6 necessary for rotating the table 4 can geometrically be determined although the amounts differ by the respective constitutions.

As described above, although the operation of the alignment apparatus differs in the amounts of moving the motors of the individual drive units 6, the operation is the same as those of the first embodiment and the second embodiment.

The problem shown by FIG. 6 and FIG. 7 of the first embodiment is posed invariably also in the embodiment.

The original point returning of the alignment apparatus of the embodiment may be carried out similar to the first embodiment. Further, although the reference image position storing apparatus 48 is not clearly shown, an operation thereof may be carried out similar to that of the second embodiment.

Although different from the second embodiment, 2 of the two-dimensional position detecting apparatus 9 are provided, the processing may be carried out by detecting marks at 2 portions of the table 4 and can be carried out similar to the second embodiment.

When the original point returning is finished, the two marks of the object 5 placed above the table 4 are detected by 2 of the two-dimensional position detecting apparatus 9, the table is operated in XYθ to coincide with stored positions of certain two points.

Further, although according to the embodiment, the drive mechanism unit 6 and the 3 freedom degree mechanism 16 shown in FIG. 24, FIG. 25, FIG. 26 and FIG. 27 and the drive mechanism unit 6 shown in FIG. 3 of the first embodiment are arranged, the drive mechanism unit 6 and the 3 freedom degree mechanism 16 having other constitution may be used. The following is pointed out as other constitutions of the drive mechanism unit 6 and the 3 freedom degree mechanism 16.

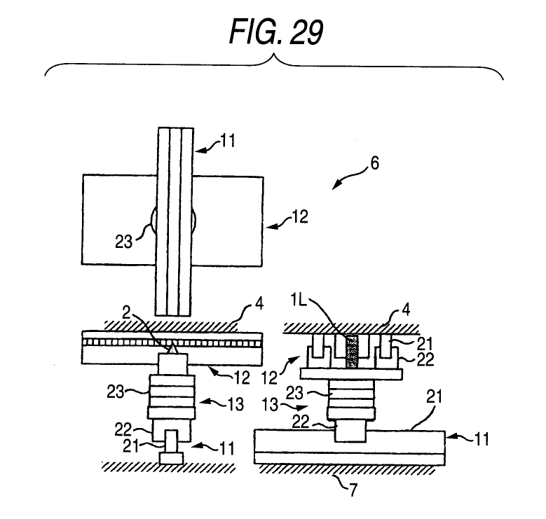

FIG. 29 is an outline view of Example 1 of other drive mechanism unit of the alignment apparatus showing the third embodiment of the invention,

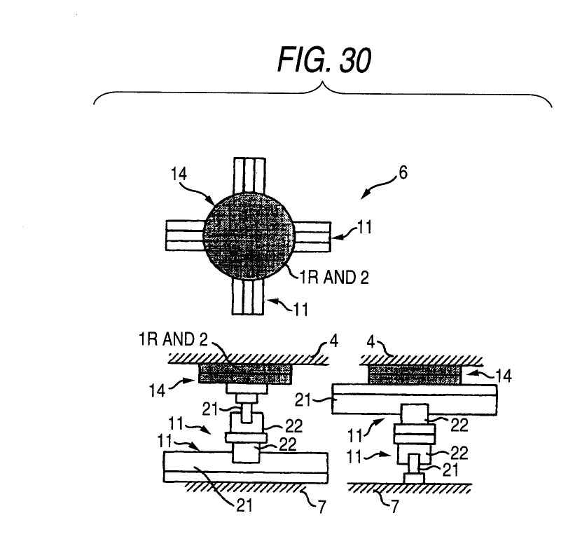

FIG. 30 is an outline view of Example 2 of other drive mechanism unit of the alignment apparatus showing the third embodiment of the invention,

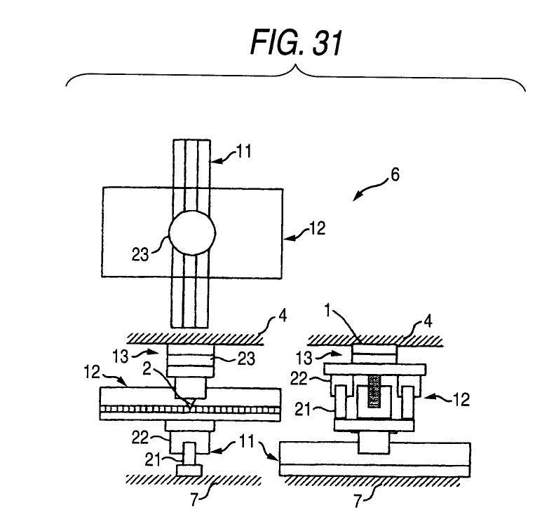

FIG. 31 is an outline view of Example 3 of the drive mechanism unit of the alignment apparatus showing the third embodiment of the invention,

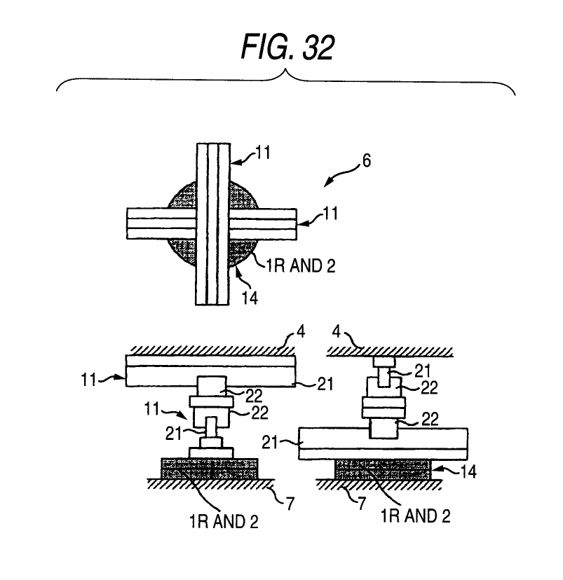

FIG. 32 is an outline view of Example 4 of the drive mechanism unit of the alignment apparatus showing the third embodiment of the invention,

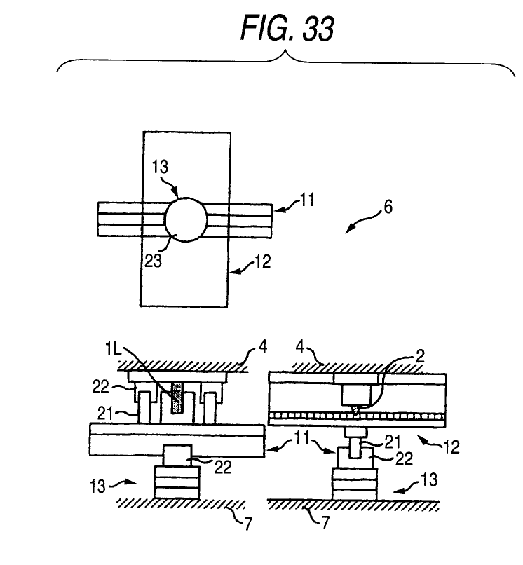

FIG. 33 is an outline view of Example 5 of the drive mechanism unit of the alignment apparatus showing the third embodiment of the invention,

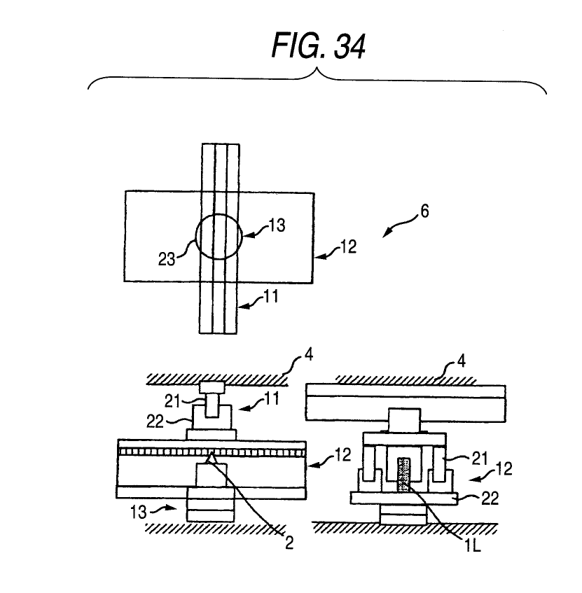

FIG. 34 is an outline view of Example 6 of other drive mechanism unit of the alignment apparatus showing the third embodiment of the invention,

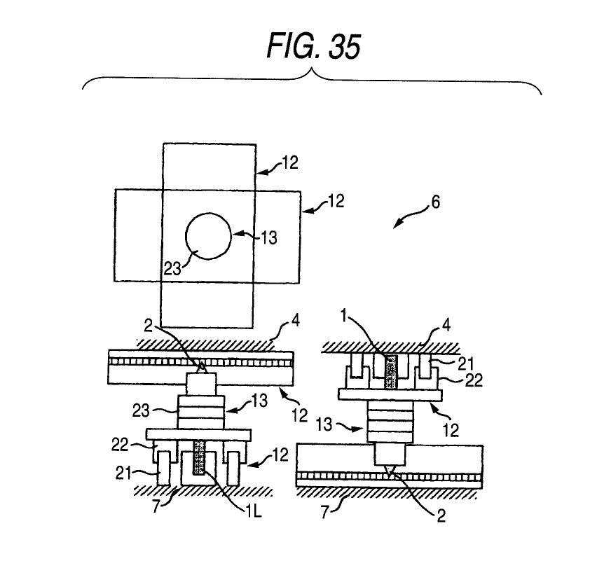

FIG. 35 is an outline view of Example 7 of other drive mechanism unit of the alignment apparatus showing the third embodiment of the invention,

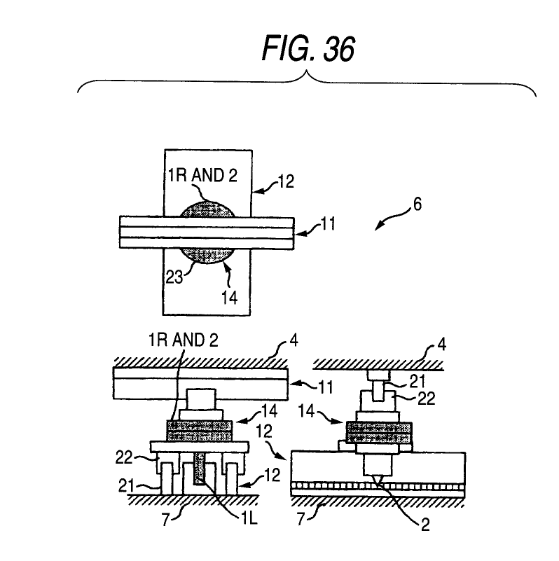

FIG. 36 is an outline view of Example 8 of other drive mechanism unit of the alignment apparatus showing the third embodiment of the invention,

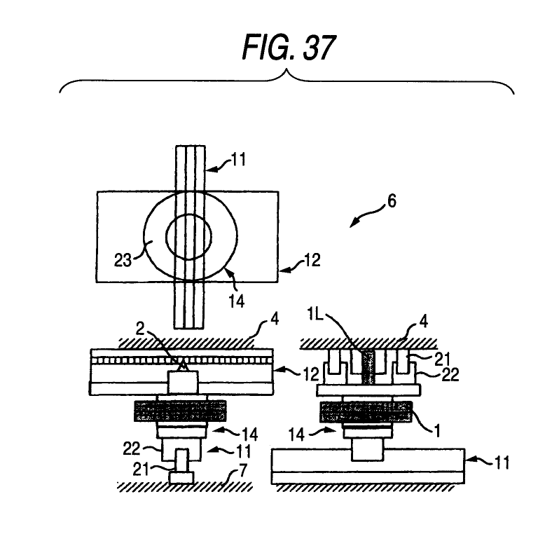

FIG. 37 is an outline view of Example 9 of other drive mechanism unit of the alignment apparatus showing the third embodiment of the invention,

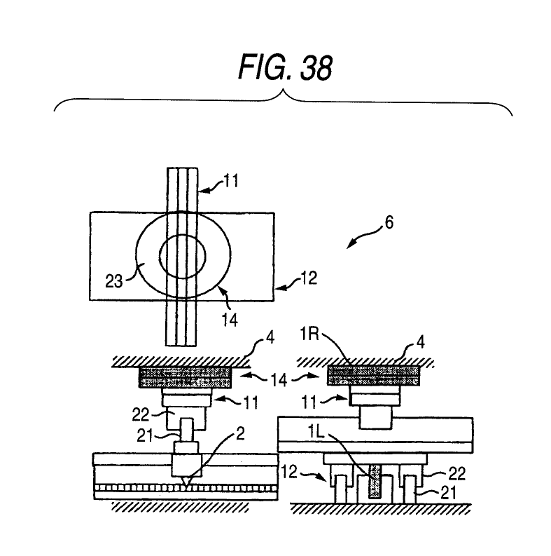

FIG. 38 is an outline view of Example 10 of other drive mechanism unit of the alignment apparatus showing the third embodiment of the invention,

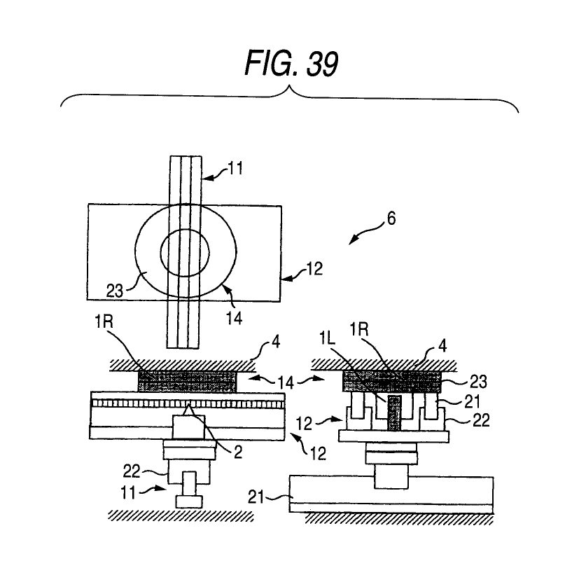

FIG. 39 is an outline view of Example 11 of other drive mechanism unit of the alignment apparatus showing the third embodiment of the invention,

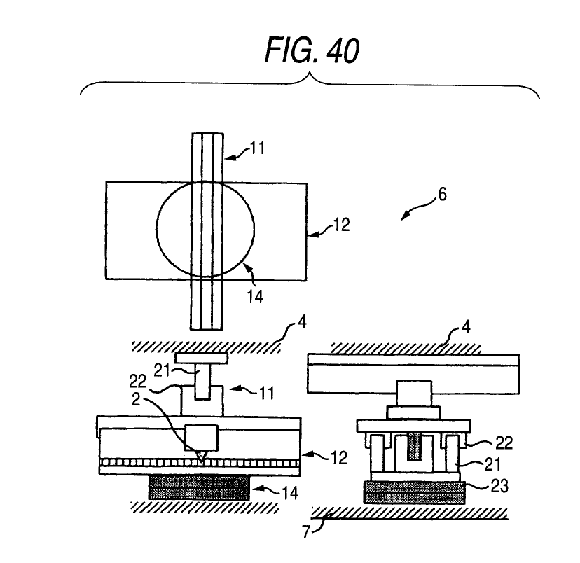

FIG. 40 is an outline view of Example 12 of other drive mechanism unit of the alignment apparatus showing the third embodiment of the invention,

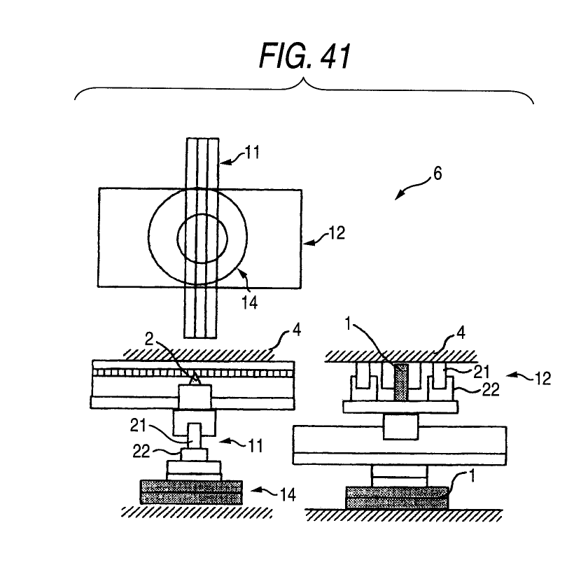

FIG. 41 is an outline view of Example 13 of other drive mechanism unit of the alignment apparatus showing the third embodiment of the invention,

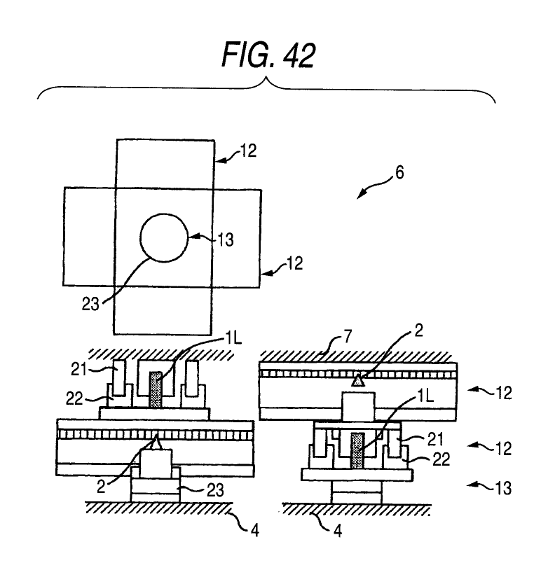

FIG. 42 is an outline view of Example 14 of other drive mechanism unit of the alignment apparatus showing the third embodiment of the invention,

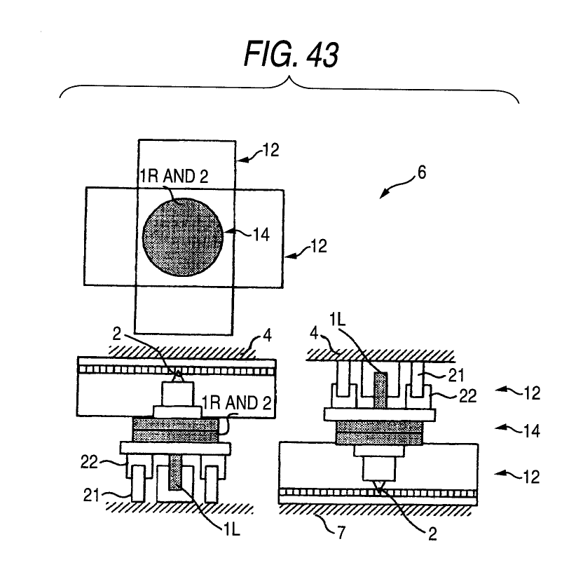

FIG. 43 is an outline view of Example 15 of other drive mechanism unit of the alignment apparatus showing the third embodiment of the invention,

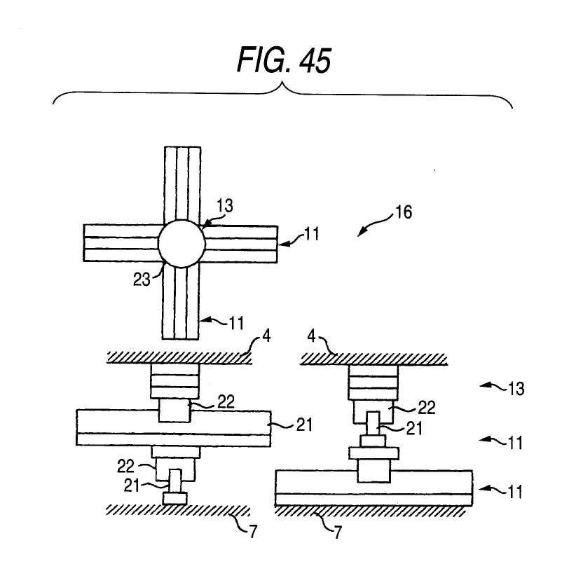

FIG. 45 is an outline view of other Example 1 of other 3 freedom degree mechanism of the alignment apparatus showing the third embodiment of the invention, and

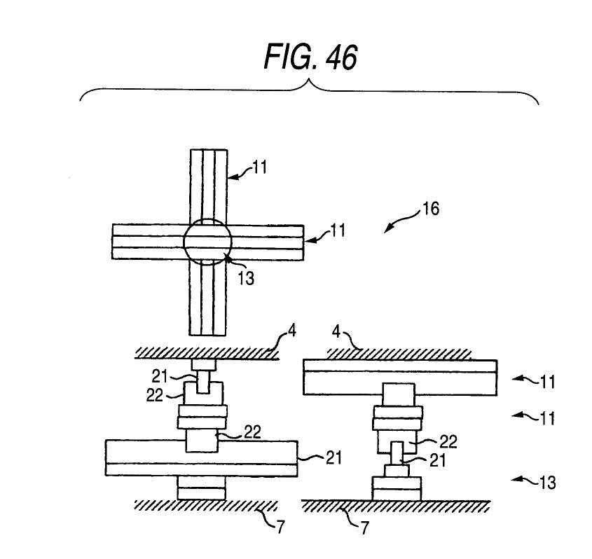

FIG. 46 is an outline view of Example 2 of other 3 freedom degree mechanism of the alignment apparatus showing the third embodiment of the invention.

Further, although an arrangement of the drive mechanism unit 6 or the 3 freedom degree mechanism 16 is shown as in FIG. 2 of Embodiment and FIG. 23 of the embodiment, other arrangement will do. Although the following arrangement examples are pointed out, the arrangement examples are not limited thereto.

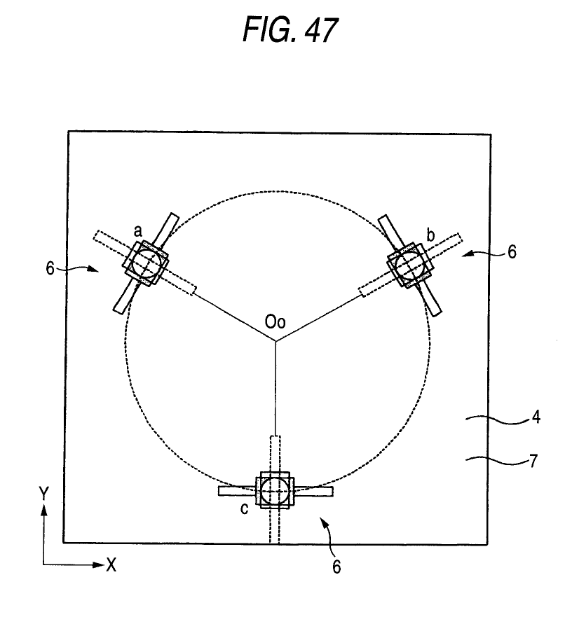

FIG. 47 is a top view of the alignment apparatus showing the third embodiment of the invention and a diagram of arranging the drive mechanism unit or the 3 freedom degree mechanism,

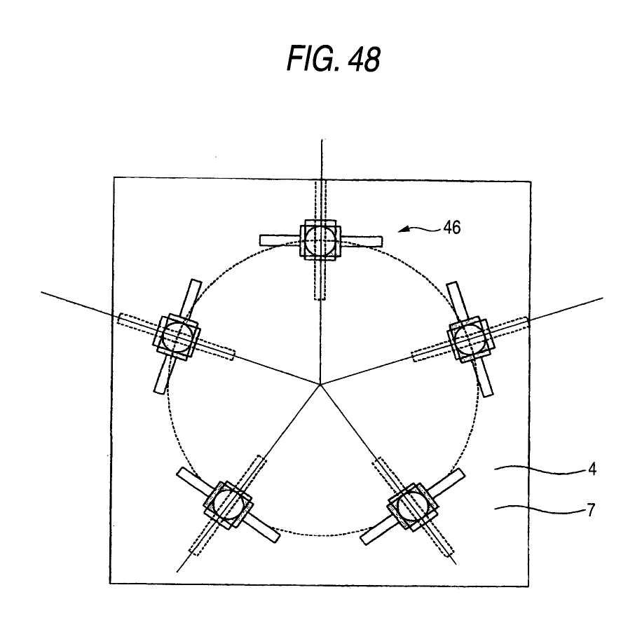

FIG. 48 is a top view of the alignment apparatus showing the third embodiment of the invention and a view showing Arrangement Example 1 of other drive mechanism unit or 3 freedom degree mechanism,

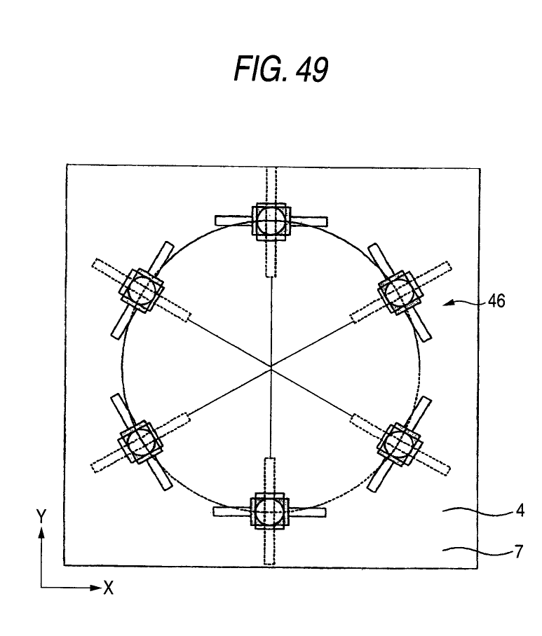

FIG. 49 is a top view of the alignment apparatus showing the third embodiment of the invention and a view showing Arrangement Example 2 of other drive mechanism unit or 3 freedom degree mechanism, and

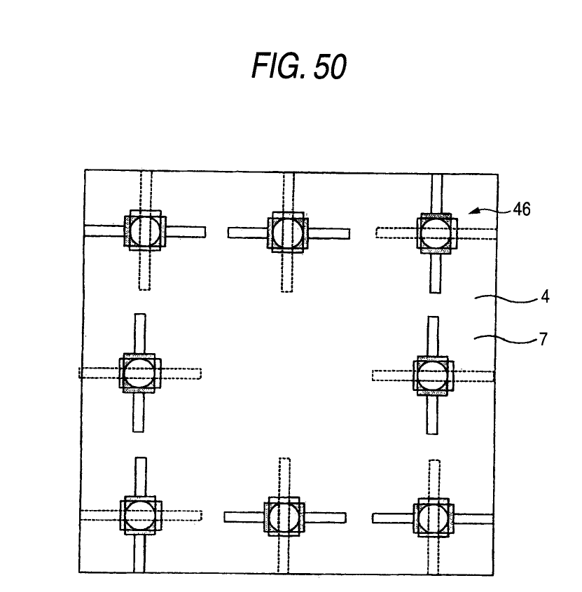

FIG. 50 is a top view of the alignment apparatus showing the third embodiment of the invention and a view showing Arrangement Example 3 of other drive mechanism or 3 freedom degree mechanism.

The drive mechanism unit 6 or the 3 freedom degree mechanism 16 necessary for an operation or a function of the table 4 and an arrangement thereof may be selected.

According to the above-described constitution, when the original point returning similar to that of the first embodiment or the second embodiment is realized, the instructing apparatus 8 can form an accurate operation instruction, and therefore, XYθ operation of the table 4 can accurately be realized by driving the motor 3.

### Embodiment 4

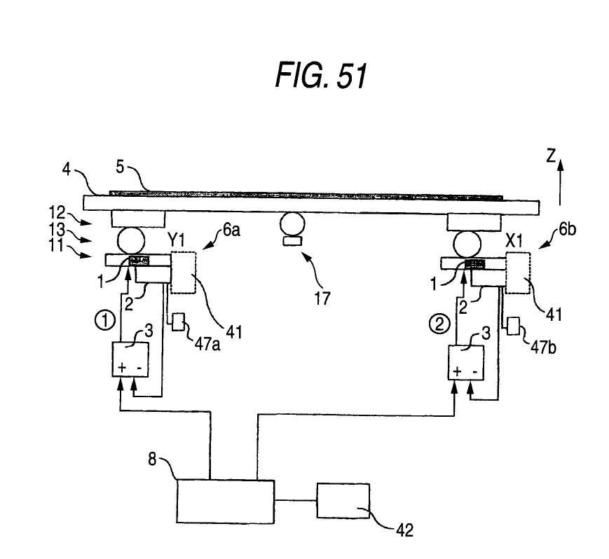

FIG. 51 is a schematic diagram and a control block diagram of an alignment apparatus showing a fourth embodiment of the invention,

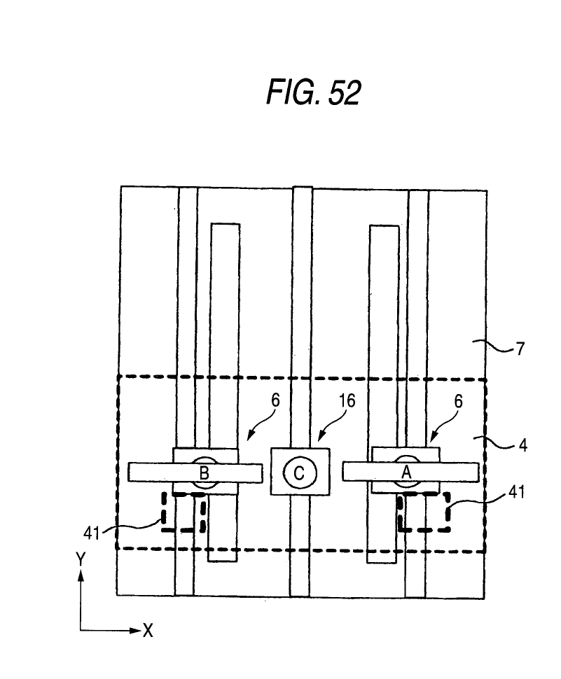

FIG. 52 is a top view of the alignment apparatus showing the fourth embodiment of the invention and a view of arranging a drive mechanism unit, and

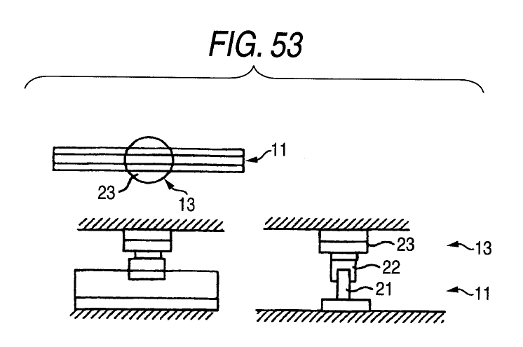

FIG. 53 is an outline view of a 2 freedom degree mechanism of the alignment apparatus showing the fourth embodiment of the invention.

The embodiment is an example of a table operated in Yθ.

In the drawings, numeral 1 designates the motor (linear motor 1L), numeral 2 designates the detecting apparatus, numeral 3 designates the controller, numeral 4 designates the table, numeral 5 designates the object, numeral 6 designates the drive mechanism unit, numeral 7 designates the machine base portion, numeral 8 designates the instructing apparatus, numeral 11 designates the translational freedom degree portion, numeral 12 designates the translational drive portion, numeral 13 designates the rotational freedom degree portion, numeral 21 designates the direct advancing guide, numeral 22 designates the direct advancing guide block, numeral 23 designates the rotating bearing, numeral 41 designates the machine fixing apparatus, numeral 42 designates the machine fixing reference position storing apparatus, and numeral 47 designates an absolute position storing apparatus. Further, the detecting apparatus 2 having the absolute position storing apparatus 47 is of an absolute value type.

The embodiment differs from the first embodiment through the third embodiment in that the table 4 is provided with 2 freedom degrees and is operated in Yθ. A center of rotation of the table 4 is provided with a 2 freedom degree mechanism shown in FIG. 53. 2 of the drive mechanism units 6 are arranged with one of the linear motor 1L and is operated to translate in Y direction.

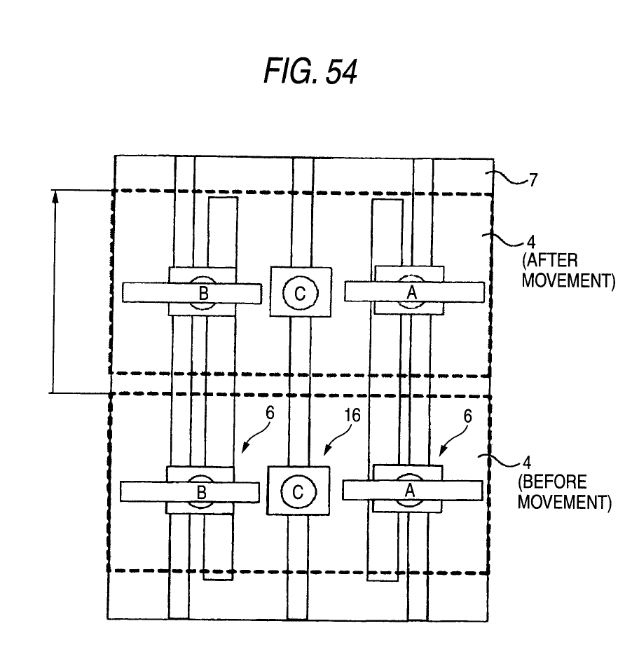

FIG. 54 is a view showing a translational movement and the table of the alignment apparatus showing the fourth embodiment of the invention, and

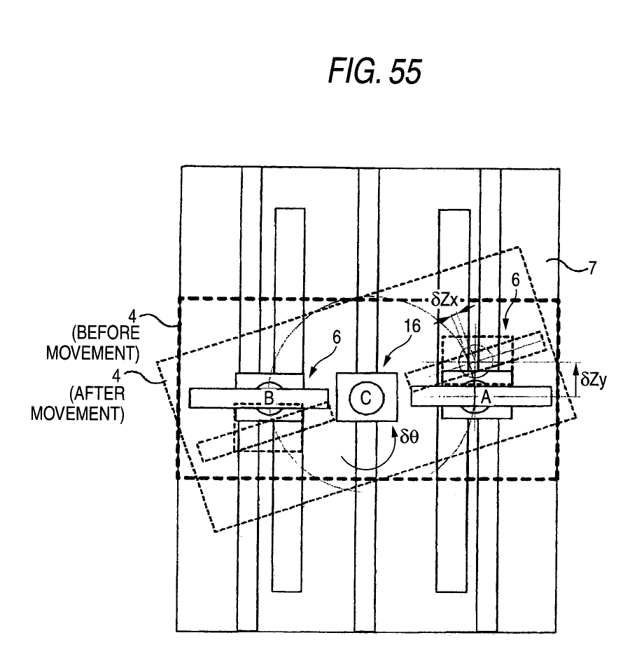

FIG. 55 is a view showing a rotational movement of the table of the alignment apparatus showing the fourth embodiment of the invention.

Although it is difficult for the alignment apparatus of XYθ operation to construct a constitution of capable of being moved by a long stroke, according to the embodiment, the alignment apparatus is not movable in X direction, and therefore, the alignment apparatus can be moved by a long stroke in Y direction.

Further, even in the table operated in Yθ as in the embodiment, the problem shown in FIG. 6 and FIG. 7 of the first embodiment is posed. However, the 2 freedom degree mechanism constitutes the center of rotation of the table 4, as shown by FIG. 52, the linear motors 1L of the two drive mechanism units 6 are arranged in Y direction constituting a tangential line from the center of rotation of the table 4, and therefore, absolute values of moving amounts of the linear motors 1L when rotated by the same angle in regular rotation and reverse rotation of the table 4 are the same. When distances of the two drive mechanism unit 6 from the center of rotation are the same, the absolute values of the moving amounts of the linear motors 1L in rotating the table are the same.

However, the problem that the moving amounts of the linear motors 1L do not constitute an equal interval even when the table is moved by a rotational angle at an equal interval is posed similar to the first embodiment.

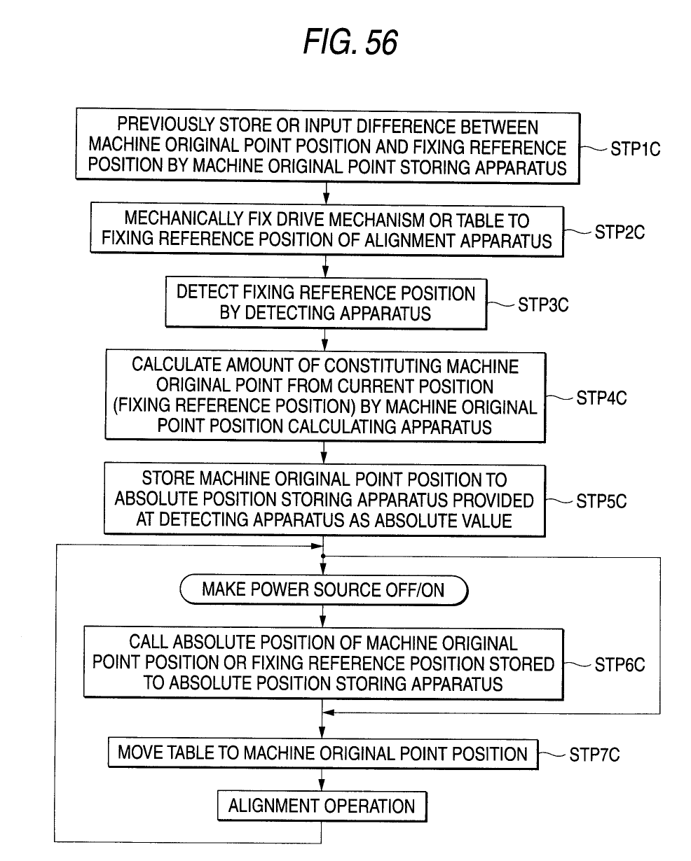

FIG. 56 is a flowchart showing an original point returning method of the alignment apparatus showing the fourth embodiment of the invention.

It is necessary to calculate an instruction of rotating the table 4 by constituting a reference by the machine original point position, and the original point returning is carried out by a procedure shown in FIG. 54. Further, the method differs from those of the first embodiment and the second embodiment.

At step STP1C, the difference between the machine original point position and the fixing reference position is stored or inputted previously by the machine original point storing apparatus.

At step STP2C, the drive mechanism of the table is mechanically fixed to the fixing reference position of the alignment apparatus.

At step STP3C, the fixing reference position is detected by the detecting apparatus.

At step STP4C, an amount of constituting the machine original point position from a current position (fixing reference position) is calculated by the machine original point position calculating apparatus. Step STP1C through step STP4c are the same as those of the first embodiment.

At step STP5C, the machine original point position is stored at the absolute position storing apparatus provided at the detecting apparatus as the absolute value.

Thereafter, a routine processing after temporarily cutting the power source and inputting again the power source is carried out.

At step STP6C, the absolute position of the machine original point position or the fixing reference position stored to the absolute position storing apparatus is called.

At step STP7C, the table is moved to the machine original point position.

As described above, the original point returning is finished and the alignment apparatus can be operated.

The above-described processing will be explained in details.

Step STP1C through step STP4C are the same as those of the first embodiment.

At step STP2C of mechanically fixing the drive mechanism or the table to the fixing reference position of the alignment apparatus, the table 4 is fixed as shown by FIG. 52, and therefore, the difference is 0 and step STP1C of storing or inputting the difference between the machine original point position and the fixing reference position can actually be omitted.

The drive unit 6 is fixed by two of the machine fixing apparatus 41. The drive unit 6 is fixed as shown by FIG. 10 of the first embodiment. The table 4 is operated in Yθ and therefore, two points may be fixed. At step STP3C of detecting the fixing reference position by the detecting apparatus, the fixing position is recognized.

As shown by FIG. 52, the fixing reference position is the machine original point position, and therefore, step STP4C of calculating an amount of constituting the machine original point position from the current position (fixing reference position) by the machine original point position calculating apparatus may actually be omitted.

Step STPLC through step STP4C are the same as those of the first embodiment.

At step STP5C, the machine original point position is stored at the absolute position storing apparatus provided to the detecting apparatus as the absolute value. Two of the drive mechanism units 6 are used for Yθ operation, and therefore, the machine original point position is stored to two of the absolute position storing apparatus 47.

The detecting apparatus 2 of the absolute value type is finished to set up as described above.

Thereafter, the routine processing after temporarily cutting the power source and inputting the power source again is carried out.

Since the detecting apparatus 2 of the absolute value type is utilized, when two of the absolute value positions are called at step STP6C for the two drive mechanism units 6 of the machine original point position or the fixing reference position and the motor 1 is driven to move at step STP7C, the original point returning is finished.

Even when the detecting apparatus 2 of the absolute value type is used, it is necessary to grasp the actual machine original point position, and therefore, the machine original point position is stored as the absolute value by fixing the apparatus at the fixing reference position, or the machine original point position as in the embodiment (FIG. 52) by the machine fixing apparatus 41.

The alignment apparatus capable of operating in Yθ accurately by returning to the original point as described above can be realized.

Further, although according to the embodiment, the table of 2 freedom degrees operated in Yθ is used, the original point returning can also be carried out by carrying out a similar processing in the table of 3 freedom degrees operated in XYθ as in the first embodiment, the second embodiment, the third embodiment.

Although according to the embodiment, the alignment apparatus operated in Yθ by the drive mechanism unit 6 shown in FIG. 3 of the first embodiment and the 2 freedom degree mechanism 17 shown in FIG. 53 is realized by the constitution of FIG. 51 and FIG. 52, the apparatus may be constituted as follows.

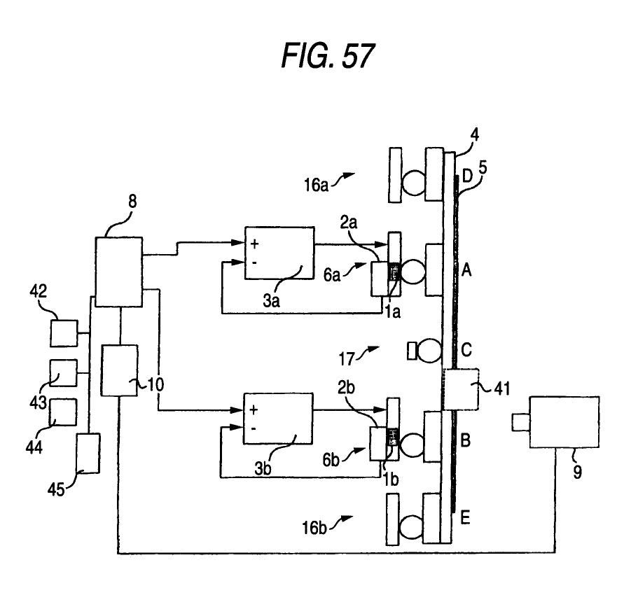

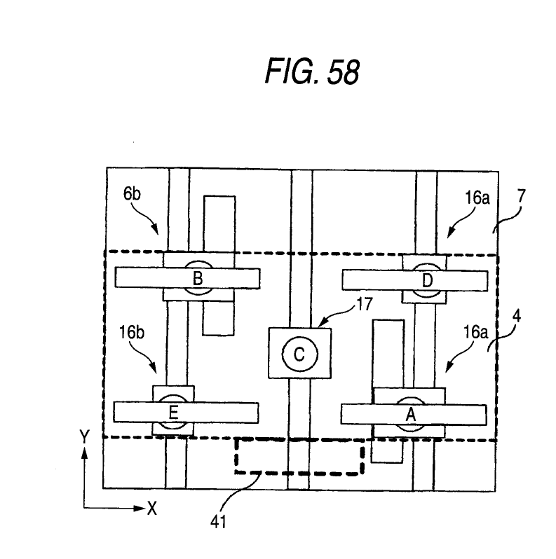

FIG. 57 shows Example 1 of other schematic diagram and a control block diagram of the alignment apparatus showing the fourth embodiment of the invention, FIG. 58 is a top view of the alignment apparatus showing the fifth embodiment of the invention and a view of arranging a drive mechanism unit, and FIG. 58 is an outline view of a 2 freedom degree drive mechanism of an alignment apparatus showing a sixth embodiment of the invention.

A point of a difference from FIG. 51 and FIG. 52 resides in adding a 3 freedom degree mechanism 16. Further, 2 of the drive units 6 are arranged to be remote from each other in an up and down direction of the drawing and in a front and rear direction of the table 4. Further, the 2 freedom degree drive mechanism 18 mounted with the motor 1 at the 2 freedom degree mechanism 17 is arranged at the center of rotation of the table 4. In addition thereto, the two-dimensional position detecting apparatus 9 and the two-dimensional image processing apparatus 10 are provided. Further, for the original point returning, similar to the first embodiment, the machine fixing apparatus 41, the machine fixing reference position storing apparatus 42, the machine original point storing apparatus 43, and the machine original point returning amount calculating apparatus 45 are provided. Further, the detecting apparatus 2 is of the increment value type.

The drive units 6 are arranged at positions of A and B of FIG. 58, the 3 freedom degree mechanisms 16 are arranged at positions of E and D and the 2 freedom degree drive mechanism 18 is arranged at a position of C.

Further, even in the table operated in Yθ as in the embodiment, the problem shown in FIG. 6 and FIG. 7 of the first embodiment is posed. The drive mechanism unit 6 does not constitute a tangential line from the center of rotation of the table 4 different from Embodiment 4, and therefore, moving amounts of the linear motor 1L in Y direction differs by regular and reverse rotation of the table 4.

In this way, the constitution of operating in Yθ is constructed, and therefore, when the table 4 is fixed by the machine fixing apparatus 41, the table 4 may be fixed by one of the machine fixing apparatus 41 as shown by FIG. 58. The table 4 and the machine base portion 7 can be fixed by positioning the table 4 and the machine base portion 7 as shown by FIG. 19 by the procedure of FIG. 17 of the second embodiment.

Similar to the first embodiment, the machine fixing apparatus 41, the machine fixing reference position storing apparatus 42, the machine original point storing apparatus 43, and the machine original point returning amount calculating apparatus 45 are provided, and therefore, the original point returning can be carried out similar to the first embodiment. Further, the original point returning may be carried out similar to the second embodiment by using the reference image position storing apparatus 48, the two-dimensional position detecting apparatus 9 and the two-dimensional image processing apparatus 10 which are not shown in FIG. 58. Further, when the detecting apparatus 2 is changed to an absolute value type having the absolute position storing apparatus 47, the original point returning may be carried out similar to the third embodiment.

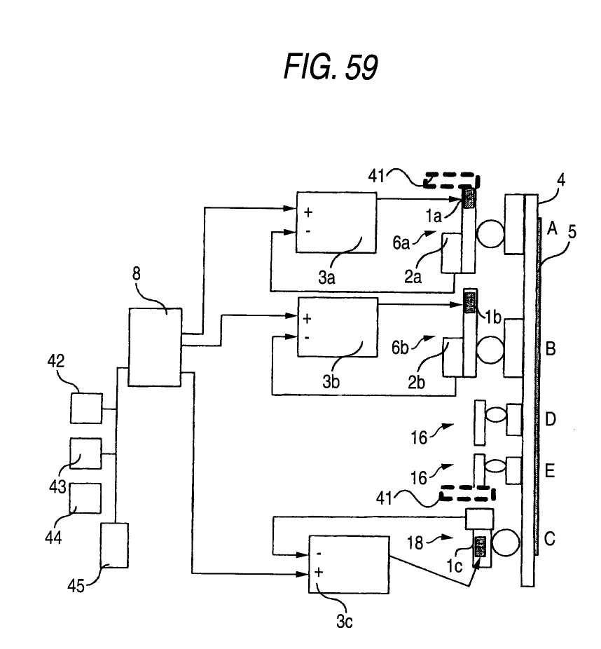

FIG. 59 shows Example 2 of other schematic diagram and a control block diagram of the alignment apparatus showing the fourth embodiment of the invention,

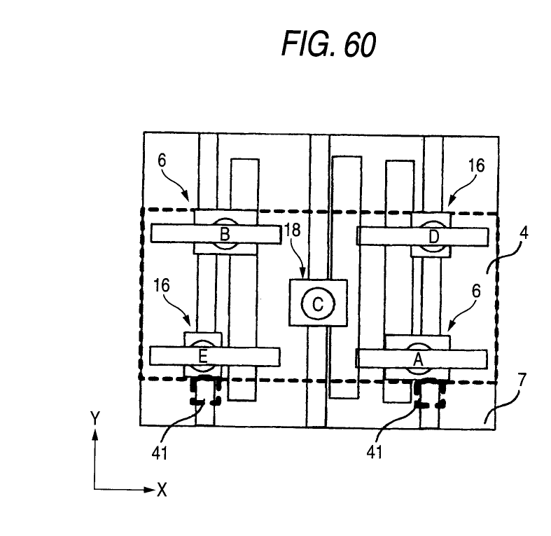

FIG. 60 is a top view of other Example 2 of the alignment apparatus showing the fourth embodiment of the invention and a view of arranging the drive mechanism unit,

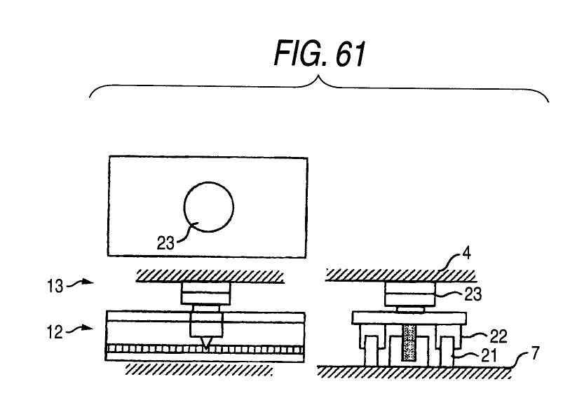

FIG. 61 is an outline view of a 2 freedom degree drive mechanism of other Example 2 of the alignment apparatus showing the fourth embodiment of the invention,

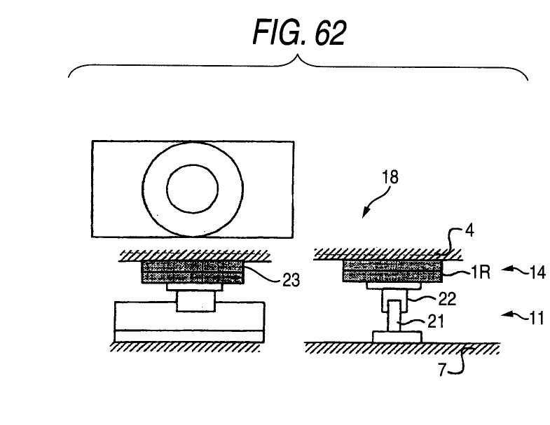

FIG. 62 shows Example 1 of an outline view of other 2 freedom degree mechanism of the alignment apparatus showing the fourth embodiment of the invention, and

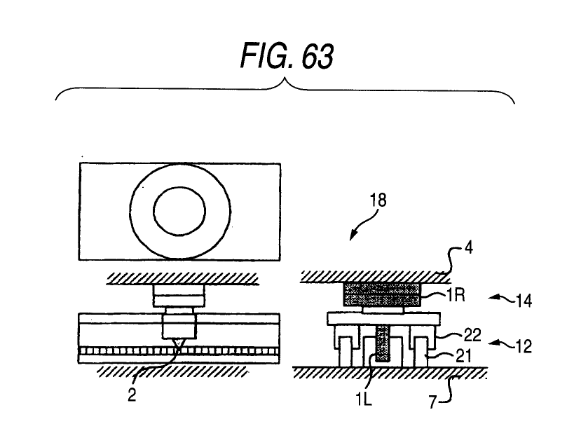

FIG. 63 shows Example 2 of an outline view of other 2 freedom degree drive mechanism of the alignment apparatus showing the fourth embodiment of the invention.

A point of difference from FIG. 57 and FIG. 58 resides in that the center of rotation of the table 4 is added with the 2 freedom degree drive mechanism 18 mounted with the motor 1 at the 2 freedom degree mechanism 17 as shown by FIG. 61. Further, the two-dimensional position detecting apparatus 9 and the two-dimensional image processing apparatus are not illustrated in the drawings.

The machine fixing apparatus 41 fixes two points of the drive mechanism 46 constituting the drive mechanism unit 6 and the 3 freedom degree mechanism 16 different from FIG. 57 and FIG. 58. The apparatus can be fixed by being positioned as in FIG. 10 by the procedure of FIG. 9 of the first embodiment.

The original point returning can be carried out similar to the first embodiment. Further, the original point returning may be carried out similar to the second embodiment and the third embodiment by using a necessary apparatus or an apparatus.

Further, the 2 freedom degree drive mechanism 18 may be constituted by a structure shown in FIG. 62 or FIG. 63.

In this way, the constitution operated in Yθ is constructed, and therefore, Yθ operation of the table 4 can accurately be carried out by driving the motor 3 by fixing the table 4 by the machine fixing apparatus 41 and carrying out the original point returning.

### Embodiment 5

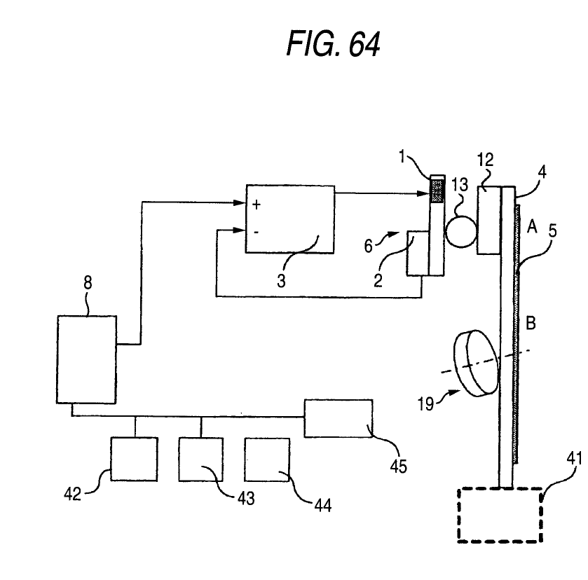

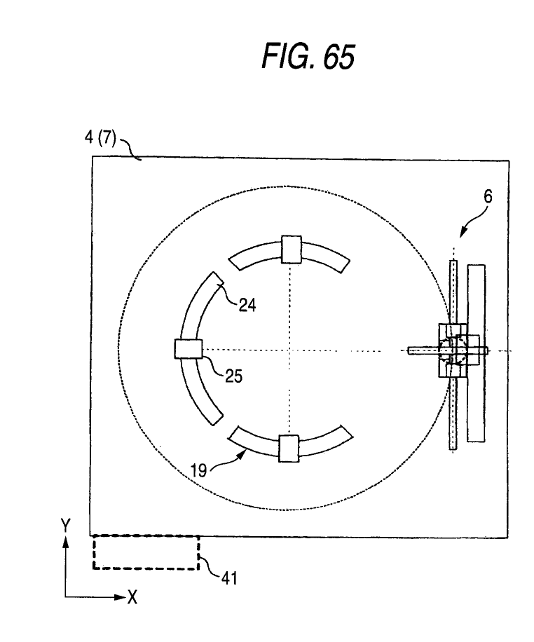

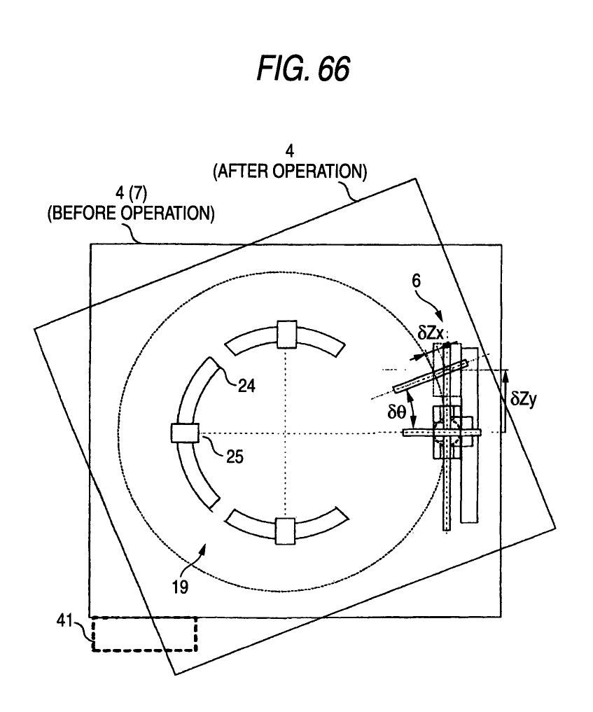

FIG. 64 is a schematic diagram and a control block diagram of an alignment apparatus showing a fifth embodiment of the invention, FIG. 65 is a top view of the alignment apparatus showing the fifth embodiment of the invention and a view of arranging the drive mechanism unit, and FIG. 66 is a view showing a rotational movement of a table of the alignment apparatus showing the fifth embodiment of the invention.

The embodiment is an example of a table operated in θ. The table 4 is rotated in θ by constituting a mechanism of one rotational freedom degree by using the drive mechanism unit 6 and arranging a rotational 1 freedom degree mechanism 19 to the table 4. The rotational 1 freedom degree mechanism 19 is constituted by a curve guide 24 and a curve guide block.

As shown by FIG. 66, the table 4 can be operated to rotate by the translational movement of the translational drive portion 12 of the drive mechanism unit 6. Further, although the drive mechanism unit 6 of FIG. 3 used in the first embodiment is used, the function remains unchanged even when the drive mechanism unit 6 of other constitution is used.

The drive mechanism unit 6 is attached in a tangential direction of a rotating circle, and therefore, there poses the problem shown in FIG. 6 and FIG. 7 of the first embodiment in which although absolute values of moving amounts of the linear motor 1L when the table 4 is rotated by the same angle in regular rotation and in reverse rotation are the same, an angle of rotating the table 4 differs by the position of the linear motor 1L of the movable portion of the drive mechanism unit 6.

Therefore, the original point returning is carried out by fixing the table 4 by the one machine fixing apparatus 41. The table 4 can be fixed by being positioned as in FIG. 19 by the procedure of FIG. 17 of the second embodiment.

The original point returning can be carried out similar to the first embodiment. Further, the original point returning may be carried out similar to the second embodiment and the fourth embodiment by using necessary apparatus or means.

The alignment capable of being operated in θ accurately can be realized by carrying out the original point returning as described above.

Although according to the embodiment, the alignment operated in θ is realized by the constitution of FIG. 64 and FIG. 65, the embodiment may be constituted as follows.

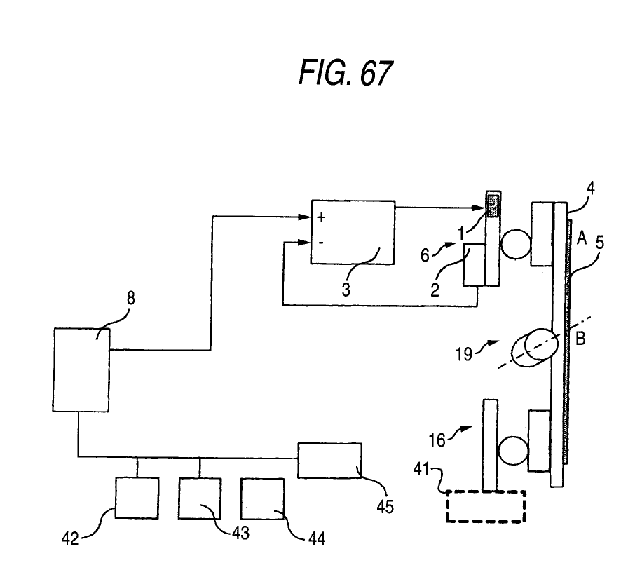

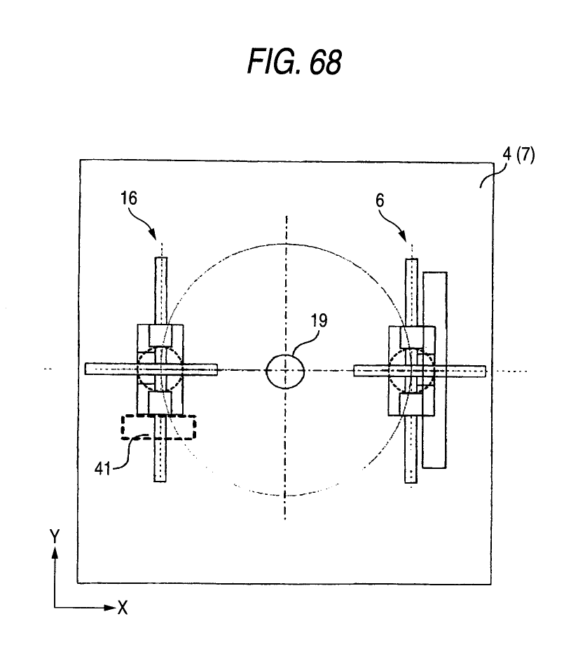

FIG. 67 shows Example 1 of other schematic diagram and a control block diagram of the alignment apparatus showing the fifth embodiment of the invention, and FIG. 68 is a top view of other example of the alignment apparatus showing the fifth embodiment of the invention and a view of arranging the drive mechanism unit.

A difference from FIG. 64 and FIG. 65 resides in adding the 3 freedom degree mechanism 16. Further, a rotational 1 freedom degree mechanism 19 is constituted as the rotational freedom degree portion 13. In addition thereto, the machine fixing apparatus 41 is fixed with the drive mechanism 46 constituting the 3 freedom degree mechanism 16. The apparatus can be fixed by being positioned as shown by FIG. 10 by the procedure of FIG. 9 of the first embodiment.

The original point returning can be carried out similar to the first embodiment. Further, the original point returning may be carried out similar to the second embodiment and the third embodiment by using necessary apparatus or means.

In this way, since the constitution operated in θ is constructed, and therefore, the Yθ operation of the table 4 can accurately be realized by driving the motor 3 by fixing the table 4 by the machine fixing apparatus 41 and carrying out the original point returning.

### Example 6

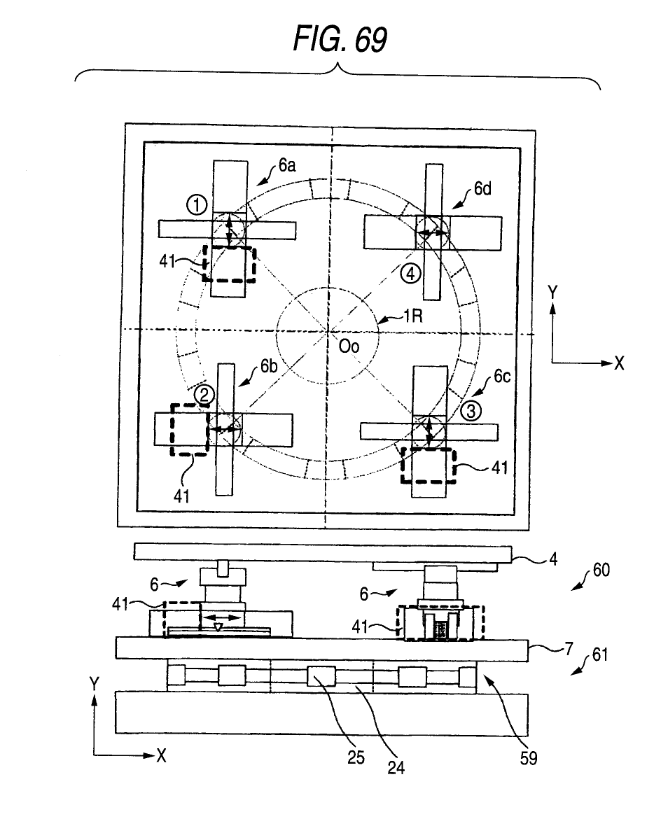

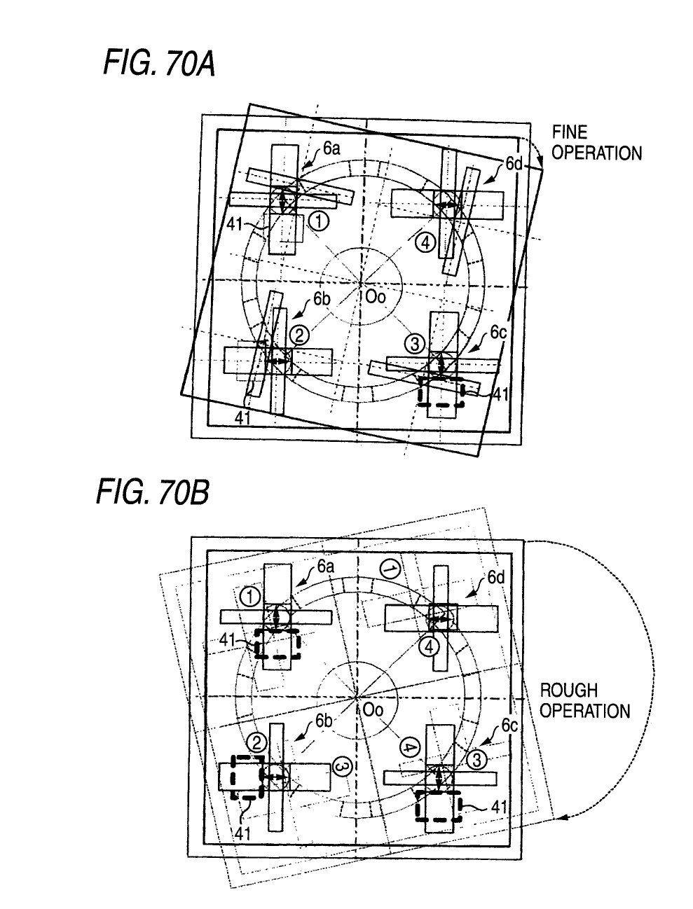

FIG. 69 illustrates a top view and an arrangement view and a side view of a turning table including an alignment apparatus showing a sixth embodiment of the invention, and FIG. 70 illustrates views showing a table of a translational table including the alignment apparatus showing the sixth embodiment of the invention and a rotational movement of the translational table.

The alignment apparatus shown in the first embodiment is mounted above the turning table.

The turning table constitutes a rotational 1 freedom degree mechanism 19 comprising the rotational type motor 1R and the curve guide 24 and the curve guide block 25.

A two layers structure is constituted, and a height thereof is increased, and although the alignment apparatus can be executed to rotate by a small amount as shown by FIG. 70(a), the turning table is constituted by a structure of capable of carrying out rotation by a large amount as shown by FIG. 70(b). The alignment apparatus carries out a fine operation. Thereby, an operational range is widened and a use is widened. The alignment apparatus is the same as that of the first embodiment, and therefore, the drive mechanism unit 6 can be fixed similar to the first embodiment. Further, the original point returning can be carried out similar to the first embodiment. Further, the original point returning can be carried out similar to the second embodiment or the fourth embodiment by using necessary apparatus or means.

Further, although the drive mechanism unit 6 of FIG. 3 used in the first embodiment is used, the function remains unchanged even when the drive mechanism unit 6 of other constitution is used.

The alignment apparatus operated in XYθ accurately carrying out the original point returning can be realized as described above. Further, the turning table including the alignment apparatus operated in XYθ accurately can be realized.

### Embodiment 7

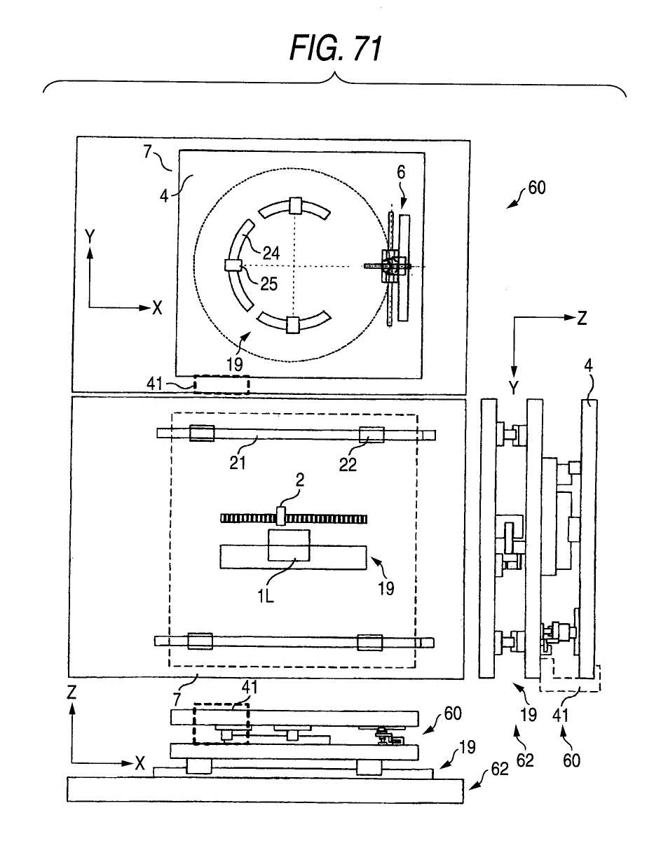

FIG. 71 illustrates a top view and a side view and a view of arranging a drive mechanism unit and a drive mechanism portion of a translational table including an alignment apparatus showing a seventh embodiment of the invention.

The alignment apparatus operated in θ shown in the fifth embodiment is mounted above a translational stage.

Although only the alignment apparatus and the translational table are shown in the drawing, with regard to the alignment apparatus, the original point returning can be carried out similar to the first embodiment, the second embodiment, the fourth embodiment when necessary apparatus or means are prepared.

The alignment apparatus capable of being operated in θ accurately by carrying out the original point returning can be realized as described above. Further, the translational table including the alignment apparatus operated in θ accurately can be realized.

### Embodiment 8

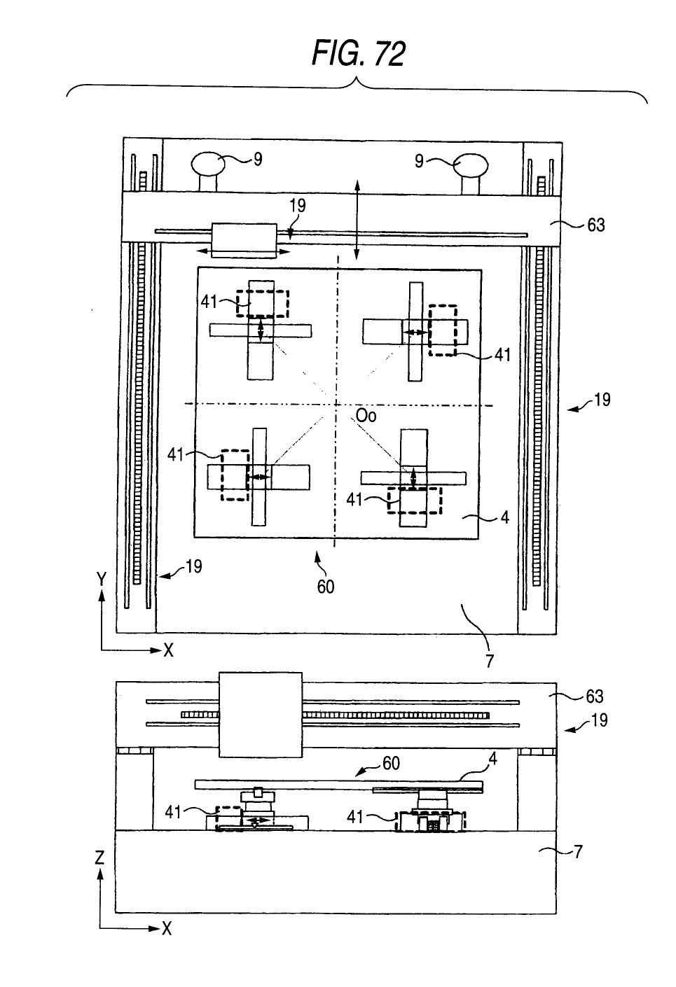

FIG. 72 is a top view of a machine control system of a gantry mechanism constituting a machine including an alignment apparatus showing an eighth embodiment of the invention,

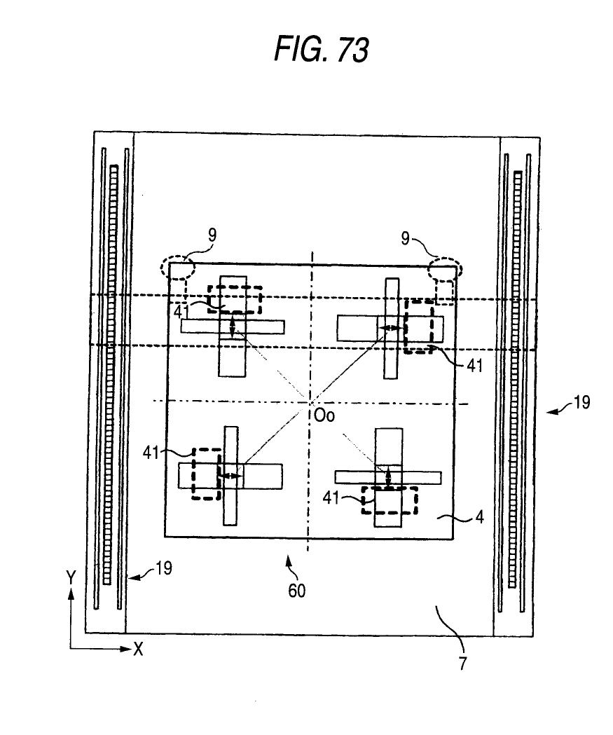

FIG. 73 is a view showing an operation of the gantry mechanism constituting the machine including the alignment apparatus showing the eighth embodiment of the invention, and

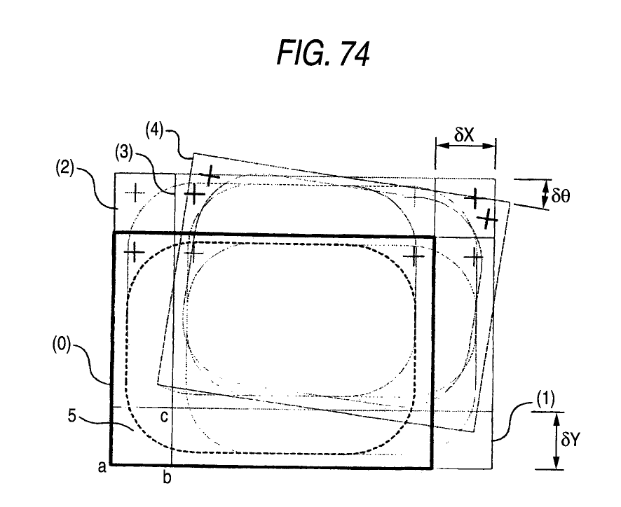

FIG. 74 is a view showing the alignment apparatus of the gantry mechanism constituting the machine including the alignment apparatus showing the eighth embodiment of the invention and the operation of the gantry mechanism.

The alignment apparatus of the first embodiment is mounted on the machine control system of the gantry mechanism.

In the gantry mechanism, a gantry movable portion 63 is operated by a biaxial drive mechanism portion 59. The drive mechanism portion 59 is provided also the gantry movable portion 63 and an operation in XY can be carried out by the gantry mechanism. Further, 2 of the two-dimensional position detecting apparatus 9 are attached to the gantry movable portion 63 and can be moved above the alignment apparatus by moving the gantry movable portion 63. The mark attached onto the table 4 or the object 5 of the alignment apparatus can be detected. The machine fixing apparatus 41 of the alignment apparatus is attached similar to the first embodiment, and the original point returning can be carried out similar to the first embodiment. Although only the alignment apparatus and the gantry mechanism and the two-dimensional position detecting apparatus 9 are shown in the drawing, with regard to the alignment apparatus, the original point returning can be carried out similar to the first embodiment as well as the second embodiment, the fourth embodiment by using necessary apparatus or means.

When the original point returning is finished, the alignment apparatus capable of being operated in XYθ can be realized, and therefore, based on the mark of the object 5 placed onto the table 4 to be shifted in XYθ directions, a shift can be corrected by using 2 of the two-dimensional position detecting apparatus 9.

(4) of FIG. 74 shows an initial position of the object 5 placed onto the table 4 of the alignment apparatus 60. When the object 5 is detected by the two-dimensional position detecting apparatus 9 and processed by the two-dimensional image processing apparatus 10, not illustrated, a shift amount in XYθ directions can be grasped as shown by FIG. 21.

According to the machine control system of a mode as in the embodiment, there is needed an operation of operating the gantry mechanism in XY on a locus drawn on the object 5 placed as in (0) of FIG. 74 by a dotted line. An operation cannot be carried out by staying to be in (4) of FIG. 74, and therefore, XYθ position of the object 5 is corrected by the alignment apparatus 60.

When the table 4 of the alignment apparatus 60 is moved by a shift amount δθ of rotation, (3) of FIG. 74 is constituted and the shift of rotation is eliminated. Further, when the table 4 of the alignment apparatus 60 is moved by a shift amount δY, (1) is constituted and when moved by a shift amount δX in X direction, (2) is constituted from (3). When the shift amount in XY can be corrected by the translational movement of the table 4 of the alignment apparatus 60, the object 5 becomes (0) of FIG. 74 to constitute the mode. Thereby, the gantry mechanism can be operated in XY.

Although in order to carry out such an operation, an accurate operation in XYθ of the alignment apparatus is needed, the operation can be carried out since the original point returning is carried out.

In this way, the alignment apparatus is fixed as in the first embodiment or the second embodiment, the original point returning is carried out as in the first embodiment, the second embodiment or the fourth embodiment, and therefore, the apparatus can be operated in XYθ highly accurately, and the machine control system capable of working or processing the object 5 is constituted by the XY operation of the gantry mechanism.

### Embodiment 9

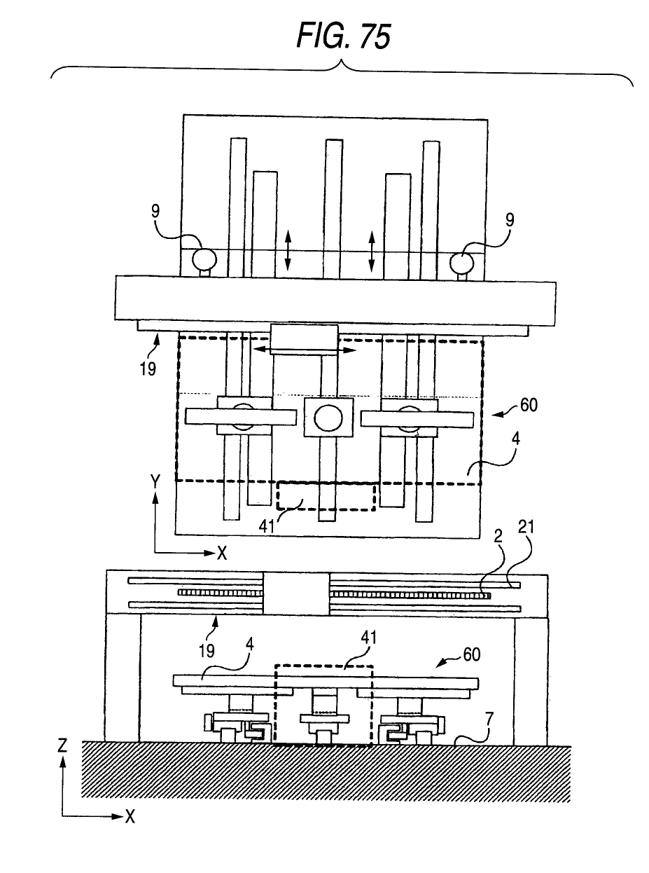

FIG. 75 illustrates a top view and a side view of a machine control system of a gantry mechanism and a gate type fixing mechanism constituting a machine including an alignment apparatus showing a ninth embodiment of the invention.

There is constructed a constitution constituting a table capable of driving and turning a gantry by also using the alignment apparatus shown in the fourth embodiment and combining a gate type fixing mechanism. Although the gate type fixing mechanism includes the drive mechanism portion 59 in X direction, the gate type fixing mechanism is fixed.

The alignment apparatus 60 can be moved in Y direction capable of being moved by a long stroke and moved in δ direction as shown by the fourth embodiment. The gate type fixing mechanism can be moved in X direction, and therefore, operation in XYθ can be carried out by a total of the machine control system.

The mark of the table 4 or the object 5 can be detected by the two-dimensional position detecting apparatus 9 by moving the table 4 of the alignment apparatus 60 in Y direction. When the operation shown by FIG. 74 of the eighth embodiment is carried out, the alignment apparatus 60 of the embodiment cannot correct the object in X direction, and therefore, the operation is carried out by bringing about a state of (3) of FIG. 74 for moving by δθ, or (1) of FIG. 74 further corrected by δY.

The operation in XYθ can be carried out at a total of the machine control system, and therefore, δX is corrected by starting to shift an operation start point in X direction of the drive mechanism portion 59 of the gate fixing mechanism by δX. δY may be corrected by bringing about the state of (1) of FIG. 74 as a function of the alignment apparatus previously, or may be corrected by starting an operation start point in Y direction by δY.

In correcting δθ, as described above, the problem shown in FIG. 6 and FIG. 7 of the first embodiment is posed, and therefore, δθ may be corrected by fixing the alignment apparatus and by the method of any of the first embodiment, the second embodiment or the fourth embodiment. Although in FIG. 75, the table 4 is shown to be fixed as in FIG. 58 of the fourth embodiment, 2 of the drive mechanism units 6 may be fixed as in FIG. 52 of the fourth embodiment.

Although the machine fixing apparatus 41, the machine fixing reference position storing apparatus 42, the machine original point storing apparatus 43, the machine original point returning amount calculating apparatus 45 as well as the reference image position storing apparatus 48, the absolute position storing apparatus 47 and the two-dimensional image processing apparatus 10 are not shown in FIG. 75, the original point returning may be carried out by the method of any of the first embodiment, the second embodiment or the fourth embodiment.

When the original point returning is carried out, the operation in Yθ of the alignment apparatus can be carried out accurately and the accurate machine control system is constituted.

In this way, the alignment apparatus is fixed as in the first embodiment and the second embodiment, and the original point returning is carried out as in the first embodiment, the second embodiment, or the fourth embodiment, and therefore, the highly accurate Yθ operation can be carried out, and the machine control system capable of working or processing the object 5 is constituted by XY operation including the alignment apparatus.

### INDUSTRIAL APPLICABILITY

The drive mechanism unit is arranged at one plane of the machine base portion, and therefore, the table can be thinned.

The invention is applicable to an alignment apparatus or the like of a machine tool in which a load is dispersedly supported even when the table is large-sized.

Further, sine the thin alignment apparatus is constituted, heights of the machine for carrying out other operation and a machine of a total of the machine control system can be formed to be low. Therefore, a stable apparatus having a low gravitational center can be realized, a rigidity can be increased, and therefore, a vibration is difficult to be generated, and the operation and the function of the drive mechanism portion can be promoted. That is, an effect of capable of promoting the function of the total of the machine control system is achieved.

The position is controlled by using the detecting apparatus mounted to the drive mechanism unit, and therefore, even when the table is large-sized, in a case of arranging the drive mechanism unit at a vicinity of an outer periphery of the table, a resolution is promoted in the table rotating operation more than that in detecting the position at the center of the table to achieve an effect of promoting the function.

Further, the height of the machine of an operating portion from above the alignment apparatus can be formed to be low, and therefore, low cost can be constituted by restraining a material thereof. Further, the portion can be light-weighted, and therefore, also an operation of fabricating/integrating the machine and the machine control system is simplified.

In addition thereto, according to the structure, by arranging the drive mechanism unit, a hollow structure hollowing the center of the table which cannot be realized by using the rotating type motor can be formed and a use thereof can be widened.

Further, even when the apparatus is large-sized, the constitution of dispersing the drive force by utilizing a plurality of standard motors without using a special large-sized motor can be constituted, and therefore, there is also achieved an advantage of capable of easily procuring parts in comparison with a special product in view of delivery or cost of an apparatus part.

1. An alignment apparatus for operating a table mounted with an object in XYθ, Yθ, or θ by way of a drive mechanism arranged at a machine base portion to be positioned to a predetermined position, the alignment apparatus comprising:
the drive mechanism comprising a plurality of drive mechanism units each constituted by;
a mechanism portion comprising two translational freedom degree portions each having a translational freedom degree and one rotational freedom degree portion having a rotational freedom degree; and
a motor control apparatus comprising motors for driving the freedom degree portions of the two translational freedom degree portions and the one rotational freedom degree portion, a detecting apparatus for detecting an amount of operating the mechanism portion constituting a member to be detected, and a controller for controlling the motors by receiving an operation instruction to constitute the motors of a number at least the same as a number of freedom degrees of XYθ, Yθ or θ operation of the table;
the drive mechanism units comprising an instructing apparatus for providing the operation instruction to the controller;
the table being operated to translationally move and rotationally move in two directions of the XYθ operation, to translationally move and rotationally move in one direction of the Yθ operation, or rotationally move of the θ operation by operating the motors respectively in a translational direction or a rotational direction;
a machine original point storing apparatus for previously storing or inputting difference between a machine original point position and a fixing reference position;
a machine fixing apparatus for mechanically fixing the table or the drive mechanism at the fixing reference position of the alignment apparatus;
a machine fixing reference position storing apparatus for detecting and storing the machine fixing reference positions of a number at least the same as a number of freedom degrees provided to the table by the detecting apparatus;
a detecting apparatus reference position storing apparatus for disengaging the machine fixing apparatus, detecting detecting apparatus reference position references of a number at least the same as the number of the freedom degrees provided to the table by the detecting apparatus by driving the motors of a number at least the same as the number of the freedom degrees provided to the table, and storing differences between the detecting apparatus reference positions and the machine original point positions or the fixing reference positions of the number at least the same as the number of the freedom degrees provided to the table; and
a machine original point returning amount calculating apparatus for detecting the detecting apparatus reference position references of the number at least the same as the number of the freedom degrees provided to the table by driving the motors of the number at least the same as the number of the freedom degrees provided to the table, and calculating moving amounts of the motors of the number at least the same as the number of the freedom degrees provided to the table for making the table and the drive mechanism unit disposed at the machine original point or the fixing reference position from a current position in a state in which the machine fixing apparatus is not present routinely after the above-described processing has been finished and a power source is introduced again, wherein
the table and the drive mechanism unit are moved to the machine original point position by operating the motors of the number at least the same as the number of the freedom degrees provided to the table.

2. An alignment apparatus for operating a table mounted with an object in XYθ, Yθ, or θ by way of a drive mechanism arranged at a machine base portion to be positioned to a predetermined position,
the alignment apparatus comprising:
the drive mechanism comprising a plurality of drive mechanism units each constituted by;
a mechanism portion comprising two translational freedom degree portions each having a translational freedom degree and one rotational freedom degree portion having a rotational freedom degree; and
a motor control apparatus comprising motors for driving the freedom degree portions of the two translational freedom degree portions and the one rotational freedom degree portion, a detecting apparatus for detecting an amount of operating the mechanism portion constituting a member to be detected, and a controller for controlling the motors by receiving an operation instruction to constitute the motors of a number at least the same as a number of freedom degrees of XYθ, Yθ or θ operation of the table;
the drive mechanism units comprising an instructing apparatus for providing the operation instruction to the controller;
the table being operated to translationally move and rotationally move in two directions of the XYθ operation, to translationally move and rotationally move in one direction of the Yθ operation, or rotationally move of the θ operation by operating the motors respectively in a translational direction or a rotational direction;
a machine fixing apparatus for mechanically fixing the table or the drive mechanism at a fixing reference position of the alignment apparatus;
a machine original point storing apparatus for previously storing or inputting difference between a machine original point and the fixing reference position;
a two-dimensional position detecting apparatus for detecting a mark previously provided to the table or the object;
a two-dimensional image processing apparatus for calculating a moving amount of the table necessary for moving to an arbitrary position based on the image of the two-dimensional position detecting apparatus;
a reference image position storing apparatus for storing a reference image position by constituting an absolute position by a position of a mark of an image by using outputs of the two-dimensional position detecting apparatus and the two-dimensional image processing apparatus; and
a machine original point returning amount calculating apparatus for calculating moving amounts of the motors of a number at least the same as a number of freedom degrees provided to the table for making the table and the drive mechanism unit disposed at the machine original point position or the fixing reference position from a current position by comparing a new output image provided by newly detecting a mark in a current state by the two-dimensional position detecting apparatus and the two-dimensional processing apparatus, and the reference image position stored in the reference image position storing apparatus, wherein
the table and the drive mechanism unit are moved to the machine original point position by operating the motors of the number at least the same as the number of the freedom degrees provided to the table.

3. An alignment apparatus for operating a table mounted with an object in XYθ, Yθ, or θ by way of a drive mechanism arranged at a machine base portion to be positioned to a predetermined position,
the alignment apparatus comprising:
the drive mechanism comprising a plurality of drive mechanism units each constituted by;
a mechanism portion comprising two translational freedom degree portions each having a translational freedom degree and one rotational freedom degree portion having a rotational freedom degree; and
a motor control apparatus comprising motors for driving the freedom degree portions of the two translational freedom degree portions and the one rotational freedom degree portion, a detecting apparatus for detecting an amount of operating the mechanism portion constituting a member to be detected, and a controller for controlling the motors by receiving an operation instruction to constitute the motors of a number at least the same as a number of freedom degrees of XYθ, Yθ or θ operation of the table;
the drive mechanism units comprising an instructing apparatus for providing the operation instruction to the controller;
the table being operated to translationally move and rotationally move in two directions of the XYθ operation, to translationally move and rotationally move in one direction of the Yθ operation, or rotationally move of the θ operation by operating the motors respectively in a translational direction or a rotational direction;
a machine original point storing apparatus for previously storing or inputting difference between a machine original point position and a fixing reference position;
a machine fixing apparatus for mechanically fixing the table or the drive mechanism at the fixing reference position of the alignment apparatus;
a machine fixing reference position storing apparatus for detecting and storing the fixing reference positions of a number at least the same as a number of freedom degrees provided to the table by the detecting apparatus; and
an absolute position storing apparatus provided to the detecting apparatus for storing values of the machine original point positions of the number at least the same as the number of the freedom degrees provided to the table as an absolute value in consideration of difference between the fixing reference position and the machine original point position, wherein
the table and the drive mechanism unit are moved to the machine original point position by reading the absolute values of the machine original point positions of the number at least the same as the number of the freedom degrees provided to the table from the absolute position storing apparatus and operating the motors of the number at least the same as the number of the freedom degrees provided to the table in a state in which the machine fixing apparatus is not present routinely after the above-described processing has been finished and a power source is introduced again.

4. An original point returning method of an alignment apparatus for operating a table mounted with an object in XYθ, Yθ or θ by way of a drive mechanism arranged at a machine base portion to be positioned to a predetermined position, wherein
the drive mechanism comprises a plurality of drive mechanism units each constituted by;
a mechanism portion comprising two translational freedom degree portions each having a translational freedom degree and one rotational freedom degree portion having a rotational freedom degree; and
a motor control apparatus comprising motors for driving the freedom degree portions of the two translational freedom degree portions and the one rotational freedom degree portion, a detecting apparatus for detecting an amount of operating the mechanism portion constituting a member to be detected, and a controller for controlling the motors by receiving an operation instruction to constitute the motors of a number at least the same as a number of freedom degrees of XYθ, Yθ or θ operation of the table;
the drive mechanism units comprises an instructing apparatus for providing the operation instruction to the controller;
the table is operated to translationally move and rotationally move in two directions of the XYθ operation, to translationally move and rotationally move in one direction of the Yθ operation, or rotationally move of the θ operation by operating the motors respectively in a translational direction or a rotational direction;
the original point returning method comprising the steps of:
previously storing or inputting a machine original point position as difference from a fixing reference position by a machine original point storing apparatus;
mechanically fixing the table or the drive mechanism to the fixing reference position of the alignment apparatus by a machine fixing apparatus;
detecting the machine fixing reference positions of the number at least the same as the number of freedom degrees provided to the table by the detecting apparatus to store in a machine fixing reference position storing apparatus;
disengaging the machine fixing apparatus;
detecting detecting apparatus reference position references of the number at least the same as the number of the freedom degrees provided to the table by driving the motors of the number at least the same as the number of the freedom degrees provided to the table;
storing differences between the detecting apparatus reference positions and the machine original point positions or the fixing reference positions of the number at least the same as the number of the freedom degrees provided to the table in the detecting apparatus reference position storing apparatus;
detecting the detecting apparatus reference position references of the number at least the same as the number of the freedom degrees provided to the table by driving the motors of the number at least the same as the number of the freedom degrees provided to the table in a state in which the machine fixing apparatus is not present routinely after the above-described processing has been finished and a power source is introduced again; and
calculating process moving amounts of the motors from the detecting apparatus reference position references to the machine original point positions or the fixing reference positions of the number at least the same as the number of the freedom degrees provided to the table by a machine original point returning amount calculating apparatus.

5. An original point returning method of an alignment apparatus for operating a table mounted with an object in XYθ, Yθ or θ by way of a drive mechanism arranged at a machine base portion to be positioned to a predetermined position, wherein
the drive mechanism comprises a plurality of drive mechanism units each constituted by;
a mechanism portion comprising two translational freedom degree portions each having a translational freedom degree and one rotational freedom degree portion having a rotational freedom degree; and
a motor control apparatus comprising motors for driving the freedom degree portions of the two translational freedom degree portions and the one rotational freedom degree portion, a detecting apparatus for detecting an amount of operating the mechanism portion constituting a member to be detected, and a controller for controlling the motors by receiving an operation instruction to constitute the motors of a number at least the same as a number of freedom degrees of XYθ, Yθ or θ operation of the table;
the drive mechanism unit comprises an instructing apparatus for providing the operation instruction to the controller;
the table is operated to translationally move and rotationally move in two directions of the XYθ operation, to translationally move and rotationally move in one direction of the Yθ operation, or rotationally move of the θ operation by operating the motors respectively in a translational direction or a rotational direction;
the original point returning method comprising the steps of:
previously storing or inputting a machine original point position as difference from a fixing reference position by a machine original point storing apparatus;
mechanically fixing the table or the drive mechanism to the fixing reference position of the alignment apparatus by a machine fixing apparatus;
detecting a mark on the table by a two-dimensional position detecting apparatus;
receiving an image of the two-dimensional position detecting apparatus by a two-dimensional image processing apparatus and storing a reference image position in a reference image position storing apparatus by constituting an absolute position by a position of a mark of the image;
newly detecting the position of the mark of a current state by the two-dimensional position detecting apparatus and the two-dimensional image processing apparatus in a state in which the machine fixing apparatus is not present routinely after the above-described processing has been finished and a power source is introduced again;
calculating moving amounts of the motors of the number at least the same as the number of the freedom degrees provided to the table for making the table and the drive mechanism unit disposed at the machine original point position or the fixing reference position from a current position by comparing positions of the new image and the reference image position stored in the reference image position storing apparatus by a machine original point returning amount calculating apparatus; and
moving the table and the drive mechanism unit to the machine original point position by operating the motors of the number at least the same as the number of the freedom degrees provided to the table.

6. The original point returning method of an alignment apparatus according to claim 5, repeating the steps of:
moving the table and the drive mechanism unit to the machine original point position by operating the motors of the number at least the same as the number of the freedom degrees provided to the table;
thereafter, detecting newly the position of a mark in the current state by the two-dimensional position detecting apparatus and the two-dimensional image processing apparatus; and
comparing with the position of the reference image stored in the reference image position storing apparatus;
when the positions do not coincide with each other,
calculating moving amounts of the motors of the number at least the same as the number of the freedom degrees provided to the table for making the table and the drive mechanism unit disposed at the machine original point position or the fixing reference position from a current position; and
moving the table and the drive mechanism unit to the machine original point position by operating the motors of the number at least the same as the number of the freedom degrees provided to the table.

7. An original point returning method of an alignment apparatus for operating a table mounted with an object in XYθ, Yθ or θ by way of a drive mechanism arranged at a machine base portion to be positioned to a predetermined position, wherein
the drive mechanism comprises a plurality of drive mechanism units each constituted by;
a mechanism portion comprising two translational freedom degree portions each having a translational freedom degree and one rotational freedom degree portion having a rotational freedom degree; and
a motor control apparatus comprising motors for driving the freedom degree portions of the two translational freedom degree portions and the one rotational freedom degree portion, a detecting apparatus for detecting an amount of operating the mechanism portion constituting a member to be detected, and a controller for controlling the motors by receiving an operation instruction to constitute the motors of a number at least the same as a number of freedom degrees of XYθ, Yθ or θ operation of the table;
the drive mechanism units comprises an instructing apparatus for providing the operation instruction to the controller;
the table is operated to translationally move and rotationally move in two directions of the XYθ operation, to translationally move and rotationally move in one direction of the Yθ operation, or rotationally move of the θ operation by operating the motors respectively in a translational direction or a rotational direction;
the original point returning method comprising the steps of:
previously storing or inputting a machine original point position as difference from a fixing reference position by a machine original point storing apparatus;
mechanically fixing the table or the drive mechanism to the fixing reference position of the alignment apparatus by a machine fixing apparatus;
detecting the fixing reference positions of the number at least the same as the number of freedom degrees provided to the table by the detecting apparatus;
storing values of the machine original point positions of the number at least the same as the number of the freedom degrees provided to the table as absolute values in an absolute position storing apparatus provided to the detecting apparatus in consideration of difference between the fixing reference position and the machine original point position;
reading the machine original point positions of the number at least the same as the number of the freedom degrees provided to the table from the absolute position storing apparatus in a state in which the machine fixing apparatus is not present routinely after the above-described processing has been finished and a power source is introduced again; and
moving the table and the drive mechanism unit to the machine original point position by operating the motors of the number at least the same as the number of the freedom degrees provided to the table.

8. The alignment apparatus according to any one of claims 1 to 3, wherein
the drive mechanism further comprises:
a 3 freedom degree mechanism comprising the translational freedom degree portion having two translational freedom degrees and the rotational freedom degree portion having one rotational freedom degree without including the motors.

9. The alignment apparatus according to claim 1, wherein
in the table having at least the two freedom degrees operated in Yθ, a 2 freedom degree mechanism comprising the translational freedom degree portion having one translational freedom degree and the rotational freedom degree portion having one rotational freedom degree without including the motors is provided.

10. The alignment apparatus according to claim 9, wherein
in the table having at least the two freedom degrees operated in Yθ, the 2 freedom degree mechanism comprising a 2 freedom degree drive mechanism having the motors is provided.

11. The alignment apparatus according to claims 1, wherein
in the table having at least the rotational one freedom degree operated in θ, a rotational one freedom degree mechanism comprising one rotational freedom degree for supporting the table is provided.

12. The alignment apparatus according to claim 1, further comprising:
a first positioning apparatus for positioning the machine fixing apparatus to the machine base portion.

13. The alignment apparatus according to claim 1, further comprising:
a second positioning apparatus for positioning the machine fixing apparatus to the drive mechanism.

14. The alignment apparatus according to of claims 1, further comprising:
a third positioning apparatus for positioning the machine fixing apparatus to the table.

15. The original point returning method of an alignment apparatus according to of claim 5, comprising a step of:
positioning an installed position by a first positioning apparatus provided at the machine base portion.

16. The original point returning method of an alignment apparatus according to claim 5, comprising a step of:
positioning an installed position by a second positioning apparatus provided at the drive mechanism.

17. The original point returning method of an alignment apparatus according to claim 5, comprising a step of:
positioning an installed position by a third positioning apparatus provided at the table.

18. The alignment apparatus according to claim 1, further comprising:
a first position fixing apparatus for fixing the machine base portion and the machine fixing apparatus.

19. The alignment apparatus according to claim 1, further comprising:
a second position fixing apparatus for fixing the drive mechanism and the machine fixing apparatus.

20. The alignment apparatus according to claim 1, further comprising:
a third position fixing apparatus for fixing the table and the machine fixing apparatus.

21. The original point returning method of an alignment apparatus according to claim 5, wherein
the machine fixing apparatus and the machine base portion are fixed by using a first position fixing apparatus provided at the machine base portion.

22. The original point returning method of an alignment apparatus according to claim 5, wherein
the machine fixing apparatus and the drive mechanism are fixed by using a second position fixing apparatus provided at the drive mechanism.

23. The original point returning method of an alignment apparatus according to claim 5, wherein
the machine fixing apparatus and the table are fixed by using a third position fixing apparatus provided at the table.

24. The original point returning method of an alignment apparatus according to claim 5, wherein
the controller cuts a control of the motors, moves the table or the drive mechanism, and fixes the machine base portion and the table or the drive mechanism at the fixing reference position.

25. The alignment apparatus according to claim 1, wherein
the drive mechanism comprises the rotational freedom portion above the translational freedom portion, and further comprises the translational freedom degree portion above the rotational freedom degree portion.

26. The alignment apparatus according to claims 1, wherein
the drive mechanism further comprises the translational freedom degree portion above the translational freedom degree portion, and comprises the rotational freedom degree portion above the translational freedom degree portion.

27. The alignment apparatus according to claim 1, wherein
the drive mechanism comprises the translational freedom degree portion above the rotational freedom degree portion, and further comprises the translational freedom degree portion above the translational freedom degree portion.

28. The alignment apparatus according to claim 1, further comprising:
a two-dimensional position detecting apparatus for grasping a position of a mark on the object or the table, and
a two-dimensional image processing apparatus for subjecting an image of the object caught by the two-dimensional position detecting apparatus to an image processing and calculating a correcting amount for correcting the position of the object, wherein
the position of the table or the object is corrected by operating the motors based on the correcting amount provided by the two-dimensional image processing apparatus.

29. The alignment apparatus according to claim 28, comprising:
a plurality of the two-dimensional position detecting apparatus.

30. The alignment apparatus according to claim 1, wherein
the drive mechanism unit is arranged such that the motors of at least the number of the freedom degrees provided to the table are separated from a gravitational center of the table and move the table with being shifted from the gravitational center of the table.

31. The original point returning method of an alignment apparatus according to claim 5, wherein
the drive mechanism units are arranged such that the motors of at least the number of the freedom degrees provided to the table are separated from a gravitational center of the table, and move the table with being shifted from the gravitational center of the table.

32. The alignment apparatus according to claim 1, wherein
the motors for driving the translational freedom degree portion of the drive mechanism is a linear motor.

33. The original point returning method of an alignment apparatus according to claim 5, wherein
a linear motor as the motor drives the translational freedom degree portion of the drive mechanism unit.

34. The alignment apparatus according to claim 1, wherein
the fixing reference position is the machine original point position.

35. The original point returning method of an alignment apparatus according to claim 5, wherein
the machine original point position is used as the fixing reference position.

36. A turning table comprising the alignment apparatus according to claim 1.

37. A translational table comprising the alignment apparatus according to claim 1.

38. A machine comprising the alignment apparatus according to claim 1.

39. A machine control system comprising at least one drive mechanism portion and the machine according to claim 38 as the drive mechanism portion.
